(19) United States
(12) Patent Application Publication
(10) Pub. No.: US 2024/0348380 A1
(43) Pub. Date: Oct. 17, 2024

(54) ACKNOWLEDGEMENT INFORMATION FOR MULTIPLE SETS OF CELLS

(71) Applicant: Samsung Electronics Co., Ltd., Suwon-si (KR)

(72) Inventors: Ebrahim MolavianJazi, San Jose, CA (US); Aristides Papasakellariou, Houston, TX (US)

(21) Appl. No.: 18/613,032

(22) Filed: Mar. 21, 2024

Related U.S. Application Data
(60) Provisional application No. 63/457,037, filed on Apr. 4, 2023.
(60) Provisional application No. 63/531,988, filed on Aug. 10, 2023.
(60) Provisional application No. 63/541,570, filed on Sep. 29, 2023.
(60) Provisional application No. 63/545,265, filed on Oct. 23, 2023.

(51) Int. Cl. H04L 1/1867; H04W 72/1273; H04W 72/232

(52) U.S. Cl. CPC H04L 1/1887; H04W 72/1273; H04W 72/232

(57) ABSTRACT

Methods and apparatuses for acknowledgment information for multiple sets of cells. A method performed by a user equipment for providing hybrid automatic repeat request acknowledgment (HARQ-ACK) information is provided includes receiving first information for a first set of serving cells including multiple serving cells, first downlink control information (DCI) formats, and first PDSCHs on respective first serving cells. The method further includes determining first HARQ-ACK information corresponding to the first PDSCHs and a first HARQ-ACK codebook associated with the first DCI formats that includes the first HARQ-ACK information. The first HARQ-ACK information includes a negative acknowledgment (NACK) for the first PDSCH. The NACK is appended to HARQ-ACK information corresponding to the first PDSCHs except for the first PDSCH. The method further includes transmitting an uplink channel that provides HARQ-ACK codebooks including the first HARQ-ACK codebook.

### CROSS-REFERENCE TO RELATED AND CLAIM OF PRIORITY

The present application claims priority under 35 U.S.C. § 119(e) to U.S. Provisional Patent Application No. 63/457,037 filed on Apr. 4, 2023, U.S. Provisional Patent Application No. 63/531,988 filed on Aug. 10, 2023, U.S. Provisional Patent Application No. 63/541,570 filed on Sep. 29, 2023, and U.S. Provisional Patent Application No. 63/545,265 filed on Oct. 23, 2023, which are hereby incorporated by reference in their entirety.

### TECHNICAL FIELD

The present disclosure relates generally to wireless communication systems and, more specifically, the present disclosure is related to acknowledgment information for multiple sets of cells.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to acknowledgement information for multiple sets of cells.

In an embodiment, a method for providing hybrid automatic repeat request acknowledgment (HARQ-ACK) information is provided. The method includes receiving first information for a first set of serving cells including multiple serving cells, first downlink control information (DCI) formats, wherein each DCI format from the first DCI formats schedules physical downlink shared channel (PDSCH) receptions on respective serving cells from the first set of serving cells, and first PDSCHs on respective first serving cells, from the first set of serving cells, that are scheduled by a first DCI format from the first DCI formats. The first DCI format is provided by a first physical downlink control channel (PDCCH) reception in a first PDCCH monitoring occasion (MO). The first PDCCH MO is before a first active downlink (DL) bandwidth part (BWP) change on a first serving cell from the first serving cells. A second active DL BWP change on the first serving cell is not triggered in the first PDCCH MO. The method further includes determining first HARQ-ACK information corresponding to the first PDSCHs and a first HARQ-ACK codebook associated with the first DCI formats that includes the first HARQ-ACK information. The first HARQ-ACK information includes a negative acknowledgment (NACK) for the first PDSCH. The NACK is appended to HARQ-ACK information corresponding to the first PDSCHs except for the first PDSCH. The method further includes transmitting a physical uplink control channel (PUCCH) or a physical uplink shared channel (PUSCH) that provides HARQ-ACK codebooks including the first HARQ-ACK codebook.

In another embodiment, a user equipment (UE) is provided. The UE includes a transceiver configured to receive first information for a first set of serving cells including multiple serving cells, first DCI formats, wherein each DCI format from the first DCI formats schedules PDSCH receptions on respective serving cells from the first set of serving cells, and first PDSCHs on respective first serving cells, from the first set of serving cells, that are scheduled by a first DCI format from the first DCI formats. The first DCI format is provided by a first PDCCH reception in a first PDCCH MO. The first PDCCH MO is before a first active DL BWP change on a first serving cell from the first serving cells. A second active DL BWP change on the first serving cell is not triggered in the first PDCCH MO. The UE further includes a processor operably coupled with the transceiver. The processor is configured to determine first HARQ-ACK information corresponding to the first PDSCHs and a first HARQ-ACK codebook associated with the first DCI formats that includes the first HARQ-ACK information. The first HARQ-ACK information includes a NACK for the first PDSCH. The NACK is appended to HARQ-ACK information corresponding to the first PDSCHs except for the first PDSCH. The transceiver is further configured to transmit a PUCCH or a PUSCH that provides HARQ-ACK codebooks including the first HARQ-ACK codebook.

In yet another embodiment, a base station is provided. The base station includes a transceiver configured to transmit first information for a first set of serving cells including multiple serving cells, first DCI formats, wherein each DCI format from the first DCI formats schedules PDSCH transmissions on respective serving cells from the first set of serving cells, and first PDSCHs on respective first serving cells, from the first set of serving cells, that are scheduled by a first DCI format from the first DCI formats. The first DCI format is provided by a first PDCCH transmission in a first PDCCH MO. The first PDCCH MO is before a first active DL BWP change on a first serving cell from the first serving cells. A second active DL BWP change on the first serving cell is not triggered in the first PDCCH MO. The base station further includes a processor operably coupled with the transceiver. The processor is configured to determine first HARQ-ACK information corresponding to the first PDSCHs and a first HARQ-ACK codebook associated with the first DCI formats that includes the first HARQ-ACK information. The first HARQ-ACK information includes a NACK for the first PDSCH. The NACK is appended to HARQ-ACK information corresponding to the first PDSCHs except for the first PDSCH. The transceiver is further configured to receive a PUCCH or a PUSCH that provides HARQ-ACK codebooks including the first HARQ-ACK codebook.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flow chart of an example UE procedure for generating separate Type-2 HARQ-ACK sub-CBs for single-cell scheduling and for multi-cell scheduling, wherein separate Type-2 sub-CBs are generated for each set of cells for multi-cell scheduling according to embodiments of the present disclosure;

FIG. 7 illustrates a flow chart of an example UE procedure for generating separate Type-2 HARQ-ACK sub-CBs for single-cell scheduling and for multi-cell scheduling, based on a value of a DAI in an UL DCI format that is applicable to only one of the sub-CBs according to embodiments of the present disclosure; and

FIG. 8 illustrates a flow chart of an example UE procedure for generating separate Type-2 HARQ-ACK sub-CBs for single-cell scheduling and for multi-cell scheduling, with different HARQ-ACK codebook types, such as Type-1 for single-cell scheduling and Type-2 for multi-cell scheduling according to embodiments of the present disclosure.

### DETAILED DESCRIPTION

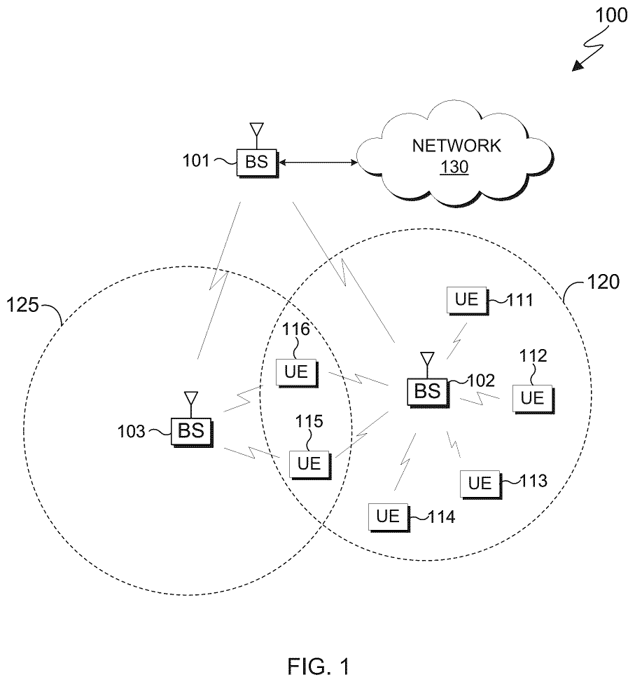

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

5G radio supports flexible spectrum utilization from 400 MHz to 90 GHz for licensed, unlicensed, and shared spectrum bands, narrow-band and wideband allocations with bandwidth parts, carrier aggregation, dual-connectivity, and dynamic spectrum sharing, achieves higher spectrum occupancy than LTE, and utilizes flexible control channel assignments in time and frequency domains. In-built support since 3GPP Release 15 for massive MIMO and beamforming greatly enhances achievable coverage and spectral efficiency when using 5G radio. Flexible orthogonal frequency division multiplexing (OFDM) numerology, short transmission time and scheduling delays, self-contained slots, asynchronous hybrid automatic repeat request acknowledgement (HARQ), minimal overhead from DL common signals and channels, adaptive reference signals and low-density parity check (LDPC) and Polar channel coding enable more flexibility and faster processing with 5G radio when compared to LTE.

In addition, 5G radio provides optimized support for additional services and features in 3GPP Release 16 such as vehicular (V2X) and device-to-device (D2D) communications, wireless backhauling (IAB), coordinated multi-point (COMP) or Multi-TRP transmission and reception (multi-TRP), cross-link interference (CLI) and remote interference (RIM) detection and avoidance, and NR operation in unlicensed bands (NR-U).

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and channel coding;” [3] 3GPP TS 38.213 v17.4.0, “NR; Physical layer procedures for control;” [4] 3GPP TS 38.214 v17.4.0, “NR; Physical layer procedures for data;” [5] 3GPP TS 38.215 v17.4.0, “NR; Physical layer measurements;” [6] 3GPP TS 38.321 v17.4.0, “NR; Medium Access Control (MAC) protocol specification;” [7] 3GPP TS 38.331 v17.4.0, “NR; Radio Resource Control (RRC) protocol specification;” and [8] 3GPP TS 38.300 v17.4.0, “NR; NR and NG-RAN Overall Description; Stage 2.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a ULE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, a smartwatch, activity tracker, or the like, or an internet of things (IoT) device such as a thermostat, smart appliance, smart hub, display device, smart speaker, media player or receiver, switch, plug, light, sensor, etc. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer, vending machine, or certain types of IoT devices).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determining acknowledgment information for multiple sets of cells. In certain embodiments, one or more of the BSs 101-103 include circuitry, programing, or a combination thereof to support acknowledgement information for multiple sets of cells.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

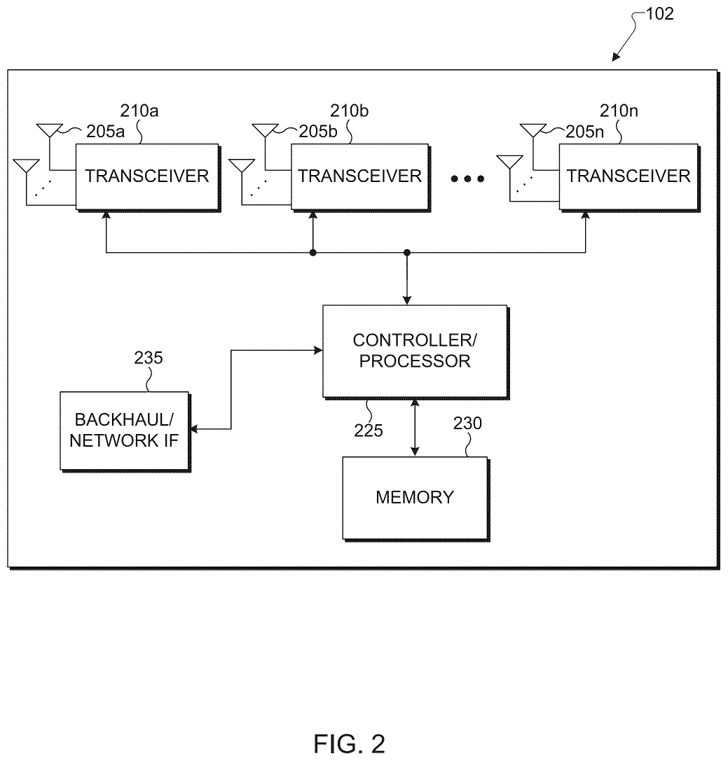

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support acknowledgment information for multiple sets of cells. Any of a wide variety of other functions could be supported in the gNB 102 by the controller/processor 225.

The controller/processor 225 is also capable of executing programs and other processes resident in the memory 230, such as processes to support acknowledgment information for multiple sets of cells. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

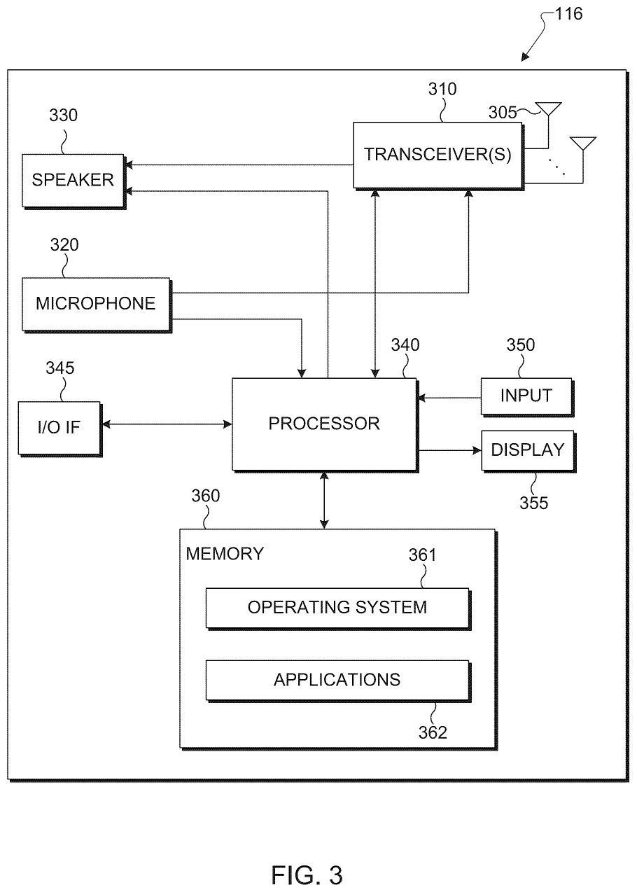

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for determining acknowledgement information for multiple sets of cells as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices, including an IoT device. For example, the UE 116 may not include one or more of display 355, speaker 330, microphone 320, input 350, I/O IF 345 and may operate using a low power processor 340 and/or memory 360.

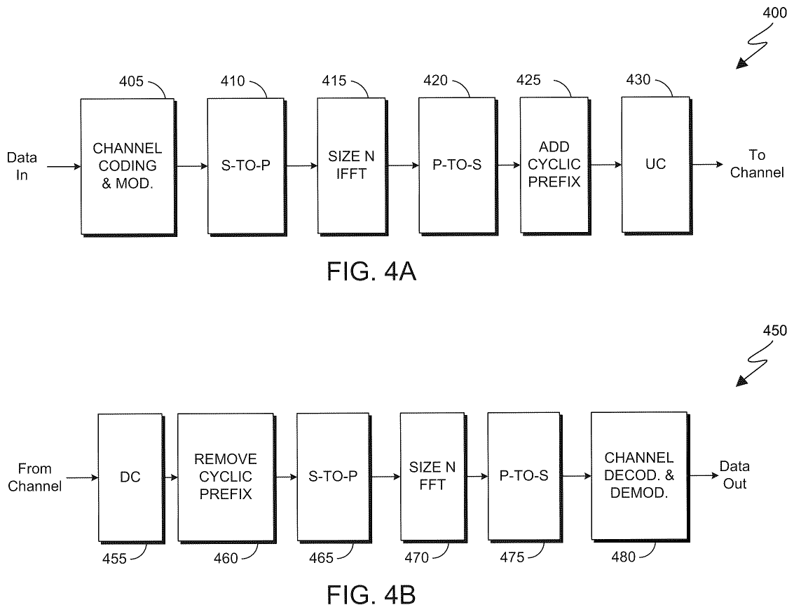

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to transmit acknowledgement information for multiple sets of cells as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or SRS. In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

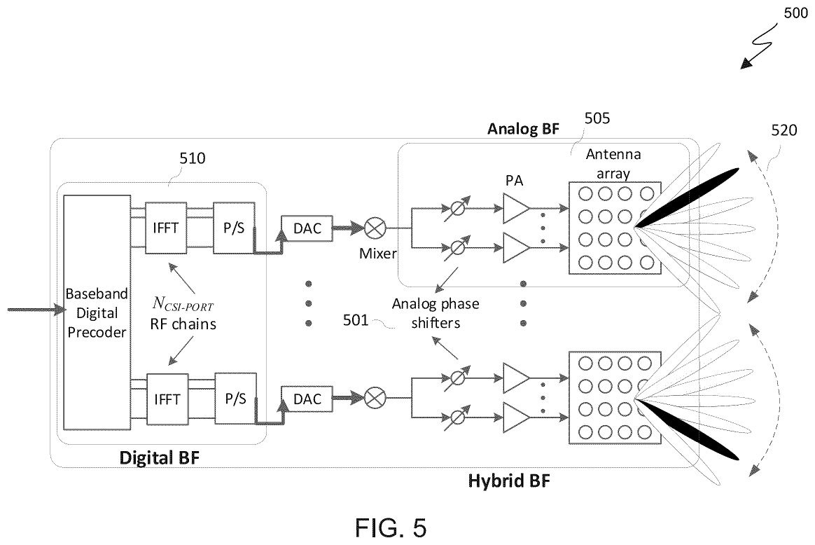

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

The present disclosure relates to a pre-5th-Generation (5G) or 5G or beyond 5G communication system to be provided for supporting one or more of: higher data rates, lower latency, higher reliability, improved coverage, massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IRs), CSI interference measurement (CSI-IM) resources associated with a zero power CSI-RS (ZP CSI-RS) configuration are used. A CSI process consists of NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE 116 may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE 116 (such as the UE 116) may assume that synchronization signal (SS)/physical broadcast channel block (also denoted as SSBs) transmitted with the same block index on the same center frequency location are quasi co-located with respect to Doppler spread, Doppler shift, average gain, average delay, delay spread, and, when applicable, spatial Rx parameters. The UE 116 may not assume quasi co-location for any other synchronization signal SS/PBCH block transmissions.

In absence of CSI-RS configuration, and unless otherwise configured, the UE 116 may assume PDSCH DM-RS and SSB to be quasi co-located with respect to Doppler shift, Doppler spread, average delay, delay spread, and, when applicable, spatial Rx parameters. The UE 116 may assume that the PDSCH DM-RS within the same code division multiplexing (CDM) group is quasi co-located with respect to Doppler shift, Doppler spread, average delay, delay spread, and spatial Rx. The UE 116 may also assume that DM-RS ports associated with a PDSCH are QCL with QCL type A, type D (when applicable) and average gain. The UE 116 may further assume that no DM-RS collides with the SS/PBCH block.

The UE 116 can be configured with a list of up to M transmission configuration indication (TCI) State configurations within the higher layer parameter PDSCH-Config to decode PDSCH according to a detected PDCCH with DCI intended for the UE 116 and the given serving cell, where M depends on the UE 116 capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The ULE 116 receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}) where Nₛₗₒₜ^{subframe,μ} is a number of slot per subframe for subcarrier spacing (SCS) configuration p.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The PCIs of SSBs transmitted in different frequency locations do not have to be unique, i.e., different SSBs in the frequency domain can have different PCIs. However, when an SSB is associated with an RMSI, the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

Measurement time resource(s) for SSB-based RSRP measurements may be confined within a SSB Measurement Time Configuration (SMTC). The SMTC configuration provides a measurement window periodicity/duration/offset information for UE RRM measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Throughout the present disclosure, the term “configuration” or “higher layer configuration” and variations thereof (such as “configured” and so on) are used to refer to one or more of: a system information signaling such as by a MIB or a SIB (such as SIB1), a common or cell-specific higher layer/RRC signaling, or a dedicated or UE-specific or BWP-specific higher layer/RRC signaling.

Throughout the present disclosure, the term signal quality is used to refer to e.g., RSRP or RSRQ or RSSI or SNR or SINR, with or without filtering such as L1 or L3 filtering, of a channel or a signal such as a reference signal (RS) including SSB, CSI-RS, or SRS.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets,
   the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

PDCCH is added to the timeDurationForQCL, where d is defined in 5.2.1.5.1a-1, otherwise d is zero;
For both the cases, when the UE is configured with enableDefaultBeamForCCS, and when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For PUSCH scheduled by DCI format 0_0 on a cell and if the higher layer parameter enableDefaultBeamPL-ForPUSCH0-0 is set ‘enabled’, the UE is not configured with PUCCH resources on the active UL BWP and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell.

For PUSCH scheduled by DCI format 0_0 on a cell and if the higher layer parameter enableDefaultBeamPL-ForPUSCH0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell in case CORESET(s) are configured on the cell.

In Multiple Transmit/Receive Point (multi-TRP) operation, a serving cell can schedule UE from two TRPs, providing better PDSCH coverage, reliability and/or data rates.

There are two different operation modes for multi-TRP: single-DCI and multi-DCI. For both modes, control of uplink and downlink operation is done by both physical layer and MAC. In single-DCI mode, UE is scheduled by the same DCI for both TRPs and in multi-DCI mode, UE is scheduled by independent DCIs from each TRP.

In Carrier Aggregation (CA), two or more Component Carriers (CCs) are aggregated. A UE may simultaneously receive or transmit on one or multiple CCs depending on its capabilities:
A UE with single timing advance capability for CA can simultaneously receive and/or transmit on multiple CCs corresponding to multiple serving cells sharing the same timing advance (multiple serving cells grouped in one TAG);
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell;
A non-CA capable UE can receive on a single CC and transmit on a single CC corresponding to one serving cell only (one serving cell in one TAG).

CA is supported for both contiguous and non-contiguous CCs. When CA is deployed frame timing and SFN are aligned across cells that can be aggregated, or an offset in multiples of slots between the PCell/PSCell and an SCell is configured to the UE. The maximum number of configured CCs for a UE is 16 for DL and 16 for UL.

When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the Primary Cell (PCell). Depending on UE capabilities, Secondary Cells (SCells) can be configured to form together with the PCell a set of serving cells. The configured set of serving cells for a UE therefore includes one PCell and one or more SCells.

The reconfiguration, addition and removal of SCells can be performed by RRC. At intra-NR handover and during connection resume from RRC_INACTIVE, the network can also add, remove, keep, or reconfigure SCells for usage with the target PCell. When adding a new SCell, dedicated RRC signalling is used for sending all required system information of the SCell i.e., while in connected mode, UEs need not acquire broadcast system information directly from the SCells.

To enable reasonable UE battery consumption when CA is configured, an activation/deactivation mechanism of Cells is supported. When an SCell is deactivated, the UE does not need to receive the corresponding PDCCH or PDSCH, cannot transmit in the corresponding uplink, nor is it required to perform CQI measurements. Conversely, when an SCell is active, the UE shall receive PDSCH and PDCCH (if the UE is configured to monitor PDCCH from this SCell) and is expected to be able to perform CQI measurements. NG-RAN ensures that while PUCCH SCell (a Secondary Cell configured with PUCCH) is deactivated, SCells of secondary PUCCH group (a group of SCells whose PUCCH signalling is associated with the PUCCH on the PUCCH SCell) should not be activated. NG-RAN ensures that SCells mapped to PUCCH SCell are deactivated before the PUCCH SCell is changed or removed.

When reconfiguring the set of serving cells:
SCells added to the set are initially activated or deactivated;
SCells which remain in the set (either unchanged or reconfigured) do not change their activation status (activated or deactivated).

At handover or connection resume from RRC_INACTIVE:
SCells are activated or deactivated.

To enable reasonable UE battery consumption when BA is configured, only one UL BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, PRACH and UL-SCH.

To enable fast SCell activation when CA is configured, one dormant BWP can be configured for an SCell. If the active BWP of the activated SCell is a dormant BWP, the UE stops monitoring PDCCH and transmitting SRS/PUSCH/PUCCH on the SCell but continues performing CSI measurements, AGC and beam management, if configured. A DCI is used to control entering/leaving the dormant BWP for one or more SCell(s) or one or more SCell group(s).

The dormant BWP is one of the UE's dedicated BWPs configured by network via dedicated RRC signalling. The SpCell and PUCCH SCell cannot be configured with a dormant BWP.

Cross-carrier scheduling with the Carrier Indicator Field (CIF) allows the PDCCH of a serving cell to schedule resources on another serving cell but with the following restrictions:
Cross-carrier scheduling does not apply to PCell i.e., PCell is scheduled via its PDCCH;
When an SCell is configured with a PDCCH, that cell's PDSCH and PUSCH are scheduled by the PDCCH on this SCell;
When an SCell is not configured with a PDCCH, that SCell's PDSCH and PUSCH are scheduled by a PDCCH on another serving cell;
The scheduling PDCCH and the scheduled PDSCH/PUSCH can use the same or different numerologies.

Some of the restrictions above may be relaxed. For example, dynamic spectrum sharing (DSS) allows LTE and NR to share the same carrier. As the number of NR devices in a network increases, it is important that sufficient scheduling capacity for NR UEs on the shared carriers is ensured. In the case of DSS operation, PDCCH enhancements for cross-carrier scheduling including can be considered such that PDCCH of an SCell, referred to as a special/scheduling SCell (sSCell), can schedule PDSCH or PUSCH on the P(S)Cell.

The Physical Downlink Control Channel (PDCCH) can be used to schedule DL transmissions on PDSCH and UL transmissions on PUSCH, where the Downlink Control Information (DCI) on PDCCH includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH.

In addition to scheduling, PDCCH can be used to for:
Activation and deactivation of configured PUSCH transmission with configured grant;
Activation and deactivation of PDSCH semi-persistent transmission;
Notifying one or more UEs of the slot format;
Notifying one or more UEs of the PRB(s) and OFDM symbol(s) where the UE may assume no transmission is intended for the UE;
Transmission of TPC commands for PUCCH and PUSCH;
Transmission of one or more TPC commands for SRS transmissions by one or more UEs;
Switching a UE's active bandwidth part;
Initiating a random-access procedure;
Indicating the UE(s) to monitor the PDCCH during the next occurrence of the DRX on-duration;
In IAB context, indicating the availability for soft symbols of an IAB-DU;
Triggering one shot HARQ-ACK codebook feedback;
For operation with shared spectrum channel access:
   Triggering search space set group switching;
   Indicating one or more UEs about the available RB sets and channel occupancy time duration;
   Indicating downlink feedback information for configured grant PUSCH (CG-DFI).

A UE monitors a set of PDCCH candidates in the configured monitoring occasions in one or more configured COntrol REsource SETs (CORESETs) according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET.

Polar coding and QPSK modulation are used for PDCCH. Each resource element group carrying PDCCH carries its own DMRS.

A UE monitors a set of PDCCH candidates in one or more CORESETs on the active DL BWP on each activated serving cell configured with PDCCH monitoring according to corresponding search space sets where monitoring implies decoding each PDCCH candidate according to the monitored DCI formats.

In the downlink, the gNB can dynamically allocate resources to UEs via the C-RNTI on PDCCH(s). A UE monitors the PDCCH(s) in order to find possible assignments when its downlink reception is enabled (activity governed by DRX when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using INT-RNTI on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to CS-RNTI can either signal and activate the configured downlink assignment, or deactivate it; i.e. a PDCCH addressed to CS-RNTI indicates that the downlink assignment can be implicitly reused according to the periodicity defined by RRC, until deactivated. When required, retransmissions are explicitly scheduled on PDCCH(s).

The dynamically allocated downlink reception overrides the configured downlink assignment in the same serving cell, if they overlap in time. Otherwise, a downlink reception according to the configured downlink assignment is assumed, if activated.

The UE may be configured with up to 8 active configured downlink assignments for a given BWP of a serving cell. When more than one is configured:
The network decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

PUSCH may be scheduled with DCI on PDCCH, or a semi-static configured grant may be provided over RRC, where two types of operation are supported:
The first PUSCH is triggered with a DCI, with subsequent PUSCH transmissions following the RRC configuration and scheduling received on the DCI, or
The PUSCH is triggered by data arrival to the UE's transmit buffer and the PUSCH transmissions follow the RRC configuration.

In the uplink, the gNB can dynamically allocate resources to UEs via the C-RNTI on PDCCH(s). A UE monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission. The gNB can configure UEs to monitor cancelled transmission indications using CI-RNTI on a PDCCH. If a UE receives the cancelled transmission indication, the UE shall cancel the PUSCH transmission from the earliest symbol overlapped with the resource or the SRS transmission overlapped with the resource indicated by cancellation.

In addition, with Configured Grants, the gNB can allocate uplink resources for the initial HARQ transmissions and HARQ retransmissions to UEs. Two types of configured uplink grants are defined:
With Type 1, RRC directly provides the configured uplink grant (including the periodicity).
With Type 2, RRC defines the periodicity of the configured uplink grant while PDCCH addressed to CS-RNTI can either signal and activate the configured uplink grant, or deactivate it; i.e., a PDCCH addressed to CS-RNTI indicates that the uplink grant can be implicitly reused according to the periodicity defined by RRC, until deactivated.

The HARQ functionality ensures delivery between peer entities at Layer 1. A single HARQ process supports one TB when the physical layer is not configured for downlink/uplink spatial multiplexing, and when the physical layer is configured for downlink/uplink spatial multiplexing, a single HARQ process supports one or multiple TBs.

In case of CA, the multi-carrier nature of the physical layer is only exposed to the MAC layer for which one HARQ entity is required per serving cell. In both uplink and downlink, there is one independent HARQ entity per serving cell and one transport block is generated per assignment/grant per serving cell in the absence of spatial multiplexing. Each transport block and its potential HARQ retransmissions are mapped to a single serving cell.

For downlink, Asynchronous Incremental Redundancy Hybrid ARQ is supported. The gNB provides the UE with the HARQ-ACK feedback timing either dynamically in the DCI or semi-statically in an RRC configuration. Retransmission of HARQ-ACK feedback is supported for operation with shared spectrum channel access by using enhanced dynamic codebook and/or one-shot triggering of HARQ-ACK transmission for all configured CCs and HARQ processes in the PUCCH group. The UE may be configured to receive code block group-based transmissions where retransmissions may be scheduled to carry a sub-set of all the code blocks of a TB.

For uplink, Asynchronous Incremental Redundancy HARQ is supported. The gNB schedules each uplink transmission and retransmission using the uplink grant on DCI. For operation with shared spectrum channel access, UE can also retransmit on configured grants. The UE may be configured to transmit code block group-based transmissions where retransmissions may be scheduled to carry a sub-set of all the code blocks of a transport block.

Up to two HARQ-ACK codebooks corresponding to a priority (high/low) can be constructed simultaneously. For each HARQ-ACK codebook, more than one PUCCH for HARQ-ACK transmission within a slot is supported. Each PUCCH is limited within one sub-slot, and the sub-slot pattern is configured per HARQ-ACK codebook.

Physical uplink control channel (PUCCH) carries the Uplink Control Information (UCI) from the UE to the gNB. UCI includes at least hybrid automatic request acknowledgement (HARQ-ACK) information, scheduling request (SR), and channel state information (CSI).

UCI can be transmitted on a PUCCH or multiplexed in a PUSCH. UCI multiplexing in PUSCH is supported when UCI and PUSCH transmissions coincide in time, either due to transmission of a UL-SCH transport block or due to triggering of A-CSI transmission without UL-SCH transport block:
UCI carrying HARQ-ACK feedback with 1 or 2 bits is multiplexed by puncturing PUSCH;
In all other cases UCI is multiplexed by rate matching PUSCH.

For configured grants operation with shared spectrum channel access, a CG-UCI (Configured Grant Uplink Control Information) is transmitted in PUSCH scheduled by configured uplink grant. For operation with shared spectrum channel access, multiplexing of CG-UCI and PUCCH carrying HARQ-ACK feedback can be configured by the gNB. If not configured, when PUCCH overlaps with PUSCH scheduled by a configured grant within a PUCCH group and PUCCH carries HARQ ACK feedback, PUSCH scheduled by configured grant is skipped.

Physical uplink control channel (PUCCH) carries the Uplink Control Information (UCI) from the UE to the gNB. Five formats of PUCCH exist, depending on the duration of PUCCH and the UCI payload size.
Format #0: Short PUCCH of 1 or 2 symbols with small UCI payloads of up to two bits with UE multiplexing capacity of up to 6 UEs with 1-bit payload in the same PRB;
Format #1: Long PUCCH of 4-14 symbols with small UCI payloads of up to two bits with UE multiplexing capacity of up to 84 UEs without frequency hopping and 36 UEs with frequency hopping in the same PRB;
Format #2: Short PUCCH of 1 or 2 symbols with large UCI payloads of more than two bits with no UE multiplexing capability in the same PRBs;
Format #3: Long PUCCH of 4-14 symbols with large UCI payloads with no UE multiplexing capability in the same PRBs;
Format #4: Long PUCCH of 4-14 symbols with moderate UCI payloads with multiplexing capacity of up to 4 UEs in the same PRBs.

The short PUCCH format of up to two UCI bits is based on sequence selection, while the short PUCCH format of more than two UCI bits frequency multiplexes UCI and DMRS. The long PUCCH formats time-multiplex the UCI and DMRS. Frequency hopping is supported for long PUCCH formats and for short PUCCH formats of duration of 2 symbols. Long PUCCH formats can be repeated over multiple slots.

For operation with shared spectrum channel access, PUCCH Format #0, #1, #2, #3 are extended to use resource in one PRB interlace (up to two interlaces for Format #2 and Format #3) in one RB Set. PUCCH Format #2 and #3 are enhanced to support multiplexing capacity of up to 4 UEs in the same PRB interlace when one interlace is used.

UCI multiplexing in PUSCH is supported when UCI and PUSCH transmissions coincide in time, either due to transmission of a UL-SCH transport block or due to triggering of A-CSI transmission without UL-SCH transport block:
UCI carrying HARQ-ACK feedback with 1 or 2 bits is multiplexed by puncturing PUSCH;
In all other cases UCI is multiplexed by rate matching PUSCH.

UCI consists of the following information:
CSI;
ACK/NAK;
Scheduling request.

For operation with shared spectrum channel access, multiplexing of CG-UCI and PUCCH carrying HARQ-ACK feedback can be configured by the gNB. If not configured, when PUCCH overlaps with PUSCH scheduled by a configured grant within a PUCCH group and PUCCH carries HARQ ACK feedback, PUSCH scheduled by configured grant is skipped.

QPSK and π/2 BPSK modulation can be used for long PUCCH with more than 2 bits of information, QPSK is used for short PUCCH with more than 2 bits of information and BPSK and QPSK modulation can be used for long PUCCH with up to 2 information bits.

Transform precoding is applied to PUCCH Format #3 and Format #4.

Channel coding used for uplink control information is described in Table 1.

TABLE 1
Channel coding for uplink control information

| Uplink Control Information | |
|---|---|
| size including CRC, if present | Channel code |
| 1 | Repetition code |
| 2 | Simplex code |
| 3-11 | Reed Muller code |
| >11 | Polar code |

PUSCH and PUCCH can be associated with a priority (high/low) by RRC or L1 signalling. If a PUCCH transmission overlaps in time with a transmission of a PUSCH or another PUCCH, only the PUCCH or PUSCH associated with a high priority can be transmitted.

In case of Supplementary Uplink (SUL), the UE is configured with 2 ULs for one DL of the same cell, and uplink transmissions on those two ULs are controlled by the network to avoid overlapping PUSCH/PUCCH transmissions in time. Overlapping transmissions on PUSCH are avoided through scheduling while overlapping transmissions on PUCCH are avoided through configuration (PUCCH can only be configured for only one of the 2 ULs of the cell). In addition, initial access is supported in each of the uplink.

If a UE is provided pdsch-HARQ-ACK-CodebookList, the UE can be indicated by pdsch-HARQ-ACK-CodebookList to generate one or two HARQ-ACK codebooks. If the UE is indicated to generate one HARQ-ACK codebook, the HARQ-ACK codebook is associated with a PUCCH of priority index 0. If a UE is provided pdsch-HARQ-ACK-CodebookList, the UE multiplexes in a same HARQ-ACK codebook only HARQ-ACK information associated with a same priority index. If the UE is indicated to generate two HARQ-ACK codebooks
a first HARQ-ACK codebook is associated with a PUCCH of priority index 0 and a second HARQ-ACK codebook is associated with a PUCCH of priority index 1
the UE is provided first and second for each of {PUCCH-Config, UCI-OnPUSCH, PDSCH-codeBlockGroupTransmission} by {PUCCH-ConfigurationList, UCI-OnPUSCH-ListDCI-0-1, PDSCH-CodeBlockGroupTransmissionList} or {PUCCH-ConfigurationList, UCI-OnPUSCH-ListDCI-0-2, PDSCH-CodeBlockGroupTransmissionList}, respectively, for use with the first and second HARQ-ACK codebooks, respectively

If a UE receives a PDSCH without receiving a corresponding PDCCH, or if the UE receives a PDCCH indicating a SPS PDSCH release, the UE generates one corresponding HARQ-ACK information bit. If the UE generates two HARQ-ACK codebooks, the UE is indicated by harq-CodebookID, per SPS PDSCH configuration, a HARQ-ACK codebook index for multiplexing the corresponding HARQ-ACK information bit.

If a UE is provided pdsch-HARQ-ACK-OneShotFeedback and the UE detects a DCI format in any PDCCH monitoring occasion that includes a One-shot HARQ-ACK request field with value 1
the UE includes the HARQ-ACK information in a Type-3 HARQ-ACK codebook
the UE does not expect that the PDSCH-to-HARQ_feedback timing indicator field of the DCI format provides an inapplicable value from dl-DataToUL-ACK-r16

In the remaining of this clause, reference is to one HARQ-ACK codebook and to DCI formats that schedule PDSCH reception, or indicate SPS PDSCH release, or indicate SCell dormancy without scheduling a PDSCH reception and are associated with the HARQ-ACK codebook.

If a UE is configured to receive SPS PDSCHs in a slot for SPS configurations that are indicated to be released by a DCI format, and if the UE receives the PDCCH providing the DCI format in the slot where the end of a last symbol of the PDCCH reception is not after the end of a last symbol of any of the SPS PDSCH receptions, and if HARQ-ACK information for the SPS PDSCH release and the SPS PDSCH receptions would be multiplexed in a same PUCCH, the UE does not expect to receive the SPS PDSCHs, does not generate HARQ-ACK information for the SPS PDSCH receptions, and generates a HARQ-ACK information bit for the SPS PDSCH release.

If a UE detects a DCI format 1_1 indicating
SCell dormancy without scheduling a PDSCH reception, as described in clause 10.3, and
is provided pdsch-HARQ-ACK-Codebook dynamic or pdsch-HARQ-ACK-Codebook-r16 the UE generates a HARQ-ACK information bit as described in clause 9.1.3 for a DCI format 1_1 indicating SCell dormancy, and the HARQ-ACK information bit value is ACK.

If a UE is not provided PDSCH-CodeBlockGroupTransmission, the UE generates one HARQ-ACK information bit per transport block.

For a HARQ-ACK information bit, a UE generates a positive acknowledgement (ACK) if the UE detects a DCI format that provides a SPS PDSCH release or correctly decodes a transport block, and generates a negative acknowledgement (NACK) if the UE does not correctly decode the transport block. A HARQ-ACK information bit value of 0 represents a NACK while a HARQ-ACK information bit value of 1 represents an ACK.

In the following, the CRC for a DCI format is scrambled with a C-RNTI, an MCS-C-RNTI, or a CS-RNTI.

If a UE is provided PDSCH-CodeBlockGroupTransmission for a serving cell, the UE receives a PDSCH scheduled by DCI format 1_1, that includes code block groups (CBGs) of a transport block. The UE is also provided maxCodeBlockGroupsPerTransportBlock indicating a maximum number N_{HARQ-ACK}^{CBG/TB,max} of CBGs for generating respective HARQ-ACK information bits for a transport block reception for the serving cell.

For a number of C code blocks (CBs) in a transport block, the UE determines a number of CBGs M according to [TS 38.214] and determines a number of HARQ-ACK bits for the transport block as N_{HARQ-ACK}^{CBG/TB,max}=M.

The UE generates an ACK for the HARQ-ACK information bit of a CBG if the UE correctly received all code blocks of the CBG and generates a NACK for the HARQ-ACK information bit of a CBG if the UE incorrectly received at least one code block of the CBG. If the UE receives two transport blocks, the UE concatenates the HARQ-ACK information bits for CBGs of the second transport block after the HARQ-ACK information bits for CBGs of the first transport block.

The HARQ-ACK codebook includes the N_{HARQ-ACK}^{CBG/TB,max} HARQ-ACK information bits and, if N_{HARQ-ACK}^{CBG/TB}<N_{HARQ-ACK}^{CBG/TB,max} for a transport block, the UE generates a NACK value for the last N_{HARQ-ACK}^{CBG/TB,max}−N_{HARQ-ACK}^{CBG/TB} HARQ-ACK information bits for the transport block in the HARQ-ACK codebook.

If the UE generates a HARQ-ACK codebook in response to a retransmission of a transport block, corresponding to a same HARQ process as a previous transmission of the transport block, the UE generates an ACK for each CBG that the UE correctly decoded in a previous transmission of the transport block.

If a UE correctly detects each of the N_{HARQ-ACK}^{CBG/TB} CBGs and does not correctly detect the transport block for the N_{HARQ-ACK}^{CBG/TB} CBGs, the UE generates a NACK value for each of the N_{HARQ-ACK}^{CBG/TB} CBGs.

This clause applies if the UE is configured with pdsch-HARQ-ACK-Codebook=semi-static.

A UE does not expect to be configured with pdsch-HARQ-ACK-Codebook=semi-static for a codebook if a UE is provided subslotLength-ForPUCCH for the codebook.

A UE reports HARQ-ACK information for a corresponding PDSCH reception or SPS PDSCH release only in a HARQ-ACK codebook that the UE transmits in a slot indicated by a value of a PDSCH-to-HARQ_feedback timing indicator field in a corresponding DCI format. The UE reports NACK value(s) for HARQ-ACK information bit(s) in a HARQ-ACK codebook that the UE transmits in a slot not indicated by a value of a PDSCH-to-HARQ_feedback timing indicator field in a corresponding DCI format.

If a UE is not provided pdsch-HARQ-ACK-OneShotFeedback, the UE does not expect to receive a PDSCH scheduled by a DCI format that the UE detects in any PDCCH monitoring occasion and includes a PDSCH-to-HARQ_feedback timing indicator field providing an inapplicable value from dl-DataToUL-ACK-r16.

If the UE is provided pdsch-AggregationFactor-r16 in SPS-Config or pdsch-AggregationFactor in PDSCH-Config and no entry in pdsch-TimeDomainAllocationList and pdsch-TimeDomainAllocationListDCI-1-2 includes repetitionNumber in PDSCH-TimeDomainResourceAllocation-r16, N_{PDSCH}^{repeat,max} is a maximum value of pdsch-AggregationFactor-r16 in SPS-Config or pdsch-AggregationFactor in PDSCH-Config; otherwise N_{PDSCH}^{repeat,max}=1. The UE reports HARQ-ACK information for a PDSCH reception
from DL slot n_{D}−N_{PDSCH}^{repeat}+1 to DL slot n_{D}, if N_{PDSCH}^{repeat} is provided by pdsch-AggregationFactor or pdsch-AggregationFactor-r16 [TS 38.214], or
from DL slot n_{D}−repetitionNumber+1 to DL slot n_{D}, if the time domain resource assignment field in the DCI format scheduling the PDSCH reception indicates an entry containing repetitionNumber, or
in DL slot n_{D}, otherwise
   only in a HARQ-ACK codebook that the UE includes in a PUCCH or PUSCH transmission in slot n+k, where n is a UL slot overlapping with the end of the PDSCH reception in DL slot n_{D} and k is a number of slots indicated by the PDSCH-to-HARQ_feedback timing indicator field in a corresponding DCI format or provided by dl-DataToUL-ACK if the PDSCH-to-HARQ_feedback timing indicator field is not present in the DCI format. If the UE reports HARQ-ACK information for the PDSCH reception in a slot other than slot n+k, the UE sets a value for each corresponding HARQ-ACK information bit to NACK.

If a UE reports HARQ-ACK information in a PUCCH only for
a SPS PDSCH release indicated by DCI format 1_0 with counter DAI field value of 1, or
a PDSCH reception scheduled by DCI format 1_0 with counter DAI field value of 1 on the PCell, or
SPS PDSCH reception(s)
   within the M_{A,c} occasions for candidate PDSCH receptions as determined in clause 9.1.2.1, the UE determines a HARQ-ACK codebook only for the SPS PDSCH release or only for the PDSCH reception or only for one SPS PDSCH reception according to corresponding M_{A,c} occasion(s) on respective serving cell(s), where the value of counter DAI in DCI format 1_0 is according to Table 2 and HARQ-ACK information bits in response to more than one SPS PDSCH receptions that the UE is configured to receive are ordered according to the following pseudo-code; otherwise, the procedures for a HARQ-ACK codebook determination apply.

```
Set N_{cells}^{DL} to the number of serving cells configured to the UE
Set N_{c}^{SPS} to the number of SPS PDSCH configuration configured to the UE for serving cell c
Set N_{c}^{DL} to the number of DL slots for SPS PDSCH reception on serving cell c with HARQ-
ACK information multiplexed on the PUCCH
Set j = 0 − HARQ-ACK information bit index
Set c = 0 − serving cell index: lower indexes correspond to lower RRC indexes of
corresponding cell
  while c < N_{cells}^{DL}
  Set s = 0 − SPS PDSCH configuration index: lower indexes correspond to lower RRC
    indexes of corresponding SPS configurations
    while s < N_{c}^{SPS}
      Set n_{D} = 0 − slot index
        while n_{D} < N_{c}^{DL}
          if {
            a UE is configured to receive SPS PDSCHs from slot n_{D} − N_{PDSCH}^{repeat} + 1 to
            slot n_{D} for SPS PDSCH configuration s on serving cell c, excluding SPS
            PDSCHs that are not required to be received in any slot among overlapping
            SPS PDSCHs, if any according to [TS 38.214], or based on a UE capability
            for a number of PDSCH receptions in a slot according to [TS 38.214], or due
            to overlapping with a set of symbols indicated as uplink by tdd-UL-DL-
            ConfigurationCommon or by tdd-UL-DL-ConfigurationDedicated where
            N_{PDSCH}^{repeat} is provided by pdsch-AggregationFactor-r16 in sps-Config or, if
            pdsch-AggregationFactor-r16 is not included in sps-Config, by pdsch-
            AggregationFactor in pdsch-config, and HARQ-ACK information for the
            SPS PDSCH is associated with the PUCCH
            }
            õⱼ^{ACK} = HARQ-ACK information bit for this SPS PDSCH reception
            j = j + 1;
          end if
          n_{D} = n_{D} + 1;
        end while
        s = s + 1;
    end while
    c = c + 1;
  end while
```

This clause applies if the UE is configured with pdsch-HARQ-ACK-Codebook dynamic or with pdsch-HARQ-ACK-Codebook-r16. Unless stated otherwise, a PDSCH-to-HARQ_feedback timing indicator field provides an applicable value.

A UE does not expect to multiplex in a Type-2 HARQ-ACK codebook HARQ-ACK information that is in response to a detection of a DCI format that does not include a counter DAI field.

If a UE receives a first DCI format that the UE detects in a first PDCCH monitoring occasion and includes a PDSCH-to-HARQ_feedback timing indicator field providing an inapplicable value from dl-DataToUL-ACK-r16,
if the UE detects a second DCI format, the UE multiplexes the corresponding HARQ-ACK information in a PUCCH or PUSCH transmission in a slot that is indicated by a value of a PDSCH-to-HARQ_feedback timing indicator field in the second DCI format, where
   if the UE is not provided pdsch-HARQ-ACK-Codebook-r16, the UE detects the second DCI format in any PDCCH monitoring occasion after the first one, and where the slot indicated by the value of the PDSCH-to-HARQ_feedback timing indicator field in the second DCI format is no later than a slot for HARQ-ACK information in response to a SPS PDSCH reception, if any, received after the PDSCH scheduled by the first DCI format.
   if the UE is provided pdsch-HARQ-ACK-Codebook-r16, the UE detects the second DCI format in any PDCCH monitoring occasion after the first one, and the second DCI format indicates a HARQ-ACK information report for a same PDSCH group index as indicated by the first DCI format as described in clause 9.1.3.3, and where the slot indicated by the value of the PDSCH-to-HARQ_feedback timing indicator field in the second DCI format is no later than a slot for HARQ-ACK information in response to a SPS PDSCH reception, if any, received after the PDSCH scheduled by the first DCI format.
   if the UE is provided pdsch-HARQ-ACK-Codebook-r16, the UE receives the second DCI format later than the slot for HARQ-ACK information in response to a SPS PDSCH reception received after the PDSCH scheduled by the first DCI format, and the second DCI format indicates a HARQ-ACK information report for a same PDSCH group index as indicated by the first DCI format as described in clause 9.1.3.3.
   if the UE is provided pdsch-HARQ-ACK-OneShotFeedback, the first DCI format does not indicate SPS PDSCH release or SCell dormancy, the UE detects the second DCI format in any PDCCH monitoring occasion after the first one, and the second DCI format includes a One-shot HARQ-ACK request field with value 1, the UE includes the HARQ-ACK information in a Type-3 HARQ-ACK codebook, as described in clause 9.1.4, and where the slot indicated by the value of the PDSCH-to-HARQ_feedback timing indicator field in the second DCI format is no later than a slot for HARQ-ACK information in response to a SPS PDSCH reception, if any, received after the PDSCH scheduled by the first DCI format.
   if the UE is provided pdsch-HARQ-ACK-OneShotFeedback-r16, the first DCI format does not indicate SPS PDSCH release or SCell dormancy, and the UE receives the second DCI format later than the slot for HARQ-ACK information in response to a SPS PDSCH reception received after the PDSCH scheduled by the first DCI format, and the second DCI format includes a One-shot HARQ-ACK request field with value 1, the UE includes the HARQ-ACK information in a Type-3 HARQ-ACK codebook, as described in clause 9.1.4.
otherwise, the UE does not multiplex the corresponding HARQ-ACK information in a PUCCH or PUSCH transmission.

A UE constructs a Type-2 HARQ-ACK codebook in physical uplink control channel as follows.

A UE determines monitoring occasions for PDCCH with DCI format scheduling PDSCH receptions or SPS PDSCH release or indicating SCell dormancy on an active DL BWP of a serving cell c, and for which the UE transmits HARQ-ACK information in a same PUCCH in slot n based on
PDSCH-to-HARQ_feedback timing indicator field values for PUCCH transmission with HARQ-ACK information in slot n in response to PDSCH receptions, SPS PDSCH release or SCell dormancy indication
slot offsets K₀[TS 38.214] provided by time domain resource assignment field in a DCI format scheduling PDSCH receptions and by pdsch-AggregationFactor, or pdsch-AggregationFactor-r16, or repetitionNumber, when provided.

The set of PDCCH monitoring occasions for a DCI format scheduling PDSCH receptions or SPS PDSCH release or indicating SCell dormancy is defined as the union of PDCCH monitoring occasions across active DL BWPs of configured serving cells. PDCCH monitoring occasions are indexed in an ascending order of their start times. The cardinality of the set of PDCCH monitoring occasions defines a total number M of PDCCH monitoring occasions.

A value of the counter downlink assignment indicator (DAI) field in DCI formats denotes the accumulative number of {serving cell, PDCCH monitoring occasion}-pair(s) in which PDSCH reception(s), SPS PDSCH release or SCell dormancy indication associated with the DCI formats is present up to the current serving cell and current PDCCH monitoring occasion,
first, if the UE indicates by type2-HARQ-ACK-Codebook support for more than one PDSCH reception on a serving cell that are scheduled from a same PDCCH monitoring occasion, in increasing order of the PDSCH reception starting time for the same {serving cell, PDCCH monitoring occasion} pair,
second in ascending order of serving cell index, and
third in ascending order of PDCCH monitoring occasion index m, where 0≤m<M.

If, for an active DL BWP of a serving cell, the UE is not provided coresetPoolIndex or is provided coresetPoolIndex with value 0 for one or more first CORESETs and is provided coresetPoolIndex with value 1 for one or more second CORESETs, and is provided ackNackFeedbackMode=joint, the value of the counter DAI is in the order of the first CORESETs and then the second CORESETs for a same serving cell index and a same PDCCH monitoring occasion index.

The value of the total DAI, when present [TS 38.212], in a DCI format denotes the total number of {serving cell, PDCCH monitoring occasion}-pair(s) in which PDSCH reception(s), SPS PDSCH release or SCell dormancy indication associated with DCI formats is present, up to the current PDCCH monitoring occasion m and is updated from PDCCH monitoring occasion to PDCCH monitoring occasion. If, for an active DL BWP of a serving cell, the UE is not provided coresetPoolIndex or is provided coresetPoolIndex with value 0 for one or more first CORESETs and is provided coresetPoolIndex with value 1 for one or more second CORESETs, and is provided ackNackFeedbackMode=joint, the total DAI value counts the {serving cell, PDCCH monitoring occasion}-pair(s) for both the first CORESETs and the second CORESETs.

Denote by N_{c-DAI}^{DL} the number of bits for the counter DAI and set T_{D}=2^{N}^{_{c-DAI}}^{^{DL}}. Denote by V_{c-DAI,c,m}^{DL} the value of the counter DAI in a DCI format scheduling PDSCH reception, SPS PDSCH release or SCell dormancy indication on serving cell c in PDCCH monitoring occasion m according to Table 2 or Table 2A. Denote by V_{T-DAI,m}^{DL} the value of the total DAI in a DCI format in PDCCH monitoring occasion m according to Table 3. The UE assumes a same value of total DAI in all DCI formats that include a total DAI field in PDCCH monitoring occasion m. A UE does not expect to multiplex, in a same Type-2 HARQ-ACK codebook, HARQ-ACK information that is in response to detection of DCI formats with different number of bits for the counter DAI field.

If the UE transmits HARQ-ACK information in a PUCCH in slot n and for any PUCCH format, the UE determines the õ₀^{ACK}, õ₀^{ACK}, ⋅ ⋅ ⋅ õₒ_{_{ACK}}₋₁^{ACK}, for a total number of O_{ACK} HARQ-ACK information bits, according to the following pseudo-code:

```
  Set m = 0 − PDCCH with DCI format scheduling PDSCH reception, SPS PDSCH release
    or SCell dormancy indication monitoring occasion index: lower index corresponds to
    earlier PDCCH monitoring occasion
  Set j = 0
  Set Vₜₑₘₚ = 0
  Set Vₜₑₘₚ₂ = 0
  Set Vₛ = Ø
Set N_{cells}^{DL} to the number of serving cells configured by higher layers for the UE
    if, for an active DL BWP of a serving cell, the UE is not provided coresetPoolIndex or is
    provided coresetPoolIndex with value 0 for one or more first CORESETs and is
    provided coresetPoolIndex with value 1 for one or more second CORESETs, and is
    provided ACKNackFeedbackMode = JointFeedback, the serving cell is counted two
    times where the first time corresponds to the first CORESETs and the second time
    corresponds to the second CORESETs
    if the UE indicates type 2-HARQ-ACK-Codebook, a serving cell is counted N_{PDSCH}^{MO} times
    where N_{PDSCH}^{MO} is the number of PDSCH receptions that can be scheduled for the serving
    cell by DCI formats in PDCCH receptions at a same PDCCH monitoring occasion based
    on the reported value of type2-HARQ-ACK-Codebook
Set M to the number of PDCCH monitoring occasion(s)
while m < M
Set c = 0 − serving cell index: lower indexes correspond to lower RRC indexes of
  corresponding cell
while c < N_{cells}^{DL}
  if PDCCH monitoring occasion m is before an active DL BWP change on serving cell c or
  an active UL BWP change on the PCell and an active DL BWP change is not triggered in
  PDCCH monitoring occasion m
c = c + 1;
else
  if there is a PDSCH on serving cell c associated with PDCCH in PDCCH monitoring
  occasion m, or there is a PDCCH indicating SPS PDSCH release or SCell dormancy on
  serving cell c
if V_{C-DAI,c,m}^{DL} ≤ Vₜₑₘₚ
j = j + 1
end if
Vₜₑₘₚ = V_{C-DAI,c,m}^{DL}
if V_{T-DAI,m}^{DL} = Ø
V_{temp,2} = V_{C-DAI,c,m}^{DL}
else
V_{temp,2} = V_{T-DAI,m}^{DL}
end if
  if harq-ACK-SpatialBundlingPUCCH is not provided and the UE is configured by
  maxNrofCodeWordsScheduledByDCI with reception of two transport blocks for at least
  one configured DL BWP of at least one serving cell,
õ_{2·T}_{_{D}}_{·j+2(V}_{_{C-DAI,c,m}}_{^{DL}}₋₁₎^{ACK} = HARQ-ACK information bit corresponding to the first transport block
  of this cell
õ_{2·T}_{_{D}}_{·j+2(V}_{_{C-DAI,c,m}}_{^{DL}}₋₁₎₊₁^{ACK} = HARQ-ACK information bit corresponding to the second transport
  block of this cell
      Vₛ = Vₛ ∪ {2 · T_{D} · j + 2(V_{C-DAI,c,m}^{DL} − 1), 2 · T_{D} · j + 2(V_{C-DAI,c,m}^{DL} − 1) + 1}
  elseif harq-ACK-SpatialBundlingPUCCH is provided to the UE and m is a monitoring
  occasion for PDCCH with a DCI format that supports PDSCH reception with two transport
  blocks and the UE is configured by maxNrofCode WordsScheduledByDCI with reception of
  two transport blocks in at least one configured DL BWP of a serving cell,
õ_{2·T}_{_{D}}_{·j+V}_{_{C-DAI,c,m}}₋₁_{^{DL}}^{ACK} = binary AND operation of the HARQ-ACK information bits corresponding
  to the first and second transport blocks of this cell
Vₛ = Vₛ ∪ {T_{D} · j + V_{C-DAI,c,m}^{DL} − 1}
else
õ_{T}_{_{D}}_{·j+V}_{_{C-DAI,c,m}}_{^{DL}}₋₁^{ACK} = HARQ-ACK information bit of this cell
Vₛ = V_{S} ∪ {T_{D} · j + V_{C-DAI,c,m}^{DL} − 1}
end if
end if
c = c + 1
end if
end while
m = m + 1
end while
${V}_{temp} = ( j mod ( \frac{4}{{T}_{D}} ) ) \times ( \frac{4}{{T}_{D}} ) + {V}_{temp}$
if UE does not set Vₜₑₘₚ₂ = V_{T-DAI}^{UL} and T_{D} = 2
Vₜₑₘₚ₂ = Vₜₑₘₚ
end if
$j = ⌊ \frac{j \times {T}_{D}}{4} ⌋$
if Vₜₑₘₚ₂ < Vₜₑₘₚ
j = j + 1
end if
  if harq-ACK-SpatialBundlingPUCCH is not provided to the UE and the UE is configured by
  maxNrofCodeWordsScheduledByDCI with reception of two transport blocks for at least one
  configured DL BWP of a serving cell,
O^{ACK} = 2 · (4 · j + Vₜₑₘₚ₂)
else
O^{ACK} = 4 · j + Vₜₑₘₚ₂
end if
õᵢ^{ACK} = NACK for any i ∈ {0, 1, · · ·, O^{ACK} − 1}\Vₛ
```

If a UE is configured to receive SPS PDSCH and the UE multiplexes HARQ-ACK information for one activated SPS PDSCH reception in the PUCCH in slot n, the UE generates one HARQ-ACK information bit associated with the SPS PDSCH reception and appends it to the O^{ACK} HARQ-ACK information bits.

If a UE is configured to receive SPS PDSCH and the UE multiplexes HARQ-ACK information for multiple activated SPS PDSCH receptions in the PUCCH in slot n, the UE generates the HARQ-ACK information as described in clause 9.1.2 and appends it to the O^{ACK} HARQ-ACK information bits.

For a PDCCH monitoring occasion with DCI format scheduling PDSCH reception or SPS PDSCH release or indicating SCell dormancy in the active DL BWP of a serving cell, when a UE receives a PDSCH with one transport block or a SPS PDSCH release or indicating SCell dormancy and the value of maxNrofCodeWordsScheduledByDCI is 2, the HARQ-ACK information is associated with the first transport block and the UE generates a NACK for the second transport block if harq-ACK-SpatialBundlingPUCCH is not provided and generates HARQ-ACK information with value of ACK for the second transport block if harq-ACK-SpatialBundlingPUCCH is provided.

If a UE is not provided PDSCH-CodeBlockGroupTransmission for each of the N_{cells}^{DL} serving cells, or for PDSCH receptions scheduled by a DCI format that does not support CBG-based PDSCH receptions, or for SPS PDSCH reception, or for SPS PDSCH release, or for SCell dormancy indication, and if O_{ACK}+O_{SR}+O_{CSI}≤11, the UE determines a number of HARQ-ACK information bits n_{HARQ-ACK} for obtaining a transmission power for a PUCCH as

$${n}_{HARQ - ACK} = {n}_{HARQ - ACK , TB} = ( ( {V}_{DAI , {m}_{last}}^{DL} - {\sum }_{c = 0}^{{N}_{cells}^{DL} - 1} {U}_{DAI , c} ) mod ( {T}_{D} ) ) {N}_{TB , max}^{DL} + {\sum }_{c = 0}^{{N}_{cells}^{DL} - 1} ( {\sum }_{m = 0}^{M - 1} {N}_{m , c}^{received} + {N}_{SPS , c} )$$

where
if N_{cells}^{DL}=1 V_{DAI,m}_{ₗₐₛₜ}^{DL} is the value of the counter DAI in the last DCI format scheduling PDSCH reception or indicating SPS PDSCH release or indicating SCell dormancy, for any serving cell c that the UE detects within the M PDCCH monitoring occasions.
if N_{cells}^{DL}>1
   if the UE does not detect any DCI format that includes a total DAI field in a last PDCCH monitoring occasion within the M PDCCH monitoring occasions where the UE detects at least one DCI format scheduling PDSCH reception, indicating SPS PDSCH release or indicating SCell dormancy for any serving cell c, V_{DAI,m}_{ₗₐₛₜ}^{DL} is the value of the counter DAI in a last DCI format the UE detects in the last PDCCH monitoring occasion
   if the UE detects at least one DCI format that includes a total DAI field in a last PDCCH monitoring occasion within the M PDCCH monitoring occasions where the UE detects at least one DCI format scheduling PDSCH reception, indicating SPS PDSCH release or indicating SCell dormancy for any serving cell c, V_{DAI,m}_{ₗₐₛₜ}^{DL} is the value of the total DAI in the at least one DCI format that includes a total DAI field.
V_{DAI,m}_{ₗₐₛₜ}^{DL}=0 if the UE does not detect any DCI format scheduling PDSCH reception, indicating SPS PDSCH release or indicating SCell dormancy for any serving cell c in any of the M PDCCH monitoring occasions.
U_{DAI,c} is the total number of a DCI format scheduling PDSCH reception, indicating SPS PDSCH release or indicating SCell dormancy that the UE detects within the M PDCCH monitoring occasions for serving cell c. U_{DAI,c}=0 if the UE does not detect any DCI format scheduling PDSCH reception, indicating SPS PDSCH release or indicating SCell dormancy for serving cell c in any of the M PDCCH monitoring occasions.
N_{TB,max}^{DL}=2 if the value of maxNrofCodeWordsScheduledByDCI is 2 for any serving cell c and harq-ACK-SpatialBundlingPUCCH is not provided; otherwise, N_{TB,max}^{DL}=1.
N_{m,c}^{received} is the number of transport blocks the UE receives in a PDSCH scheduled by a DCI format that the UE detects in PDCCH monitoring occasion m for serving cell c if harq-ACK-SpatialBundlingPUCCH is not provided, or the number of PDSCH scheduled by a DCI format that the UE detects in PDCCH monitoring occasion m for serving cell c if harq-ACK-SpatialBundlingPUCCH is provided, or the number of DCI format that the UE detects and indicate SPS PDSCH release in PDCCH monitoring occasion m for serving cell c, or the number of DCI format that the UE detects and indicate SCell dormancy in PDCCH monitoring occasion m for serving cell c.
N_{SPS,c} is the number of SPS PDSCH receptions by the UE on serving cell c for which the UE transmits corresponding HARQ-ACK information in the same PUCCH as for HARQ-ACK information corresponding to PDSCH receptions within the M PDCCH monitoring occasions.

If a UE
is provided PDSCH-CodeBlockGroup Transmission for N_{cells}^{DL,CBG} serving cells; and
is not provided PDSCH-CodeBlockGroupTransmission, for N_{cells}^{DL,TB} serving cells where N_{cells}^{DL,TB}+N_{cells}^{DL,CBG}=N_{cells}^{DL}
   the UE determines the õ₀^{ACK}, õ₁^{ACK}, ⋅ ⋅ ⋅ , õₒ_{_{ACK}}₋₁^{ACK} according to the previous pseudo-code with the following modifications
N_{cells}^{DL} is used for the determination of a first HARQ-ACK sub-codebook for
   SPS PDSCH release,
   SPS PDSCH reception,
   DCI format 1_1 indicating SCell dormancy, and
   for TB-based PDSCH receptions on the N_{cells}^{DL,CBG} serving cells and on the N_{cells}^{DL,CBG} serving cells,
N_{cells}^{DL} is replaced by N_{cells}^{DL,CBG} for the determination of a second HARQ-ACK sub-codebook corresponding to the N_{cells}^{DL,CBG} serving cells for CBG-based PDSCH receptions, and
if, for an active DL BWP of a serving cell, the UE is not provided coresetPoolIndex or is provided coresetPoolIndex with value 0 for one or more first CORESETs and is provided coresetPoolIndex with value 1 for one or more second CORESETs, and is provided ackNackFeedbackMode=joint, the serving cell is counted as two times where the first time corresponds to the first CORESETs and the second time corresponds to the second CORESETs, and
   instead of generating one HARQ-ACK information bit per transport block for a serving cell from the N_{cells}^{DL,CBG} serving cells, the UE generates N_{HARQ-ACK,max}^{CBG/TB,max} HARQ-ACK information bits, where N_{HARQ-ACK,c}^{CBG/TB,max} is the maximum value of N_{TB,c}^{DL}·N_{HARQ-ACK,c}^{CBG/TB,max} across all N_{cells}^{DL,CBG} serving cells and N_{TB,c}^{DL} is the value of maxNrofCodeWordsScheduledByDCI for serving cell c. If for a serving cell c it is N_{TB,c}^{DL}·N_{HARQ-ACK,c}^{CBG/TB,max}<N_{HARQ-ACK,max}^{CBG/TB,max}, the UE generates NACK for the last N_{HARQ-ACK,max}^{CBG/TB,max}−N_{TB,c}^{DL}·N_{HARQ-ACK,c}^{CBG/TB,max} HARQ-ACK information bits for serving cell c
   the pseudo-code operation when harq-ACK-SpatialBundlingPUCCH is provided is not applicable
The counter DAI value and the total DAI value apply separately for each HARQ-ACK sub-codebook
The UE generates the HARQ-ACK codebook by appending the second HARQ-ACK sub-codebook to the first HARQ-ACK sub-codebook

If O_{ACK}+O_{SR}+O_{CSI}≤11, the UE also determines n_{HARQ-ACK}=n_{HARQ-ACK,TB}+n_{HARQ-ACK,CBG} for obtaining a PUCCH transmission power with

$${n}_{HARQ - ACK , CBG} = ( ( {V}_{DAI , {m}_{last}}^{DL} - {\sum }_{c = 0}^{{N}_{cells}^{DL , CBG} - 1} {U}_{DAI , c}^{CBG} ) mod ( {T}_{D} ) ) {N}_{HARQ - ACK , max}^{CBG / TB , max} + {\sum }_{c = 0}^{{N}_{cells}^{DL} - 1} {\sum }_{m = 0}^{M - 1} {N}_{m , c}^{received , CBG}$$

where
if N_{cells}^{DL}=1, V_{DAI,m}_{ₗₐₛₜ}^{DL} is the value of the counter DAI in the last DCI format scheduling CBG-based PDSCH reception for any serving cell c that the UE detects within the M PDCCH monitoring occasions
if N_{cells}^{DL}>1, V_{DAI,m}_{ₗₐₛₜ}^{DL} is the value of the total DAI in the last DCI format scheduling CBG-based PDSCH reception for any serving cell c that the UE detects within the M PDCCH monitoring occasions
V_{DAI,m}_{ₗₐₛₜ}^{DL}=0, if the UE does not detect any DCI format scheduling CBG-based PDSCH reception for any serving cell c in any of the M PDCCH monitoring occasions
U_{DAI,c}^{CBG} is the total number of DCI formats scheduling CBG-based PDSCH receptions that the UE detects within the M PDCCH monitoring occasions for serving cell c. U_{DAI,c}^{CBG}=0 if the UE does not detect any DCI format scheduling CBG-based PDSCH reception for serving cell c in any of the M PDCCH monitoring occasions N_{m,c}^{received,CBG} is the number of CBGs the UE receives in a PDSCH scheduled by a DCI format that supports CBG-based PDSCH reception that the UE detects in PDCCH monitoring occasion m for serving cell c and the UE reports corresponding HARQ-ACK information in the PUCCH

TABLE 2
Value of counter DAI (C-DAI) for N_{C-DAI}^{DL} = 2 and of total DAI

| | | Number of {serving cell, PDCCH monitoring occasion}-pair(s) |
|---|---|---|
| | V_{C-DAI}^{DL} | in which PDSCH transmission(s) associated with PDCCH or |
| DAI | or | PDCCH indicating SPS PDSCH release or DCI format 1_1 |
| MSB, LSB | V_{T-DAI}^{DL} | indicating SCell dormancy is present, denoted as Y and Y ≥ 1 |
| 0, 0 | 1 | (Y − 1) mod T_{D} + 1 = 1 |
| 0, 1 | 2 | (Y − 1) mod T_{D} + 1 = 2 |
| 1, 0 | 3 | (Y − 1) mod T_{D} + 1 = 3 |
| 1, 1 | 4 | (Y − 1) mod T_{D} + 1 = 4 |

TABLE 2A
Value of counter DAI (C-DAI) for N_{C-DAI}^{DL} = 1

| | | Number of {serving cell, PDCCH monitoring |
|---|---|---|
| | | occasion} - pair(s) in which PDSCH transmission(s) |
| | | associated with PDCCH or PDCCH indicating SPS |
| DAI | V_{C-DAI}^{DL} | PDSCH release is present, denoted as Y and Y ≥ 1 |
| 0 | 1 | (Y − 1) mod T_{D} + 1 = 1 |
| 1 | 2 | (Y − 1) mod T_{D} + 1 = 2 |

A UE constructs a Type-2 HARQ-ACK codebook in physical uplink shared channel as follows.

If a UE would multiplex HARQ-ACK information in a PUSCH transmission that is not scheduled by a DCI format or is scheduled by a DCI format that does not include a DAI field, then
if the UE has not received any PDCCH within the monitoring occasions for DCI formats scheduling PDSCH receptions, or SPS PDSCH release, or DCI format 1_1 indicating SCell dormancy on any serving cell c and the UE does not have HARQ-ACK information in response to a SPS PDSCH reception, or in response to a detection of a DCI format 1_1 indicating SCell dormancy, to multiplex in the PUSCH, the UE does not multiplex HARQ-ACK information in the PUSCH transmission;
else, the UE generates the HARQ-ACK codebook as described for a Type-2 HARQ-ACK codebook in physical uplink control channel, except that harq-ACK-SpatialBundlingPUCCH is replaced by harq-ACK-SpatialBundlingPUSCH.

If a UE multiplexes HARQ-ACK information in a PUSCH transmission that is scheduled by a DCI format that includes a DAI field, the UE generates the HARQ-ACK codebook as described in clause 9.1.3.1, with the following modifications:
For the pseudo-code for the HARQ-ACK codebook generation for a Type-2 HARQ-ACK codebook in physical uplink control channel, after the completion of the c and m loops, the UE sets Vₜₑₘₚ₂=V_{T-DAI}^{UL} where V_{T-DAI}^{UL} is the value of the DAI field according to Table 3
For the case of first and second HARQ-ACK sub-codebooks, the DCI format includes a first DAI field corresponding to the first HARQ-ACK sub-codebook and a second DAI field corresponding to the second HARQ-ACK sub-codebook
harq-ACK-SpatialBundlingPUCCH is replaced by harq-ACK-SpatialBundlingPUSCH.

If a UE is not provided PDSCH-CodeBlockGroupTransmission and the UE is scheduled for a PUSCH transmission by DCI format that includes a DAI field with value V_{T-DAI}^{UL}=4 and the UE has not received any PDCCH within the monitoring occasions for PDCCH with DCI format scheduling PDSCH receptions or SPS PDSCH release or indicating SCell dormancy on any serving cell c and the UE does not have HARQ-ACK information in response to a SPS PDSCH reception to multiplex in the PUSCH, the UE does not multiplex HARQ-ACK information in the PUSCH transmission.

If a UE is provided PDSCH-CodeBlockGroupTransmission and the UE is scheduled for a PUSCH transmission by DCI format that includes a DAI field with first value V_{T-DAI}^{UL}=4 or with second value V_{T-DAI}^{UL}=4 and the UE has not received any PDCCH within the monitoring occasions for PDCCH with DCI format scheduling PDSCH receptions or SPS PDSCH release, or DCI format 1_1 indicating SCell dormancy, on any serving cell c and the UE does not have HARQ-ACK information in response to a SPS PDSCH reception to multiplex in the PUSCH, the UE does not multiplex HARQ-ACK information for the first sub-codebook or for the second sub-codebook, respectively, in the PUSCH transmission.

TABLE 3
Value of T-DAI

| | | Number of {serving cell, PDCCH monitoring occasion}-pair(s) |
|---|---|---|
| | | in which PDSCH transmission(s) associated with PDCCH or |
| DAI | | PDCCH indicating SPS PDSCH release or DCI format 1_1 |
| MSB, LSB | V_{T-DAI}^{UL} | indicating SCell dormancy is present, denoted as X and X ≥ 1 |
| 0, 0 | 1 | (X − 1) mod 4 + 1 = 1 |
| 0, 1 | 2 | (X − 1) mod 4 + 1 = 2 |
| 1, 0 | 3 | (X − 1) mod 4 + 1 = 3 |
| 1, 1 | 4 | (X − 1) mod 4 + 1 = 4 |

A UE generates a Type-3 HARQ-ACK codebook determination as follows.

If a UE is provided pdsch-HARQ-ACK-OneShotFeedback, the UE determines õ₀^{ACK}, õ₁^{ACK}, . . . , õₒ_{_{ACK}}₋₁^{ACK} information bits, for a total number of O_{ACK} HARQ-ACK information bits, of a Type-3 HARQ-ACK codebook according to the following procedure.

```
Set N_{cells}^{DL} to the number of configured serving cells
Set N_{HARQ,c}^{DL} to the value of nrofHARQ-ProcessesForPDSCH for serving cell c, if provided;
else, set N_{HARQ,c}^{DL} = 8
Set N_{TB,c}^{DL} to the value of maxNrofCodeWordsScheduledByDCI for serving cell c if harq-ACK-
SpatialBundlingPUCCH is provided and NDI_{HARQ} = 0, or if harq-ACK-
SpatialBundlingPUCCH is not provided, or if maxCodeBlockGroupsPerTransportBlock is
provided for serving cell c; else, set N_{TB,c}^{DL} = 1
Set N_{HARQ-ACK,c}^{CBG/TB,max} to the number of HARQ-ACK information bits per TB for PDSCH receptions
on serving cell c as described in clause 9.1.1 if maxCodeBlockGroupsPerTransportBlock is
provided for serving cell c and pdsch-HARQ-ACK-OneShotFeedbackCBG is provided; else, set
N_{HARQ-ACK,c}^{CBG/TB,max} = 0
Set NDI_{HARQ} = 0 if pdsch-HARQ-ACK-OneShotFeedbackNDI is provided; else set
NDI_{HARQ} = 1
Set c = 0 − serving cell index
Set h = 0 − HARQ process number
Set t = 0 − TB index
Set g = 0 − CBG index
Set j = 0
  while c < N_{cells}^{DL}
    while h < N_{HARQ,c}^{DL}
      if NDI_{HARQ} = 0
        if N_{HARQ-ACK,c}^{CBG/TB,max} > 0
          while t < N_{TB,c}^{DL}
            while g < N_{HARQ-ACK,c}^{CBG/TB,max}
              õⱼ^{ACK} = HARQ-ACK information bit for CBG g of TB t for HARQ process
                number h of serving cell c, if any; else, õⱼ^{ACK} = 0
```

```
          j = j + 1
          g = g + 1
```

```
            end while
            õⱼ^{ACK} = NDI value indicated in the DCI format corresponding to the HARQ-
              ACK information bit(s) for TB t for HARQ process number h on serving
              cell c, if any; else, õⱼ^{ACK} = 0
```

```
            g = 0
        j = j + 1
        t = t + 1
```

```
          end while
        else
          while t < N_{TB,c}^{DL}
            õⱼ^{ACK} = HARQ-ACK information bit for TB t for HARQ process h of
              serving cell c, if any; else, õⱼ^{ACK} = 0
```

j = j + 1

```
            õⱼ^{ACK} = NDI value indicated in the DCI format corresponding to the HARQ-
              ACK information bit(s) for TB t for HARQ process number h on serving
              cell c, if any; else, õⱼ^{ACK} = 0
```

```
        j = j + 1
        t = t + 1
```

```
          end while
        end if
```

t = 0

```
      else
        if N_{HARQ-ACK,c}^{CBG/TB,max} > 0
          while t < N_{TB,c}^{DL}
            if UE has obtained HARQ-ACK information for TB t for HARQ process
              number h on serving cell c corresponding to a PDSCH reception and has
              not reported the HARQ-ACK information corresponding to the PDSCH
              reception
              while g < N_{HARQ-ACK,c}^{CBG/TB,max}
                õⱼ^{ACK} = HARQ-ACK information bit for CBG g of TB t for HARQ
                  process number h of serving cell c
```

```
                j = j + 1
              g = g + 1
```

```
              end while
            else
              while g < N_{HARQ-ACK,c}^{CBG/TB,max}
                õⱼ^{ACK} = NACK
```

```
                j = j + 1
              g = g + 1
```

```
              end while
            end if
```

```
            g = 0
        t = t + 1
```

```
          end while
        else
          while t < N_{TB,c}^{DL}
            if UE has obtained HARQ-ACK information for TB t for HARQ process
              number h on serving cell c corresponding to a PDSCH reception and has
              not reported the HARQ-ACK information corresponding to the PDSCH
              reception
              if harq-ACK-SpatialBundlingPUCCH is not provided
              õⱼ^{ACK} = HARQ-ACK information bit for TB t for HARQ process h of
                serving cell c
              else
              õⱼ^{ACK} = binary AND operation of the HARQ-ACK information bits
                corresponding to first and second transport blocks for HARQ process h
                of serving cell c. If the UE receives one transport block, the UE assumes
                ACK for the second transport block
              end if
```

```
          j = j + 1
          t = t + 1
```

```
            else
              õⱼ^{ACK} = NACK
```

```
          j = j + 1
          t = t + 1
```

```
            end if
          end while
        end if
```

t = 0

end if

h = h + 1

end while

h = 0
c = c + 1

end while

If N_{TB,c}^{DL}>1, when a UE receives a PDSCH with one transport block, the HARQ-ACK information is associated with the first transport block.

If a UE receives a SPS PDSCH, or a PDSCH that is scheduled by a DCI format that does not support CBG-based PDSCH receptions for a serving cell c and if maxCodeBlockGroupsPerTransportBlock is provided for serving cell c, and pdsch-HARQ-ACK-OneShotFeedbackCBG is provided, the UE repeats N_{HARQ-ACK,c}^{CBG/TB,max} times the HARQ-ACK information for the transport block in the PDSCH.

If a UE detects a DCI format that includes a One-shot HARQ-ACK request field with value 1, the UE determines a PUCCH or a PUSCH to multiplex a Type-3 HARQ-ACK codebook for transmission in a slot. The UE multiplexes only the Type-3 HARQ-ACK codebook in the PUCCH or the PUSCH for transmission in the slot.

If
a UE detects a DCI format that includes a One-shot HARQ-ACK request field with value 1, and
the CRC of the DCI is scrambled by a C-RNTI or an MCS-C-RNTI, and
resourceAllocation=resourceAllocationType0 and all bits of the frequency domain resource assignment field in the DCI format are equal to 0, or
resourceAllocation=resourceAllocationType1 and all bits of the frequency domain resource assignment field in the DCI format are equal to 1, or
resourceAllocation=dynamicSwitch and all bits of the frequency domain resource assignment field in the DCI format are equal to 0 or 1
   the DCI format provides a request for a Type-3 HARQ-ACK codebook report and does not schedule a PDSCH reception. The UE is expected to provide HARQ-ACK information in response to the request for the Type-3 HARQ-ACK codebook after N symbols from the last symbol of a PDCCH providing the DCI format, where the value of N for y=0, 1, 2 is provided in clause 10.2 by replacing “SPS PDSCH release” with “DCI format”.

If a UE multiplexes HARQ-ACK information in a PUSCH transmission, the UE generates the HARQ-ACK codebook as described in this clause except that harq-ACK-SpatialBundlingPUCCH is replaced by harq-ACK-SpatialBundlingPUSCH.

UCI types reported in a PUCCH include HARQ-ACK information, SR, LRR, and CSI. UCI bits include HARQ-ACK information bits, if any, SR information bits, if any, LRR information bit, if any, and CSI bits, if any. The HARQ-ACK information bits correspond to a HARQ-ACK codebook. For the remaining of this clause, any reference to SR is applicable for SR and/or for LRR.

A UE may transmit one or two PUCCHs on a serving cell in different symbols within a slot. When the UE transmits two PUCCHs in a slot and the UE is not provided ackNackFeedbackMode=separate, at least one of the two PUCCHs uses PUCCH format 0 or PUCCH format 2.

If a UE is provided ackNackFeedbackMode=separate, the UE may transmit up to two PUCCHs with HARQ-ACK information in different symbols within a slot.

A UE assumes 11 CRC bits if a number of respective UCI bits is larger than or equal to 360; otherwise, the UE determines a number of CRC bits based on the number of respective UCI bits as described in [TS 38.212].

If a UE does not have dedicated PUCCH resource configuration, provided by PUCCH-ResourceSet in PUCCH-Config, a PUCCH resource set is provided by pucch-ResourceCommon through an index to a row of [Table 9.2.1-1, TS 38.213] for transmission of HARQ-ACK information on PUCCH in an initial UL BWP of N_{BWP}^{size} PRBs.

The PUCCH resource set includes sixteen resources, each corresponding to a PUCCH format, a first symbol, a duration, a PRB offset RB_{BWP}^{offset}, and a cyclic shift index set for a PUCCH transmission.

The UE transmits a PUCCH using frequency hopping if not provided uselnterlacePUCCH-PUSCH in BWP-UplinkCommon; otherwise, the UE transmits a PUCCH without frequency hopping.

An orthogonal cover code with index 0 is used for a PUCCH resource with PUCCH format 1 in [Table 9.2.1-1, TS 38.213].

The UE transmits the PUCCH using the same spatial domain transmission filter as for a PUSCH transmission scheduled by a RAR UL grant.

If a UE is not provided any of pdsch-HARQ-ACK-Codebook, pdsch-HARQ-ACK-Codebook-r16, or pdsch-HARQ-ACK-OneShotFeedback, the UE generates at most one HARQ-ACK information bit.

If the UE provides HARQ-ACK information in a PUCCH transmission in response to detecting a DCI format scheduling a PDSCH reception or a SPS PDSCH release, the UE determines a PUCCH resource with index r_{PUCCH}, 0≤r_{PUCCH}≤15, as

$${r}_{PUCCH} = ⌊ \frac{2 \cdot {n}_{CCE , 0}}{{N}_{CCE}} ⌋ + 2 \cdot {Δ}_{PRI} ,$$

where N_{CCE} is a number of CCEs in a CORESET of a PDCCH reception with the DCI format, n_{CCE,0} is the index of a first CCE for the PDCCH reception, and Δ_{PRI} is a value of the PUCCH resource indicator field in the DCI format.

If └r_{PUCCH}/8┘=0 and a UE is provided a PUCCH resource by pucch-ResourceCommon and is not provided uselnterlacePUCCH-PUSCH in BWP-UplinkCommon
the UE determines the PRB index of the PUCCH transmission in the first hop as RB_{BWP}^{offset}+└r_{PUCCH}/N_{CS}┘ and the PRB index of the PUCCH transmission in the second hop as N_{BWP}^{size}−1−RB_{BWP}^{offset}−└r_{PUCCH}/N_{CS}┘, where N_{CS} is the total number of initial cyclic shift indexes in the set of initial cyclic shift indexes
the UE determines the initial cyclic shift index in the set of initial cyclic shift indexes as r_{PUCCH} modN_{CS}

If └r_{PUCCH}/8┘=1 and a UE is provided a PUCCH resource by pucch-ResourceCommon and is not provided uselnterlacePUCCH-PUSCH in BWP-UplinkCommon
the UE determines the PRB index of the PUCCH transmission in the first hop as N_{BWP}^{size}−1−RB_{BWP}^{offset}−└(r_{PUCCH}−8)/N_{CS}┘ and the PRB index of the PUCCH transmission in the second hop as RB_{BWP}^{offset}+└(r_{PUCCH}−8)/N_{CS}┘;
the UE determines the initial cyclic shift index in the set of initial cyclic shift indexes as (r_{PUCCH}−8)modN_{CS}.

If a UE is provided a PUCCH resource by pucch-ResourceCommon and is provided useInterlacePUCCH-PUSCH in BWP-UplinkCommon
the UE determines for the PUCCH resource an interlace index m as m=(m₀+└r_{PUCCH}/N_{CS}┘)modM where M is a number of interlaces [TS 38.211] and m₀=RB_{BWP}^{offset} is an interlace index offset and RB_{BWP}^{offset} is as given in [Table 9.2.1-1, TS 38.213]
the UE determines an initial cyclic shift index in a set of initial cyclic shift indexes as r_{PUCCH} modN_{CS}, where N_{CS} is the total number of initial cyclic shifts indexes in the set of initial cyclic shift indexes in [Table 9.2.1-1, TS 38.213]
if pucch-ResourceCommon indicates
   index 0: the first symbol is 9 for a PUCCH resource with PUCCH format 0 if r_{PUCCH}≥10
   index 1 or 2: the first symbol is 9 for a PUCCH resource with PUCCH format 0 if r_{PUCCH}=15
   index 3, 7, or 11: an orthogonal cover code with index 1 is used for a PUCCH resource with PUCCH format 1 if r_{PUCCH}≥10
the UE does not expect pucch-ResourceCommon to indicate index 15

A UE can be configured up to four sets of PUCCH resources in a PUCCH-Config. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadSize. For the first PUCCH resource set, the maximum number of UCI information bits is 2. A maximum number of PUCCH resource indexes for a set of PUCCH resources is provided by maxNrofPUCCH-ResourcesPerSet. The maximum number of PUCCH resources in the first PUCCH resource set is 32 and the maximum number of PUCCH resources in the other PUCCH resource sets is 8.

If the UE transmits O_{UCI} UCI information bits, that include HARQ-ACK information bits, the UE determines a PUCCH resource set to be
a first set of PUCCH resources withpucch-ResourceSetId=0 if O_{UCI}≤2 including 1 or 2 HARQ-ACK information bits and a positive or negative SR on one SR transmission occasion if transmission of HARQ-ACK information and SR occurs simultaneously, or
a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources withpucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

If the UE is provided SPS-PUCCH-AN-List and transmits O_{UCI} UCI information bits that include only HARQ-ACK information bits in response to one or more SPS PDSCH receptions and SR, if any, the UE determines a PUCCH resource to be
a PUCCH resource provided by sps-PUCCH-AN-ResourceID obtained from the first entry in sps-PUCCH-AN-List if O_{UCI}≤2 including 1 or 2 HARQ-ACK information bits and a positive or negative SR on one SR transmission occasion if transmission of HARQ-ACK information and SR occurs simultaneously, or
a PUCCH resource provided by sps-PUCCH-AN-ResourceID obtained from the second entry in sps-PUCCH-AN-List, if provided, if 2<O_{UCI}≤N_{1,sps} where N_{1,sps} is either provided by maxPayloadSize obtained from the second entry in sps-PUCCH-AN-List or is otherwise equal to 1706, or
a PUCCH resource provided by sps-PUCCH-AN-ResourceID obtained from the third entry in sps-PUCCH-AN-List, if provided, if N_{1,sps}<O_{UCI}≤N_{2,sps} where N_{2,sps} is either provided by maxPayloadSize obtained from the third entry in sps-PUCCH-AN-List or is otherwise equal to 1706, or
a PUCCH resource provided by sps-PUCCH-AN-ResourceID obtained from the fourth entry in sps-PUCCH-AN-List, if provided, if N_{2,sps}<Ouc₁≤N_{3,sps} where N_{3,sps} is equal to 1706.

UE procedure for reporting HARQ-ACK is as follows.

A UE does not expect to transmit more than one PUCCH with HARQ-ACK information in a slot per priority index, if the UE is not provided ackNackFeedbackMode=separate.

For DCI format 10, the PDSCH-to-HARQ_feedback timing indicator field values map to {1, 2, 3, 4, 5, 6, 7, 8}. For a DCI format, other than DCI format 1_0, scheduling a PDSCH reception or a SPS PDSCH release, the PDSCH-to-HARQ_feedback timing indicator field values, if present, map to values for a set of number of slots provided by dl-DataToUL-ACK, dl-DataToUL-ACK-r16, or dl-DataToUL-ACKForDCIFormat1_2, as defined in Table 4.

For a SPS PDSCH reception ending in slot n, the UE transmits the PUCCH in slot n+k where k is provided by the PDSCH-to-HARQ_feedback timing indicator field, if present, in a DCI format activating the SPS PDSCH reception.

If the UE detects a DCI format that does not include a PDSCH-to-HARQ_feedback timing indicator field and schedules a PDSCH reception or activates a SPS PDSCH reception ending in slot n, the UE provides corresponding HARQ-ACK information in a PUCCH transmission within slot n+k where k is provided by dl-DataToUL-ACK, or dl-DataToUL-ACK-r16, or dl-DataToUL-ACKForDCIFormat1_2.

With reference to slots for PUCCH transmissions, if the UE detects a DCI format scheduling a PDSCH reception ending in slot n or if the UE detects a DCI format indicating a SPS PDSCH release or indicating SCell dormancy through a PDCCH reception ending in slot n, or if the UE detects a DCI format that requests Type-3 HARQ-ACK codebook report and does not schedule a PDSCH reception through a PDCCH reception ending in slot n, the UE provides corresponding HARQ-ACK information in a PUCCH transmission within slot n+k, where k is a number of slots and is indicated by the PDSCH-to-HARQ_feedback timing indicator field in the DCI format, if present, or provided by dl-DataToUL-ACK, dl-DataToUL-ACK-r16, or dl-DataToUL-ACKForDCIFormat1_2. k=0 corresponds to the last slot of the PUCCH transmission that overlaps with the PDSCH reception or with the PDCCH reception in case of SPS PDSCH release or in case of SCell dormancy indication or in case of the DCI format that requests Type-3 HARQ-ACK codebook report and does not schedule a PDSCH reception.

A PUCCH transmission with HARQ-ACK information is subject to the limitations for UE transmissions described in clause 11.1 and clause 11.1.1 of [TS 38.213].

TABLE 4
Mapping of PDSCH-to-HARQ feedback timing indicator
field values to numbers of slots

| PDSCH-to-HARQ | | | |
|---|---|---|---|
| feedback | | | |
| timing indicator | | | |
| 1 | 2 | 3 | |
| bit | bits | bits | Number of slots k |
| ‘0’ | ‘00’ | ‘000’ | 1^{st} value provided by dl-DataToUL-ACK, dl- |
| | | | DataToUL-ACK-r16, or dl-DataToUL- |
| | | | ACKForDCIFormat1_2 |
| ‘1’ | ‘01’ | ‘001’ | 2^{nd} value provided by dl-DataToUL-ACK, dl- |
| | | | DataToUL-ACK-r16, or dl-DataToUL- |
| | | | ACKForDCIFormat1_2 |
| | ‘10’ | ‘010’ | 3^{rd} value provided by dl-DataToUL-ACK, dl- |
| | | | DataToUL-ACK-r16, or dl-DataToUL- |
| | | | ACKForDCIFormat1_2 |
| | ‘11’ | ‘011’ | 4^{th} value provided by dl-DataToUL-ACK, dl- |
| | | | DataToUL-ACK-r16, or dl-DataToUL- |
| | | | ACKForDCIFormat1_2 |
| | | ‘100’ | 5^{th} value provided by dl-DataToUL-ACK, dl- |
| | | | DataToUL-ACK-r16, or dl-DataToUL- |
| | | | ACKForDCIFormat1_2 |
| | | ‘101’ | 6^{th} value provided by dl-DataToUL-ACK, dl- |
| | | | DataToUL-ACK-r16, or dl-DataToUL- |
| | | | ACKForDCIFormat1_2 |
| | | ‘110’ | 7^{th} value provided by dl-DataToUL-ACK, dl- |
| | | | DataToUL-ACK-r16, or dl-DataToUL- |
| | | | ACKForDCIFormat1_2 |
| | | ‘111’ | 8^{th} value provided by dl-DataToUL-ACK, dl- |
| | | | DataToUL-ACK-r16, or dl-DataToUL- |
| | | | ACKForDCIFormat1_2 |

For a PUCCH transmission with HARQ-ACK information, a UE determines a PUCCH resource after determining a set of PUCCH resources for O_{UCI} HARQ-ACK information bits, as described in clause 9.2.1. The PUCCH resource determination is based on a PUCCH resource indicator field [TS 38.212], if present, in a last DCI format, among the DCI formats that have a value of a PDSCH-to-HARQ_feedback timing indicator field, if present, or a value of dl-DataToUL-ACK, or dIDataToUL-ACK-r16, or dIDataToUL-ACKForDCIFormat1_2, indicating a same slot for the PUCCH transmission, that the UE detects and for which the UE transmits corresponding HARQ-ACK information in the PUCCH where, for PUCCH resource determination, detected DCI formats are first indexed in an ascending order across serving cells indexes for a same PDCCH monitoring occasion and are then indexed in an ascending order across PDCCH monitoring occasion indexes. For indexing DCI formats within a serving cell for a same PDCCH monitoring occasion, if the UE is not provided coresetPoolIndex or is provided coresetPoolIndex with value 0 for one or more first CORESETs and is provided coresetPoolIndex with value 1 for one or more second CORESETs on an active DL BWP of a serving cell, and with ackNackFeedbackMode=joint for the active UL BWP, detected DCI formats from PDCCH receptions in the first CORESETs are indexed prior to detected DCI formats from PDCCH receptions in the second CORESETs.

The PUCCH resource indicator field values map to values of a set of PUCCH resource indexes, as defined in Table 5 for a PUCCH resource indicator field of 3 bits, provided by resourceList for PUCCH resources from a set of PUCCH resources provided by PUCCH-ResourceSet with a maximum of eight PUCCH resources. If the PUCCH resource indicator field includes 1 bit or 2 bits, the values map to the first two values or the first four values, respectively, of Table 5. If the last DCI format does not include a PUCCH resource indicator field, the first value of Table 5 is used.

For the first set of PUCCH resources and when the size R_{PUCCH} of resourceList is larger than eight, when a UE provides HARQ-ACK information in a PUCCH transmission in response to detecting a last DCI format in a PDCCH reception, among DCI formats with a value of the PDSCH-to-HARQ_feedback timing indicator field, if present, or a value of dl-DataToUL-ACK, or dl-DataToUL-ACK-r16, or dl-DataToUL-ACKForDCIFormat12, indicating a same slot for the PUCCH transmission, the UE determines a PUCCH resource with index r_{PUCCH}, 0≤r_{PUCCH}≤R_{PUCCH}−1, as

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ if \\ {Δ}_{PRI} < {R}_{PUCCH} mod 8\end{matrix} \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + {R}_{PUCCH} mod 8 if \\ {Δ}_{PRI} \geq {R}_{PUCCH} mod 8\end{matrix}\end{matrix} \}$$

where N_{CCE,p} is a number of CCEs in CORESET p of the PDCCH reception for the DCI format as described in clause 10.1, n_{CCE,p} is the index of a first CCE for the PDCCH reception, and Δ_{PRI} is a value of the PUCCH resource indicator field in the DCI format. If the DCI format does not include a PUCCH resource indicator field, Δ_{PRI}=0.

TABLE 5
Mapping of PUCCH resource indication field
values to a PUCCH resource in a PUCCH resource
set with maximum 8 PUCCH resources

| PUCCH resource | | | |
|---|---|---|---|
| indicator | | | |
| 1 | 2 | 3 | |
| bit | bits | bits | PUCCH resource |
| ‘0’ | ‘00’ | ‘000’ | 1^{st} PUCCH resource provided by pucch-ResourceId |
| | | | obtained from the 1^{st} value of resourceList |
| ‘1’ | ‘01’ | ‘001’ | 2^{nd} PUCCH resource provided by pucch-ResourceId |
| | | | obtained from the 2^{nd} value of resourceList |
| | ‘10’ | ‘010’ | 3^{rd} PUCCH resource provided by pucch-ResourceId |
| | | | obtained from the 3^{rd} value of resourceList |
| | ‘11’ | ‘011’ | 4^{th} PUCCH resource provided by pucch-ResourceId |
| | | | obtained from the 4^{th} value of resourceList |
| | | ‘100’ | 5^{th} PUCCH resource provided by pucch-ResourceId |
| | | | obtained from the 5^{th} value of resourceList |
| | | ‘101’ | 6^{th} PUCCH resource provided by pucch-ResourceId |
| | | | obtained from the 6^{th} value of resourceList |
| | | ‘110’ | 7^{th} PUCCH resource provided by pucch-ResourceId |
| | | | obtained from the 7^{th} value of resourceList |
| | | ‘111’ | 8^{th} PUCCH resource provided by pucch-ResourceId |
| | | | obtained from the 8^{th} value of resourceList |

If a UE determines a first resource for a PUCCH transmission with HARQ-ACK information corresponding only to a PDSCH reception without a corresponding PDCCH or detects a first DCI format indicating a first resource for a PUCCH transmission with corresponding HARQ-ACK information in a slot and also detects at a later time a second DCI format indicating a second resource for a PUCCH transmission with corresponding HARQ-ACK information in the slot, the UE does not expect to multiplex HARQ-ACK information corresponding to the second DCI format in a PUCCH resource in the slot if the PDCCH reception that includes the second DCI format is not earlier than N₃·(2048+144)·κ·2^{-μ}·T_{c} from the beginning of a first symbol of the first resource for PUCCH transmission in the slot where, K and T_{c} are defined in clause 4.1 of [TS 38.211] and μ corresponds to the smallest SCS configuration among the SCS configurations of the PDCCHs providing the DCI formats and the SCS configuration of the PUCCH. If processingType2Enabled of PDSCH-ServingCellConfig is set to enable for the serving cell with the second DCI format and for all serving cells with corresponding HARQ-ACK information multiplexed in the PUCCH transmission in the slot, N₃=3 for μ=0, N₃=4.5 for μ=1, N₃=9 for μ=2; otherwise, N₃=8 for μ=0, N₃=10 for μ=1, N₃=17 for μ=2, N₃=20 for μ=3.

If a UE is not provided SPS-PUCCH-AN-List and transmits HARQ-ACK information corresponding only to a PDSCH reception without a corresponding PDCCH, a PUCCH resource for corresponding PUCCH transmission with HARQ-ACK information is provided by n1PUCCH-AN.

The present disclosure provides enhanced scheduling operation in a carrier aggregation (CA) framework to support joint scheduling of multiple cells, such as when operating with one or multiple sets of cells for multi-cell scheduling.

In legacy 5G NR systems, a downlink or uplink data transmission can be scheduled only for a single serving cell. In other words, a DCI format provides scheduling information parameters for a PDSCH or a PUSCH on a single serving cell. If the serving cell is a scheduled cell, the UE receives a DCI format for the PDSCH/PUSCH in a PDCCH that the UE receives on a corresponding scheduling cell. Based on a carrier indication field (CIF) in the DCI format, the UE can determine a serving cell on which the UE can receive the PDSCH or transmit the PUSCH.

The legacy NR system does not support joint scheduling of multiple PDSCHs or multiple PUSCH on multiple cells using a single/common control signaling, such as by using a single DCI format. For such operation, the UE receives multiple DCI formats, wherein each DCI format can schedule one of the multiple PDSCHs or PUSCHs on one of the serving cells. Such operation achieves the intended outcome, but with possibly high signaling overhead. In various scenarios, it is possible that several scheduling parameters or corresponding UE operations are shared among the multiple PDSCHs or PUSCHs on the jointly scheduled cells, referred to as co-scheduled cells.

For example, the UE may use a same PUCCH resource to transmit HARQ-ACK feedback corresponding to the multiple PDSCHs. Therefore, an indication for the same PUCCH resource (and corresponding operations for PUCCH transmission) may be unnecessarily repeated multiple times. In addition, in some scenarios, such as intra-band CA, it is likely that physical channel conditions are correlated, so various scheduling parameters pertaining link adaptation, MIMO/beamforming operation, and even possibly resource allocation can be common and repeated among the co-scheduled cells. Such unnecessary overhead in control signaling can be significant, especially when the number of co-scheduled cells are large, such as 4-8 cells. Last but not least, CRC field needs to be repeated multiple times, which incurs significant signaling overhead, especially for large number of co-scheduled cells.

Design of HARQ-ACK codebooks in legacy 5G NR systems is based on consideration of single PDSCH reception on a single serving cell that is individually scheduled by a corresponding DCI format, herein referred to as DCI formats for single-cell scheduling. For example, HARQ-ACK information corresponding to each DCI (in case of TB-based PDSCH reception) is 1 or 2 bits, depending on whether a corresponding PDSCH includes 1 or 2 transport blocks (TBs). For a Type-2 or “dynamic” HARQ-ACK CB, definition of downlink assignment index (DAI) aims to detect missed DCIs, so each DAI refers to a single DCI and a single corresponding PDSCH. Other HARQ-ACK design aspects, such as total DAI in UL DCI formats and HARQ timeline considerations, rely on the same assumption for single-cell scheduling.

When the UE is configured multiple sets of cells for multi-cell scheduling, the UE needs to determine how to generate the HARQ-ACK codebook, such as Type-2 HARQ-ACK codebook, since different DCI formats corresponding to different sets of cells can trigger different number of HARQ-ACK information bits. Therefore, there is a need to determine a number of Type-2 sub-codebooks (sub-CBs) in association with the sets of cells for multi-cell scheduling.

In addition, when a HARQ-ACK codebook include multiple Type-2 sub-CBs, the UE needs to operate with separate counter/total DAIs in DL DCI formats for each sub-CB. In addition, an UL DCI format can provide a DAI value to be used instead of a total DAI in a last monitoring occasion, so the UE needs to determine an association between the DAI value in the UL DCI format with different Type-2 sub-CBs.

Furthermore, when a number of UCI bits is no larger than 11 bits, a Reed-Muller coding scheme would be applicable to the UCI (rather than the Polar coding used for UCI having more than 11 bits). Therefore, there is a need to determine a number of HARQ-ACK information bits for the case of UCI bits not exceeding 11 bits.

The present disclosure provides methods and apparatus for acknowledgment information with one or multiple set of cells for multi-cell scheduling.

One motivation for multi-cell scheduling using a single DCI format is enhanced cross-carrier scheduling operation for larger number of cells, such as 4-8 cells, operating in an intra-band CA framework in frequency bands below 6 GHz or above 6 GHz, referred to as FR1 or FR2, respectively.

In general, the embodiments apply to any deployments, verticals, or scenarios including inter-band CA with potentially fragmented spectrum in frequency domain, with eMBB, URLLC and IIoT and extended reality (XR), mMTC and IoT, with sidelink/V2X communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, and so on.

Embodiments of the disclosure for HARQ-ACK codebook design in presence of multiple sets of cells for multi-cell scheduling are summarized in the following and are fully elaborated further below. Combinations of the embodiments are also applicable, but they are not described in detail for brevity.
Multi-cell scheduling operation: A UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as those described in one or more embodiments herein. Additionally, the UE can be indicated via a DCI format in a PDCCH or via a MAC CE in a PDSCH a subset of a set of co-scheduled cells, wherein cells of the subset can change across different PDCCH monitoring occasions, for example, as indicated by a corresponding DCI format.
Various mechanisms for multi-cell scheduling: The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets.
PDCCH monitoring for multi-cell scheduling: The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets. There can be two cases for monitoring a DCI format for multi-cell scheduling: a first case based on search space set(s) dedicated to multi-cell scheduling, and a second case based on search space set(s) shared by both single-cell scheduling and multi-cells scheduling.
General considerations for HARQ-ACK codebook for multi-cell scheduling: A UE configured with multi-cell scheduling for a set of co-scheduled cells expects that all cells in the set of co-scheduled cells belong to a same PUCCH group, and also that the UE is provided configuration for a HARQ-ACK codebook, such as Type-1 or Type-2 codebook. HARQ codebook generation for multi-cell scheduling can depend on configuration of a TDRA table, a set of K0 values, and/or a set of K1 values provided for multi-cells scheduling. The UE can be provided a dedicated TDRA/K0/K1 configuration for multi-cell scheduling for a set of co-scheduled cells or for cells with multi-cell scheduling configuration, or the UE can implicitly determine a TDRA/K0/K1 configuration for multi-cell scheduling based on intersection (or union) of corresponding configurations for single-cell scheduling among the set of co-scheduled cells. A value of K0 can be with respect to (w.r.t.) an SCS configuration of a corresponding serving cell or w.r.t. a reference SCS configuration such as a largest SCS configuration among the set of co-scheduled cells. A value of K1 can be w.r.t. an SCS configuration of a corresponding cell with PUCCH configuration (such as the PCell).
Generation of a separate Type-2 sub-CB for DCI formats scheduling a single cell and multiple separate Type-2 sub-CBs for DCI formats scheduling multiple cells corresponding to more than one sets of cells for multi-cell scheduling: In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and multiple second Type-2 sub-CBs for DCI formats that schedule more than one cell. The multiple second Type-2 sub-CBs can have a one-to-one or one-to-many association with the more than one sets of cells for multi-cell scheduling. The multiple second Type-2 sub-CBs include a number of HARQ-ACK information bits based on a number of TBs configured for the cell combinations that are configured for the associated sets of cells for multi-cell scheduling. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide first bits/value corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for all Type-2 sub-CBs or only for one or some Type-2 sub-CBs. When applicable, the UE can determine a last DCI format separately for each set of cells or for each Type-2 sub-CB, or jointly across a number/all sets of cells or Type-2 sub-CBs. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the multiple Type-2 sub-CBs in ascending order of the sets of cells.
Generation of multiple separate Type-2 sub-CB for DCI formats scheduling a single cell and multiple separate Type-2 sub-CBs for DCI formats scheduling multiple cells corresponding to more than one sets of cells for multi-cell scheduling: In one embodiment, for a UE configured with one or more than one sets of cells for multi-cell scheduling of PDSCHs, the UE can generate multiple first Type-2 sub-CBs for DCI formats scheduling a single cell or triggering a single bit for HARQ-ACK information per DCI format, and multiple second Type-2 sub-CBs for DCI formats that schedule more than one cell. The multiple first Type-2 sub-CBs can have a one-to-one mapping with a number of HARQ-ACK information bits (such as two first sub-CBs corresponding to one or two HARQ-ACK information bits) or can have a same association with the one or more than one sets of cells for multi-cell scheduling, as described in one or more embodiments herein, including any cells that do not belong to any set of cells for multi-cell scheduling. The UE generates the multiple second Type-2 sub-CBs as described in one or more embodiments herein. The counter/total DAI in downlink DCI formats as well as the DAI in uplink DCI formats increment based on a number of DCI formats (for example, rather than a number of PDSCHs or TBs that have triggered the HARQ-ACK information bits). Accordingly, the UE can operate with multiple first counter/total DAIs corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide multiple first bits/values corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for all Type-2 sub-CBs or only for one or some Type-2 sub-CBs. When applicable, the UE can determine a last DCI format separately for each set of cells or each Type-2 sub-CB, or jointly across a number/all sets of cells or Type-2 sub-CBs. The UE determines missed DCI formats based on values of the counter/total DAI fields provided in downlink DCI formats or based on bits/values provided in the DAI field in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the multiple first Type-2 sub-CBs in ascending order of the number of HARQ-ACK information bits or the order of the sets of cells and the multiple Type-2 sub-CBs in ascending order of the sets of cells.
Generation of a separate Type-2 sub-CB for DCI formats scheduling a single cell and a single separate Type-2 sub-CB for DCI formats scheduling multiple cells across different sets of cells for multi-cell scheduling: In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and a (single) second Type-2 sub-CB for DCI formats that schedule more than one cell. The second Type-2 sub-CB corresponds to (all) different sets of cells for multi-cell scheduling. The second Type-2 sub-CBs includes a number of HARQ-ACK information bits based on a number of TBs configured for the cell combinations that are configured across different sets of cells for multi-cell scheduling in a PUCCH group. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and a second counter/total DAI corresponding to multi-cell scheduling DCI formats, from the more than one sets of cells, that schedule more than one cell. Similar, the UE can operate with a DAI field in uplink DCI formats that provide a first value corresponding to DCI formats scheduling a single cell or triggering a single bit for HARQ-ACK information, and a second value corresponding to multi-cell scheduling DCI formats, from the more than one sets of cells, that schedule more than one cell. An UL DCI format can include DAI values for both Type-2 sub-CBs or only for one Type-2 sub-CB. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the second Type-2 sub-CB.
Separate HARQ-ACK codebook types for single-cell scheduling and multi-cell scheduling DCI formats: In one embodiment, a UE can be configured a first HARQ-ACK codebook type for first DCI formats, such as for a Type-1 codebook for single-cell scheduling DCI formats, and a second HARQ-ACK codebook type for second DCI formats, such as a Type-2 codebook for multi-cell scheduling DCI formats. The UE can transmit a PUCCH or PUSCH that includes only one HARQ-ACK codebook with one HARQ-ACK codebook type, or the UE can concatenate the two HARQ-ACK codebooks that are of different HARQ-ACK codebook and transmit the two codebooks in a same PUSCH or PUCCH.
Separate spatial bundling type for single-cell scheduling and multi-cell scheduling DCI formats: In one embodiment, a UE can be configured a first information element (IE) providing a first type of spatial bundling of HARQ-ACK information in PUSCH/PUCCH for first DCI formats and a second IE providing a second type of spatial bundling of HARQ-ACK information in PUSCH/PUCCH for second DCI formats. For example, the UE can be configured to provide HARQ-ACK information without spatial bundling for the two TBs of a PDSCH that is scheduled by a single-cell scheduling DCI format, and to provide HARQ-ACK information with spatial bundling for the two TBs of a PDSCH that is scheduled by a multi-cell scheduling DCI format. Such design can be beneficial, for example, to reduce a size of the HARQ-ACK CB.
Number of HARQ-ACK bits for PUCCH power control: In one embodiment, when a UE transmits a PUCCH with a UCI that is no larger than 11 bits, the UE determines a number of HARQ-ACK information bits as n_{HARQ-ACK}=n_{HARQ-ACK,TB}+n_{HARQ-ACK,Multi-Cell}, wherein n_{HARQ-ACK,TB} is based on a number of HARQ-ACK information bits in a first sub-codebook, such as for single-cell scheduling DCI formats, and n_{HARQ-ACK,Multi-Cell} is based on a number of HARQ-ACK information bits in a second sub-codebook, such as for multi-cell scheduling. For example, the UE generates a single Type-2 sub-CB across different sets of cells for multi-cell scheduling, as considered in one or more embodiments herein.
HARQ-ACK generation based on advanced UE capability for multiple MC-DCIs per cell or per set of cells per MO: In one embodiment, when a UE indicates a capability for HARQ-ACK generation based on processing more than one unicast DL MC-DCI 1_3 per cell or per set of cells configured for multi-cell scheduling in a same PDCCH monitoring occasion (MO) or in a same slot of the scheduling cell, the UE counts the cell or the set of serving cells a number N_{MC-DCI}^{MO} times in each PDCCH MO index ‘m’ in a pseudo-code for Type-2 HARQ-ACK codebook generation, wherein N_{MC-DCI}^{MO} is the number of unicast DL MC-DCI 1_3 that the UE can process in a same MO or slot. Accordingly, the cell or the set of serving cells can be checked a corresponding number of times for MC-DCIs that can schedule the cell or the set of serving cells in a corresponding PDCCH MO index ‘m’, and the UE can generate a corresponding number of sets of HARQ-ACK information bits if the UE has processed multiple MC-DCIs for the same cell or the same set of cells in the corresponding MO. In an alternative method, the UE counts, in a pseudo-code for Type-2 HARQ-ACK codebook generation, a serving cell c or a set of serving cells s a number N_{MC-DCI,c}^{m} or N_{MC-DCI,s}^{m} times in a given PDCCH MO index ‘m’, wherein N_{MC-DCI,c}^{m} or N_{MC-DCI,s}^{m} is the number of unicast DL MC-DCI formats 1_3 that the UE (actually) receives in the same MO index ‘m’ that each schedule a PDSCH on the serving cell c or each schedule more than one PDSCH receptions on respective more than one serving cells from the set of serving cells s. Accordingly, the corresponding HARQ-ACK bits are ordered first in increasing order of the PDSCH reception starting time for the same {serving cell with smallest index from the respective more than one serving cells, PDCCH monitoring occasion} pair, and second in ascending order of the smallest serving cell index from the respective more than one serving cells.
HARQ-ACK skipping in case of BWP change: In one embodiment, when a UE is provided an MC-DCI format 1_3 in a PDCCH, and the MC-DCI format 1_3 schedules first PDSCHs on first cells from a set of cells, and the UE receives the PDCCH in a monitoring occasion (MO)/slot that is before a BWP change event, the UE can skip the HARQ-ACK information corresponding to one or more or all PDSCHs from the first PDSCHs. Herein, the BWP change event can include change for one or more of: an active DL BWP of a cell from the first cells, an active DL BWP of a cell from the set of cells, active DL BWPs of all cells from the first cells, active DL BWPs of all cells from the set of cells, active UL BWP of PCell or PSCell or PUCCH-SCell or secondary PUCCH-SCell (sPUCCH-SCell). For example, the UE can skip the HARQ-ACK information corresponding to the cell with a change of the active DL BWP. For example, the UE can skip the HARQ-ACK information for all cells from the first (co-scheduled) cells when there is a change of active DL BWP for each cell from the first cells or when there is a change of active DL BWP for at least one cell from the first cells.

Various embodiments are described in terms of multiple PDSCHs or multiple PUSCHs that are jointly scheduled on multiple serving cells, such as a subset/set of cells from among one or more sets of co-scheduled cells.

The embodiments are generic and can apply to various other scenarios such as when a UE is jointly scheduled to receive/transmit multiple PDSCHs/PUSCHs:
from/to multiple transmission-reception points (TRPs) or other communication entities, such as multiple distributed units (DUs) or multiple remote radio heads (RRHs) and so on, for example, in a distributed MIMO operation, wherein TRPs/DUs/RRHs can be associated with one or more cells; or
in multiple time units, such as multiple slots or multiple transmission time intervals (TTIs); or
on multiple BWPs associated with one or more cells/carriers/TRPs, including multiple BWPs of a single serving cell/carrier for a UE with a capability of reception/transmission on multiple active BWPs; or
on one or more TRPs/cells, wherein the UE can receive/transmit more than one PDSCH/PUSCH on each co-scheduled TRP/cell; or
for multiple transport blocks (TBs), or for multiple codewords (CWs) corresponding to single TB or multiple TBs; or
for multiple semi-persistently scheduled PDSCHs (SPS PDSCHs) or for multiple configured grant PUSCHs (CG PUSCHs) that are jointly activated on one or multiple TRPs/cells.

Accordingly, any reference to “co-scheduled cells” can be replaced with/by “co-scheduled TRPs/DUs/RRHs”, or “co-scheduled slots/TTIs”, or “co-scheduled BWPs”, or “co-scheduled PDSCHs/PUSCHs”, or “co-scheduled TBs/CWs”, or “co-scheduled SPS-PDSCHs/CG-PUSCHs”, and so on. Similar for other related terms, such as “multi-cell scheduling”, and so on.

Various embodiments provide for reception of multiple PDSCHs or transmission of multiple PUSCHs on respective cells, including carriers of a same cell such as on an UL carrier (also referred to as, a normal UL (NUL) carrier) or a supplemental UL (SUL) carrier. The embodiments also apply to cases where scheduling is for a mixture of PDSCHs and PUSCHs. For example, the UE can receive first PDSCHs on respective first cells and can transmit second PUSCHs on respective second cells, wherein the first PDSCHs and the second PUSCHs are jointly scheduled.

In various embodiments, the phrase “a UE configured with multi-cell scheduling” refers to a UE that is configured joint scheduling for at least one set of co-scheduled cells.

In various embodiments, the phrase “scheduled PDSCH” refers to a PDSCH that is scheduled/indicated by a DCI format, regardless of whether the PDSCH is received or not yet.

Multi-cell scheduling operation: A UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as those described in one or more embodiments herein. Additionally, the UE can be indicated via a DCI format in a PDCCH or via a MAC CE in a PDSCH a subset of a set of co-scheduled cells, wherein cells of the subset can change across different PDCCH monitoring occasions, for example, as indicated by a corresponding DCI format.

In one example, multi-cell scheduling can also include operations related to DL/UL transmissions such as reporting HARQ-ACK information, beam/CSI measurement or reporting, transmission or reception of UL/DL reference signals, and so on.

In one example, the UE can be configured by higher layers, such as by a UE-specific RRC configuration, a number of sets of co-scheduled cells. For example, the UE can be configured a first set of cells, such as {cell #0, cell #1, cell #4, cell #7} and a second set {cell #2, cell #3, cell #5, cell #6}. The multiple sets of co-scheduled cells can be scheduled from a same scheduling cell or from different scheduling cells.

In one example, a set of co-scheduled cells can include a primary cell (PCell/PSCell) and one or more SCells. In another example, a set of co-scheduled cells can include only SCells. In one example, a scheduling cell can belong to a set of co-scheduled cells. In another example, the UE does not expect that a scheduling cell belongs to a set of co-scheduled cells.

In one example, per specifications of the system operation, a set of co-scheduled cells is defined as a set that includes all scheduled cells having a same scheduling cell, and additional higher layer configuration is not required for indication of the set of co-scheduled cells. Accordingly, a DCI format for multi-cell scheduling, or other complementary methods, can jointly schedule any number of scheduled cells that have a same scheduling cell.

In another example, a set of co-scheduled cells can have two or more scheduling cells. For example, a UE can receive a DCI format for scheduling multiple co-scheduled cells on a first scheduling cell in a first PDCCH monitoring occasion, or on a second scheduling cell in a second PDCCH monitoring occasion. The DCI format can be associated with any search space set or can be restricted to be associated with USS sets. For example, the DCI format can be associated with multicast scheduling and have CRC scrambled by a G-RNTI and PDCCH candidates monitored according to CSS sets, or can be associated with unicast scheduling and have CRC scrambled by a C-RNTI and PDCCH candidates monitored according to USS sets. Such PDCCH monitoring from two scheduling cells can be simultaneous, for example in a same span of symbol or in a same slot, or can be non-overlapping, such as in different slots (per higher layer configuration, or per indication in a PDCCH or via a MAC CE). The UE may or may not expect that both the first scheduling cell and the second scheduling cell can schedule, through PDCCH transmissions in a same time interval such as a span or a slot, transmissions or receptions on a same cell. The UE can also monitor PDCCH for detection of a DCI format providing scheduling only on one cell from the set of co-scheduled cells (single-cell scheduling DCI format).

A UE can report one or more of: a maximum number of sets of co-scheduled cells, or a maximum number of cells within a set of co-scheduled cells, or a maximum total number of co-scheduled cells across different sets, or a maximum number of co-scheduled cells per PDCCH monitoring occasion, as capability to the gNB. In one example, that capability can depend on an operating frequency band or on a frequency range such as above or below 6 GHz.

Multi-cell scheduling can be an optional UE feature with capability signaling that can additionally be separate for PDSCH receptions and for PUSCH transmissions. For example, a UE can report a capability for a maximum number of {2, 4, 8, 16} co-scheduled cells for the DL and a maximum of {2, 4} co-scheduled cells for the UL.

A UE can also be configured a number of cells that do not belong to any of set of co-scheduled cells. For example, the UE can be configured a cell #8 that does not belong to either the first set or the second set of co-scheduled cells in the previous example.

In one example, restrictions can apply for co-scheduled cells and a UE can expect that co-scheduled cells in a corresponding set:
have a same numerology (SCS configuration and CP); or
have a same numerology for respective active DL/UL BWPs; or
have a same duplex configuration, for example, all cells have FDD configuration, or all cells have TDD configuration and, in case of a TDD configuration, also have a same UL-DL configuration; or
are within a same frequency band (intra-band CA).

A serving cell can belong only to a single set of co-scheduled cells so that the sets of co-scheduled cells do not include any common cell, or can belong to multiple sets of co-scheduled cells to enable larger scheduling flexibility to a serving gNB. For example, a serving cell can belong to a first set of co-scheduled cells and to a second set of co-scheduled cells, when cells in the first and second sets of co-scheduled cells have a common feature such as a common numerology, duplex configuration, operating frequency band/range, and so on. Also, a serving cell can belong to both a first set of co-scheduled cells and to a second set of co-scheduled cells, when the serving cell has a first common feature with cells in the first set of co-scheduled cells and a second common feature with cells in the second set of co-scheduled cells, wherein the first common feature can be different from the second common feature.

In a first approach, a UE expects to be provided multi-cell scheduling for all cells in a set of co-scheduled cells. For example, for a first set of co-scheduled cells including cells {cell #0, cell #1, cell #4, cell #7}, a DCI format schedules PDSCH receptions or PUSCH transmissions on all four cells in the first set of co-scheduled cells {cell #0, cell #1, cell #4, cell #7}.

In a second approach, the UE can be provided multi-cell scheduling for a subset of a set of co-scheduled cells. For example, a DCI format can schedule PDSCH receptions or PUSCH transmissions on only two cells, such as {cell #0, cell #4}, from the first set of cells.

In a first option for the second approach, the subset of cells can be indicated by a MAC CE. Such a MAC CE command can include one or more of: an indication for activation or deactivation/release of a subset of cells; an indication for a number of sets of co-scheduled cells; or an indication for a number of subsets of co-scheduled cells from a corresponding number of sets of co-scheduled cells.

For example, a MAC CE activates a first subset of a set of co-scheduled cells and subsequent DCI format(s) for multi-cell scheduling apply to the first subset of cells activated by the MAC CE. The UE can receive another MAC CE command that deactivates the first subset of co-scheduled cells, or activates a second subset of co-scheduled cells, wherein the second subset can be a subset of the same set of co-scheduled cells or a subset of a different set of co-scheduled cells. If a UE receives a MAC CE that deactivates the first subset of co-scheduled cells, but does not activate a second subset of co-scheduled cells, in one alternative, the UE does not expect to receive a DCI format for multi-cell scheduling, and the UE may not monitor PDCCH according to respective search space sets, until the UE receives a new MAC CE that activates a second subset of co-scheduled cells. In another alternative, the UE can receive DCI format(s) for multi-cell scheduling even before receiving a new MAC CE that activates a second subset of co-scheduled cells, but the UE expects to be provided an indication for a subset of co-scheduled cells by the DCI format(s), or by using complementary methods, such as those described in one or more embodiments herein, for multi-cell scheduling.

In a second option for the second approach, the subset of the set of co-scheduled cells can be provided by a DCI format in a PDCCH/PDSCH. The subset of cells can change between PDCCH monitoring occasions (MOs) for PDSCH/PUSCH scheduling as indicated by a corresponding DCI format. For example, a first DCI format in a first PDCCH MO indicates scheduling on a first subset of cells, while a second DCI format in a second PDCCH MO indicates scheduling on a second subset of cells.

In a first example, a DCI format for multi-cell scheduling provides an index for a subset of cells that are co-scheduled such as a CIF value that corresponds to a subset of one or more cells from a set of co-scheduled cells. For example, UE-specific RRC signaling can indicate first/second/third/fourth indexes and corresponding first/second/third/fourth subsets that include one or more cells from a set of co-scheduled cells, wherein a subset can also include all cells from the set of co-scheduled cells. Then, a CIF field of 2 bits in a DCI format can provide a value that indicates the subset of scheduled cells.

In a second example, a DCI format can include a 1-bit flag field to indicate whether the DCI format is for single-cell scheduling or for multi-cell scheduling in order for a UE to accordingly interpret fields of the DCI format that may also include the CIF field. Then, for single-cell scheduling, the CIF field can be interpreted as in case of single-cell cross-carrier scheduling while for multi-cell scheduling the CIF field can be interpreted as indicating a subset from the set of co-scheduled cells.

In a third example, a DCI format for multi-cell scheduling provides a number of co-scheduled cells, and the indexes of the co-scheduled cells are provided by additional methods, such as by an additional DCI format (or an additional part/stage of a same DCI format) or by higher layer signaling as described in one or more embodiments herein.

In a fourth example, a CIF field in a DCI format for multi-cell scheduling can be a bitmap mapping to the individual cells or subsets of cells from the set of co-scheduled cells. When the DCI format is applicable to all cells in the set of co-scheduled cells, the DCI format may not include a CIF.

In a third option for the second approach, a UE can implicitly determine indexes for co-scheduled cells without need for explicit gNB indication. For example, the UE can determine indexes for co-scheduled cells based on a PDCCH monitoring parameter, such as:
a CORESET index; or
a search space set index, or a carrier indicator parameter n_CI corresponding to the search space set index; or
a set of CCEs in the search space set or a first/last CCE in the search space set; where the UE received a PDCCH providing the DCI format for multi-cell scheduling.

According to the third option, the UE can be configured a mapping among values for PDCCH monitoring parameters, such as search space sets, and a number of co-scheduled cells or indexes of the co-scheduled cells. In one example, first and second values for parameter n_CI in a search space set can respectively indicate first and second subsets of co-scheduled cells. According to this example, the parameter n_CI can correspond to a single cell or can correspond to a group of cells, such as a subset/set of co-scheduled cells.

Receptions or transmissions on a respective subset of cells that are jointly scheduled by a single DCI format, or by using complementary methods such as those described in one or more embodiments herein, can refer to PDSCHs or PUSCHs that may or may not overlap in time. For example, the UE can be indicated to receive PDSCHs or to transmit PUSCHs on respective co-scheduled cells wherein all receptions/transmissions are in a same slot or at least one reception/transmission is in a different slot than the remaining ones.

A UE that is configured for multi-cell scheduling can be provided a first set of cell-common parameters whose values apply for scheduling on all co-scheduled cells, and a second set of cell-specific parameters whose values apply for scheduling on each corresponding co-scheduled cell. The UE can determine cell-common and cell-specific scheduling information parameters based on the specifications of the system operation, or based on higher layer configuration. For some cell-specific scheduling information parameters, the UE can be provided differential values compared to a reference value wherein the reference value can correspond, for example, to a first scheduled cell from a set of scheduled cells.

For a UE that is configured a number of sets of co-scheduled cells, a DCI format for multi-cell scheduling can provide complete or partial information for cell-common or cell-specific scheduling parameters, for multiple PDSCH receptions or multiple PUSCH transmissions on respective multiple co-scheduled cells. When the DCI format for multi-cell scheduling provides partial information for a scheduling parameter, the UE can determine remaining information from UE-specific RRC signaling or by other complementary methods.

Various mechanisms for multi-cell scheduling: The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets.

For a UE that is configured a set of co-scheduled cells, a DCI format for multi-cell scheduling can provide full or partial information for values of cell-common and cell-specific fields for scheduling PDSCH receptions or PUSCH transmissions on respective two or more cells from the set of co-scheduled cells. When the DCI format provides partial information, the UE can determine remaining information from RRC signaling or by using other complementary methods.

In a first approach, referred to as concatenated DCI format for multi-cell scheduling, a DCI format for multi-cell scheduling can provide separate values of fields for each of the multiple co-scheduled cells. A first value corresponds to a first cell, a second value corresponds to a second cell, and so on. Therefore, DCI format fields for the multiple cells are concatenated, thereby referring to such DCI format as a concatenated DCI format for multi-cell scheduling. This approach can be beneficial, for example, for co-scheduling cells that have different channel characteristics or configurations, such as for inter-band CA operation, or for co-scheduling a PDSCH reception and a PUSCH transmission.

In a second approach, referred to as multi-cell scheduling via multi-cell mapping, a UE can be provided information for multi-cell scheduling of multiple PDSCHs/PDCCHs on multiple respective cells using a multi-cell mapping, wherein a field in a DCI format can be interpreted to provide multiple values for a corresponding scheduling parameter for the multiple co-scheduled cells. Such interpretation can be based on a configured one-to-many mapping/table or based on multiple configured offset values for respective cells that are applied to a reference value indicated by the DCI format. For example, the field can be an MCS field wherein a value indicated in the DCI format can be for a PDSCH reception on a first cell and a value for a PDSCH reception on a second cell can be determined from the first value and a configured offset value. This approach can be beneficial, for example, for co-scheduling cells that have several similar physical channel characteristics or configurations, such as for intra-band CA operation.

In a third approach, referred to as single-cell DCI pointing to a PDSCH with multi-cell scheduling, a UE can be provided information for multi-cell scheduling using a single-cell scheduling DCI format, namely a DCI format that schedules a first PDSCH on a first cell, wherein the first PDSCH includes scheduling information for reception of second PDSCH(s) or transmission of second PUSCH(s) on a subset from one or more sets of co-scheduled cells. This approach can be beneficial, for example, for co-scheduling several (such as 4-8) cells that have different channel characteristics or configurations, such as for inter-band CA operation.

In a first option for the third approach, the first PDSCH includes a MAC CE that provides scheduling information for the number of PDSCH(s) or PUSCH(s). Accordingly, the MAC CE can include a number of modified DCIs (M-DCIs), wherein each M-DCI includes full or partial scheduling information for a PDSCH/PUSCH from the number of PDSCH(s)/PUSCH(s).

In a second option for the third approach, multi-cell scheduling information is multiplexed as M-DCI in a PDSCH. The UE receives a first PDSCH that is scheduled by a single-cell scheduling DCI format, and the UE receives additional scheduling information for one or more PDSCH(s)/PUSCH(s) on one or more respective co-scheduled cell(s). The UE allocates the coded modulation symbols for M-DCIs to time/frequency resources within the first PDSCH, for example in a frequency-first, time-second manner, except for reserved resources corresponding to reference signals or other cell-level broadcast transmissions. The UE can start receiving the M-DCIs in a first symbol of the first PDSCH, or in a first symbol after first symbols with DM-RS REs, in the first PDSCH. The M-DCIs can be jointly coded and include a single CRC.

In the second option, physical layer processing of M-DCI(s) that are included in the first PDSCH can be same as that for a DCI in a PDCCH, such as for the DCI scheduling the first PDSCH, or can be same as that for data information/transport block in the first PDSCH. For example, physical layer processing refers to, for example, modulation, coding, scrambling, and so on. In addition, the UE can determine a number of coded modulation symbols corresponding to multi-scheduling information, such as M-DCIs, that are multiplexed in a first PDSCH scheduled by a single-cell scheduling DCI format, based on a scaling factor β_{offset}^{PDSCH}=β_{offset}^{M-DCI} applied to a total (coded) payload size for the M-DCIs. Such scaling factor determines an effective channel coding rate of M-DCIs multiplexed on the first PDSCH, for flexible link adaptation and improved reliability of the M-DCIs according to physical channel conditions.

In a fourth approach, referred to as multi-stage PDCCHs/DCIs for multi-cell scheduling, a UE can be provided information for multi-cell scheduling of multiple PDSCHs/PDCCHs on multiple respective cells using a multi-stage DCI method, such as a 2-stage DCI wherein a first-stage DCI format includes a set of cell-common fields, and a second-stage DCI format includes cell-specific fields. The UE receives the first-stage DCI format in a first PDCCH and the second-stage DCI format in a second PDCCH. This approach can be beneficial, for example, for co-scheduling several cells that have several common physical characteristics, such as a time-domain resource allocation or a frequency-domain resource allocation, without incurring latency and without having a DCI format size that is too large (that would result if the first-stage and second-stage DCI formats were combined into a single DCI format) for receiving cell-specific parameters when the second PDCCH is received in a same slot as the first PDCCH. The first-stage DCI format can also indicate a location for a PDCCH providing the second-stage DCI format, such as a PDCCH candidate for a corresponding CCE aggregation level, so that the UE can interpret the contents of the second-stage DCI format or reduce a number of PDCCH receptions. A UE can determine an association among a number of linked multi-stage PDCCHs/DCIs, such as two PDCCHs/DCIs, that provide multi-cell scheduling information based on parameters of the linked DCI formats, such as size(s) of the DCI format(s), or RNTI(s) associated with the DCI format(s), or by an explicit indication in some field(s) in the DCI format(s), or based on PDCCH monitoring parameters, such as CORESET, search space, CCEs, or monitoring occasions in which the UE receives the first and the second linked PDCCHs.

PDCCH monitoring for multi-cell scheduling: The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets. There can be two cases for monitoring a DCI format for multi-cell scheduling: a first case based on search space set(s) dedicated to multi-cell scheduling, and a second case based on search space set(s) shared by both single-cell scheduling and multi-cells scheduling.

In a first case, a search space set for multi-cell scheduling is associated only with DCI format(s) for multi-cell scheduling on a set of co-scheduled cells. Such search space sets can correspond to a set-level n_CI value, which can be separate from n_CI values corresponding to search space sets for single-cell scheduling. By monitoring the search space set, the UE can detect a DCI format for scheduling on all scheduled cells or only a subset of scheduled cells from the set of co-scheduled cells. Accordingly, the detected DCI format can include a CIF value that is same as or different from an n_CI value corresponding to the search space set for multi-cell scheduling. The search space set can be commonly configured, thereby linked, on the scheduling cell and on all scheduled cells from the set of co-scheduled cells. The UE can monitor the search space set for multi-cell scheduling when linked search spaces sets on the scheduling cell and at least one scheduled cell from the set co-scheduled cells are configured on corresponding active DL BWPs of the scheduling cell and the at least one scheduled cell.

In a second case, a search space set for multi-cell scheduling is associated with DCI format(s) both for multi-cell scheduling on a set of co-scheduled cells and for single-cell scheduling on a first scheduled cell from the set of co-scheduled cells. Such search space sets correspond to an existing cell-level n_CI value corresponding to the first scheduled cell. By monitoring the search space set, the UE can detect a DCI format for single-cell scheduling on the first scheduled cell with a CIF value that is same as the n_CI value corresponding to the first scheduled cell, or can detect a DCI format for multi-cell scheduling on all scheduled cells or only a subset of scheduled cells from the set of co-scheduled cells, with a set-level CIF value that is different from the n_CI value corresponding to the first scheduled cell. The search space set is commonly configured, thereby linked, on the scheduling cell and only the first scheduled cell, and the UE monitors the linked search space sets when both are configured on active DL BWPs of the scheduling cell and the first scheduled cell.

General considerations for HARQ-ACK codebook for multi-cell scheduling: A UE configured with multi-cell scheduling for a set of co-scheduled cells expects that all cells in the set of co-scheduled cells belong to a same PUCCH group, and also that the UE is provided configuration for a HARQ-ACK codebook, such as Type-1 or Type-2 codebook. HARQ codebook generation for multi-cell scheduling can depend on configuration of a TDRA table, a set of K0 values, and/or a set of K1 values provided for multi-cells scheduling. The UE can be provided a dedicated TDRA/K0/K1 configuration for multi-cell scheduling for a set of co-scheduled cells, or the UE can implicitly determine a TDRA/K0/K1 configuration for multi-cell scheduling based on intersection (or union) of corresponding configurations for single-cell scheduling among the set of co-scheduled cells. A value of K0 can be with respect to (w.r.t.) an SCS configuration of a corresponding serving cell or w.r.t. a reference SCS configuration such as a largest SCS configuration among the set of co-scheduled cells. A value of K1 can be w.r.t. an SCS configuration of a corresponding cell with PUCCH configuration (such as the PCell).

When a UE is configured two or multiple PUCCH groups, and the UE is also configured with a set of co-scheduled cells, the UE expects that all serving cells in the set of co-scheduled cells belong to a same PUCCH group. For example, if a UE is configured a PUCCH-SCell, and a corresponding secondary PUCCH group, the UE expects that all serving cells in a configured set of co-scheduled cells belong to either the primary PUCCH group or the secondary PUCCH group, and not both. In another example, if a UE is configured an MCG and an SCG, the UE expects that all serving cells in a configured set of co-scheduled cells belong to either the MCG or the SCG, and not both.

A UE configured with multi-cell scheduling expects to be configured a HARQ-ACK codebook, for example using a parameter ‘pdsch-HARQ-ACK-Codebook’. The HARQ-ACK codebook (CB) can be, for example, one of Type-1 CB, also referred to as semi-static CB, or Type-2 CB, also referred to as dynamic CB, or enhanced Type-2 CB, also referred to as enhanced dynamic CB, and so on. Accordingly, the UE does not expect to provide separate HARQ-ACK feedback for each PDSCH from a number of co-scheduled PDSCHs on a set/subset of co-scheduled cells. The UE multiplexes HAQR-ACK feedback information corresponding to the number of co-scheduled PDSCH receptions on a set/subset of co-scheduled cells, based on a HARQ-ACK codebook configuration, and transmits the CB in a same PUCCH resource or multiplexes the CB in a same PUSCH transmission.

In one example, a UE configured with multi-cell scheduling can transmit HARQ-ACK information feedback for a first number of co-scheduled cells on a first PUCCH resource and transmit HARQ-ACK information feedback for a second number of co-scheduled cells on a second PUCCH resource, wherein the first and second number of co-scheduled cells are indicated by a same DCI format. This can be beneficial, for example, for reducing latency of HARQ retransmission for co-scheduled cells.

In one realization, a UE can be configured:
a first group of serving cell that are configured with single-cell scheduling only, and
a second group of serving cells that are configured with multi-cell scheduling only, and
a third group of serving cells that are configured with both single-cell scheduling and multi-cell scheduling.

At least one of the first and second and third groups of serving cells is non-empty. In one example, the second group of serving cells can be empty, so that any serving cell can be configured with single-cell scheduling, while some other serving cells (from the third group) can be additionally configured with multi-cell scheduling.

In one example, the UE expects that a serving cell with multi-cell scheduling is included in only one configured set of co-scheduled cells. Therefore, the UE does not expect to be configured multiple overlapping sets of co-scheduled cells. Accordingly, the UE determines only one TDRA/K0/K1 configuration (for HARQ-ACK codebook generation) for a serving cell with multi-cell scheduling configuration, as described next.

It is noted that, the UE can receive a first DCI format for multi-cell scheduling in a first PDCCH monitoring occasion that indicates joint scheduling for a first subset from the configured set of co-scheduled cells, and receive a second DCI format for multi-cell scheduling in a second PDCCH monitoring occasion that indicates joint scheduling for a second subset from the (same) configured set of co-scheduled cells, wherein the first subset and the second subset can be separate, but potentially with non-empty overlap.

In one example, a DCI format for multi-cell scheduling can indicate scheduling on only a single serving cell, for instance, when the serving cell belongs to the third group of serving cells, per above. In one example, single-cell scheduling can be considered as a fallback operation for any serving cell that is configured with multi-cell scheduling, without any explicit configuration for single-cell scheduling (that is, no distinction between the second group and third group of serving cells, as above).

HARQ codebook generation for multi-cell scheduling can depend on configuration of a TDRA table, a set of K0 values, and/or a set of K1 values provided for multi-cells scheduling. Various methods for configuration of TDRA/K0/K1 for multi-cell scheduling is provided below, and potential relationships with corresponding configurations for single-cell scheduling is also considered.

In one example, a serving cell that belongs to a set of co-scheduled cells, can be configured a first TDRA table (including a first set of K0 values) or a first set of K1 values for single-cell scheduling, and a second TDRA table (including a second set of K0 values) or a second set of K1 values for multi-cell scheduling, wherein the first TDRA/K0/K1 configuration can be separate from the second TDRA/K0/K1 configuration.

In another example, when a UE is configured a first set and a second set of co-scheduled cells, and a serving cell belongs to both the first set and the second set, the serving cell can be associated with a first TDRA table/K0 set/K1 set corresponding to the first set of co-scheduled cells, and a second TDRA table/K0 set/K1 set corresponding to the second set of co-scheduled cells. Such configurations are beneficial, for example, in order to provide high scheduling flexibility.

In another example, the TDRA/K0/K1 configuration can be simplified, for example, in order to reduce UE complexity or specification efforts. In one realization, a UE can be configured a same TDRA table/K0 set/K1 set for a serving cell, regardless of whether the UE belongs to a single set or multiple sets of co-scheduled cells. In another realization, all cells within a same set of co-scheduled cells can be configured a same TDRA table/K0 set/K1 set. In a further realization, all cells with multi-cell scheduling configuration, regardless of whether they belong to a same set or different sets of co-scheduled cells, are configured a same TDRA table/K0 set/K1 set.

In yet another example, the UE is not provided any dedicated configuration for TDRA table/K0 set/K1 set for the case of multi-cell scheduling. Instead, the UE implicitly determines an applicable configuration for TDRA table/K0 set/K1 set for multi-cell scheduling based on the corresponding configuration for single-cell scheduling. For example, the UE determines a TDRA table/K0 set/K1 set for multi-cell scheduling on a set of co-scheduled cells based on intersection or union of all TDRA tables/K0 sets/K1 sets for single-cell scheduling corresponding to all serving cells that belong to the set of co-scheduled cells. According to these example, and when the intersection operation is used, the UE determines that entries of TDRA tables or K0 values or K1 values, configured for a cell from a set of co-scheduled cells, that do not belong to the intersection of TDRA tables/K0 sets/K1 sets, are used only for single-cell scheduling for the corresponding cell.

For example, if K1={0, 1, 2, 3} for a first cell and K1={1, 2, 3, 4} for a second cell, then the UE considers:
K1=0 is used only for single-cell scheduling of the first cell; and
K1=4 is only for single-cell scheduling of the second cell; and
K1={1, 2, 3} can be used for both single-cell scheduling and multi-cell scheduling on the first cell and the second cell.

In one example, a TDRA field in a DCI format for multi-cell scheduling can be a cell-common field that commonly applies to all co-scheduled cells by the DCI format. Such TDRA field will point to an entry in a TDRA table, wherein the entry includes a K0 value, an SLIV, and an indication for a PDSCH mapping type, that applies commonly to all co-scheduled PDSCHs on the set/subset of co-scheduled cells. For example, the TDRA table is a TDRA table for multi-cell scheduling that the UE determines based on one of the methods described above.

In one example, when all co-scheduled cells have a common/same SCS, the K0 value determined from the TDRA field of the DCI format for multi-cell scheduling applies commonly to all co-scheduled PDSCHSs based on the common SCS value.

In another example, when the co-scheduled cells have different SCSs, the UE applies the K0 value for each PDSCH on each serving cell from the set of co-scheduled cells based on:
an SCS configuration of the corresponding serving cell, or
a largest (or smallest) SCS configuration among the set/subset of co-scheduled cells, or
an SCS configuration of a corresponding scheduling cell, or
an SCS configuration provided by higher layers, or
a predetermined SCS configuration, such as 30 kHz for FR1, and 120 kHz for FR2.

For example, assuming the method in the first bullet point above is used, if a DCI format jointly schedules PDSCHs on a first cell with SCS=15 kHz and a second cell with SCS=30 kHz, and the DCI format indicates K0=1, the UE determines a slot for a first PDSCH on the first cell with an offset equal to 1 slot w.r.t. SCS=15 kHz, and a slot for a second PDSCH on the second cell with an offset equal to 1 slot w.r.t. SCS=30 kHz, wherein the offsets are w.r.t. a slot where the multi-cell scheduling DCI format ends.

In one example, a TDRA field in a DCI format for multi-cell scheduling can be based on a “multi-cell mapping” to provide cell-specific TDRA for each of the co-scheduled cells. For example, a TDRA table for multi-cell scheduling on a set of [M] serving cells can include a number of entries, wherein each entry includes a number of up to [M] sets of K0/SLIV/mapping types. For each PDSCH from the co-scheduled PDSCHs on a serving cell from the set of co-scheduled cells, the UE applies the set of K0/SLIV/mapping type corresponding to the serving cell, from the number of sets of K0/SLIV/mapping types that is included in the TDRA entry which is indicated by the DCI format for multi-cell scheduling. According to this example, each K0 value provided for each serving cell from the set of co-scheduled cells is w.r.t. an SCS configuration of the corresponding serving cell.

When a DCI format for multi-cell scheduling is a two-stage DCI format with a 2^{nd}-stage DCI provided by a PDSCH or PDCCH, as described in one or more embodiments herein, the UE determines K0 relative to a 2^{nd}-stage DCI, at least for any PDSCHs whose scheduling information is at least partially provided by the 2^{nd}-stage DCI. Accordingly, the UE determines a slot for a PDSCH from co-scheduled PDSCHs to be a slot that is K0 slots from/after a last slot that includes the 2^{nd}-stage DCI format, wherein the UE determines the K0 value and an SCS configuration for determination of K0 slots based on one of the various methods described in the previous examples. In one example, if scheduling information for a first PDSCH from a set of co-scheduled PDSCHs is fully provided in a 1^{st}-stage DCI, the UE determines a slot for the first PDSCH to be a slot that is K0 slots from/after a last slot that includes the 1^{st}-stage DCI format, wherein the UE determines the K0 value and an SCS configuration for determination of K0 slots based on one of the various methods described in the previous examples. For example, the first PDSCH can be a PDSCH in which the 2^{nd}-stage DCI is multiplexed.

In one realization, when a UE is configured with multi-cell scheduling, the UE expects to be provided a single PUCCH resource for transmitting HARQ-ACK information corresponding to co-scheduled PDSCHs on a set of co-scheduled cells.

In one example, a PDSCH-to-HARQ_feedback timing indicator field (K1) in a DCI format for multi-cell scheduling is with respect to a corresponding cell with PUCCH configuration (such as the PCell). For example, the UE determines K1 based on an SCS configuration of the corresponding cell with PUCCH configuration (such as the PCell). According to this example, a K1 timing for transmitting HARQ-ACK information is relative to a last DL slot of a last PDSCH from co-scheduled PDSCHs on a set/subset of co-scheduled cells, w.r.t. a slot/SCS for the cell with PUCCH configuration (such as the PCell). For example, the last PDSCH can refer to a PDSCH that:
ends in a latest slot/symbol, among the co-scheduled PDSCHs, w.r.t. the SCS for the PUCCH cell (such as the PCell), or
corresponds to a cell, among the co-scheduled cells, with a largest cell index or largest CIF, or
corresponds to a cell, among the co-scheduled cells, with a largest (or smallest) SCS, or
corresponds to a cell, among the co-scheduled cells, that is indicated last in the DCI format for multi-cell scheduling, if the DCI format includes an ordered indication for the set of co-scheduled cells.

Supporting K1 relative to a last PDSCH can be beneficial, for example, when the co-scheduled PDSCHs can start in different slots (for example, due to different K0 values) or when the co-scheduled cells have different SCSs.

In another example, a K1 field in a DCI format for multi-cell scheduling can provide a cell-common value that applies commonly to all co-scheduled cells. Therefore, the UE applies a same K1 value to each PDSCH from the co-scheduled PDSHCs, wherein the K1 value is w.r.t. the SCS of the cell with PUCCH configuration (such as the PCell). Such operation can be beneficial, for example, when all co-scheduled PDSCHs start in a same slot (for example, due to same K0 value), and all co-scheduled cells have a same SCS.

In one example, K1 can start from the last DL slot (of a corresponding PDSCH) that overlaps with a PUCCH slot (that corresponds to K1=0). For Type-2, K1 is w.r.t. PCell (cell of PUCCH). If there is a second stage DCI in a PDSCH, the K1 values of those DCIs can be w.r.t. the overlapping slot of the PCell.

In one realization, a UE with multi-cell scheduling configuration can be provided with a single value for each of TDRA, K1, and PRI parameters, but the UE interprets the fields separately for each cell from the set of co-scheduled cells, that is, a cell-specific interpretation. For example, based on a single/same indication for TDRA/K0/K1/PRI, the UE determines a first TDRA/K0 value for a first PDSCH with a corresponding HARQ-ACK feedback to be transmitted in a first PUCCH resource and with a slot timing based on a first K1, while the UE determines a second TDRA/K0 value for a second PDSCH with a corresponding HARQ-ACK feedback to be transmitted in a second PUCCH resource and with a slot timing based on a second K1. For example, the first and second values for each of the corresponding TDRA/K0/K1/PRI parameters can be different. Such UE behavior can be realized, for example, based on corresponding configurations for single-cell scheduling, that is, without need for any dedicated configuration(s) for multi-cell scheduling. Construction of Type-1 HARQ-ACK codebooks for such a scenario can follow legacy procedure applied to each PDSCH from co-scheduled PDSCHs on the set of co-scheduled cells. Therefore, this realization is not further considered in the remainder of the present disclosure.

In one example, a UE can be configured multiple sets of cells for multi-cell scheduling of PDSCHs/PUSCHs by a DCI format 0_3/1_3. For example, each set of cells, from the multiple sets of cells, can include one or more cells. For example, the UE expects that different sets of cells are mutually exclusive, so a cell in a first set of cells cannot be included in a second set of cells. In another example, the UE can be configured two sets of cells that include a same cell. For example, the latter example can be conditioned to occur (only) when the two sets of cells include a same number of cells or correspond to a same maximum number of TBs across different cells or across different cell combinations configured for the set of cells.

For example, the UE can report a capability for a maximum number of sets of cells for multi-cell scheduling. For example, different sets of cells for multi-cell scheduling can correspond to same or different scheduling cell. In one example, each set of cells corresponds to a different scheduling cells, so the UE is configured a single set of cells for each scheduling cell. The latter example can be based on a UE capability that does not support multiple sets of cells for a same scheduling cell. In one example, the UE can be configured a scheduling cell that corresponds to more than one sets of cells. The latter example can be based on a UE capability that supports multiple sets of cells for a same scheduling cell. For example, the UE can report a maximum number of sets of cells that can correspond to each/any scheduling cell.

In one example, when a UE is configured first and second sets of cells for multi-cell scheduling from a same scheduling cell, mixture scheduling among different sets of cells is not supported. For example, a DCI format 0_3/1_3 can schedule PUSCHs/PDSCHs on cells from (only) one set of cells, wherein the UE can determine the one set of cells, for example, based on a cell set indicator field (CSIF or SIF for short) in the DCI format 1_3/0_3. A bit-width of the CSIF is ceil(log 2(N_set)), wherein N_set is a number of sets of cells for multi-cell scheduling associated with a same scheduling cell. For example, a first DCI format 0_3/1_3 can schedule first PUSCHs/PUSCHs on first cells (only) from a first set of cells, and a second DCI format 0_3/1_3 can schedule second PUSCHs/PUSCHs on second cells (only) from a second set of cells. In another example, mixture scheduling among different sets of cells may be supported, for example, subject to UE capability. For example, a DCI format 0_3/1_3 can schedule both first PUSCHs/PDSCHs on first cells from a first set of cells and second PUSCHs/PDSCHs on second cells from a second set of cells. For example, the DCI format 0_3/1_3 can include two CSIF values with a first CSIF value indicating the first set of cells and a second CSIF value indicating the second set of cells.

In one example, when the UE is configured only a single set of cells associated with a scheduling cell, N_set=0, a CSIF is not present in the DCI forma 0_3/1_3, and the UE can determine that any DCI format 0_3/1_3 provided by a PDCCH on the scheduling cell corresponds to the single set of cells.

For example, a DCI format 0_3/1_3 can schedule any cell combination (that is, any subset of cells), from a set of cells, and the UE can determine a co-scheduled cell combination based on, for example, a cell-specific field in DCI format 0_3/1_3, such as an FDRA field, that provides separate values for each cell in the set of cells. For example, a DCI format can schedule only cell combinations (that is, only subset of cells), from a set of cells, that is provided by higher layers for the set for the set of cells. For example, the UE can be configured, for the set of cells, a table/list of cell combinations along with corresponding IDs for the respective cell combinations, and a co-scheduled cell combination indicator field in the DCI format 0_3/1_3 indicates a cell combination for scheduling PUSCHs/PDSCHs by providing an ID corresponding to the cell combination. For example, the co-scheduled cell combination indicator field includes ceiling(log 2(N_cell_combo,s)), wherein N_cell_combo,s is a number of configured cell combinations (or a number of corresponding IDs) for a set of cells with set index s. For example, the UE can be configured separate table/list of cell combinations for DCI format 0_3 for scheduling PUSCHs, and for DCI format 1_3 for scheduling PDSCHs. For example, a first set of cells can be configured for DCI format 13, and no DCI format 0_3 applies to the set of cells. For example, a second set of cells can be configured for DCI format 03, and no DCI format 1_3 applies to the set of cells. For example, a set of cells can be configured both DCI format 0_3 and DCI format 1_3. For example, the UE expects that all sets of cells can be configured both DCI format 0_3 and 1_3.

For example, the UE determines a size of DCI format 0_3 separately for each set of cells for multi-cell scheduling. For example, the UE can determine a first size for a first DCI format 0_3 scheduling PUSCHs on cells from a first set of cells, and a second size for a second DCI format 0_3 scheduling PUSCHs on cells from a second set of cells.

For example, the UE determines a size of DCI format 1_3 separately for each set of cells for multi-cell scheduling. For example, the UE can determine a first size for a first DCI format 1_3 scheduling PDSCHs on cells from a first set of cells, and a second size for a second DCI format 1_3 scheduling PDSCHs on cells from a second set of cells.

In one example, the UE counts sizes of DCI formats 0_3 and 1_3 corresponding to a set of cells towards a DCI size budget (referred to as, the “3+1” rule) for a reference cell from the set of cells. For example, the reference for the set of cells cell can be the scheduling cell when the scheduling cell is included in the set of cells and search space sets of the DCI format 0_X/1_X is configured only on the scheduling cell. For example, when the search space sets of the DCI format 0_X/1_X are configured on a cell from the set of cells, in addition to the scheduling cell, the reference cell can be the cell on which (linked) search space sets of DCI format 0_X/1_X are configured and are associated with the search space sets of the scheduling cell with the same search space IDs. For example, when the scheduling cell is not included in a set of cells, the UE expects to be configured (linked) search space sets of DCI format 0_X/1_X on (only) one cell from the set of cells.

In one example, the UE can determine a first size for a DCI format 0_3 and a second size for a DCI format 1_3, with the first size different from the second size, when both DCI formats 0_3 and 1_3 correspond to a same set of cells. In one example, the UE applies size alignment between DCI formats 0_3 and 1_3 corresponding to a same set of cells when the DCI size budget (“3+1”) on a reference cell is exceeded after applying DCI size alignment to all single-cell scheduling DCI formats.

In one example, different sets of cells for multi-cell scheduling can correspond to one or more of the following:
separate n_CI values, wherein an n_CI value for the set of cells is same as a value provided as the cell set indicator field (CSIF or SIF) in the DCI format 0_3/1_3; When multiple sets of cells correspond to a same scheduling cell, the UE expects unique/different n_CI values (equivalently, unique/different CSI values) for each set of cells;
separate search space sets (for example, USS sets) for monitoring one or both of DCI formats 0_3/1_3;
separate reference cells for counting DCI format sizes for DCI formats 0_3/1_3, or for counting a number of PDCCH candidates or non-overlapping CCEs corresponding to (search space sets for monitoring) DCI formats 0_3/1_3.

In one example, when a UE is configured multiple set of cells for multi-cell scheduling from a same or different scheduling cells, the UE can monitor a first PDCCH in a first monitoring occasion (MO) for detection of a first DCI format for multi-cell scheduling and can monitor a second PDCCH in the same MO for detection of a second DCI format for multi-cell scheduling, wherein the first and the second DCI formats correspond to cells from same or different sets of cells.

In one example, the UE can receive first and second PDCCHs on first and second scheduling cells in a same PDCCH monitoring occasion (MO), providing first and second DCI formats for multi-cell scheduling, such as first and second DCI formats 13, that schedule first PDSHCs and second PDSCHs on first cells from a first set of cells and second cells from a second set of cells, respectively, such that:
in a first example, the first set and the second set of cells are separate (the corresponding scheduling cells can be same or different); or
in a second example, the first set and the second set of cells are the same (so the corresponding scheduling cell is the same), and the first cells and the second cells are separate; or
in a third example, the first set and the second set of cells are the same (so the corresponding scheduling cell is the same), and the first cells and the second cells share at least one cell.

At least the second and third examples can be based on corresponding UE capabilities.

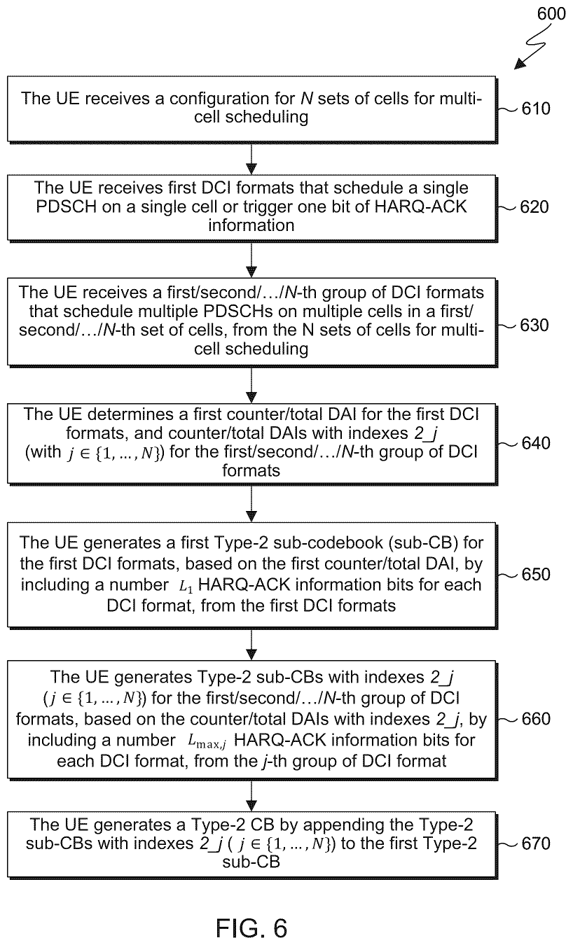

Generation of a separate Type-2 sub-CB for DCI formats scheduling a single cell and multiple separate Type-2 sub-CBs for DCI formats scheduling multiple cells corresponding to more than one sets of cells for multi-cell scheduling: FIG. 6 illustrates a flow chart of an example UE procedure 600 for generating separate Type-2 HARQ-ACK sub-CBs for single-cell scheduling and for multi-cell scheduling, wherein separate Type-2 sub-CBs are generated for each set of cells for multi-cell scheduling. The procedure 600 may be performed by a UE (e.g., any of the UEs 111-116 as illustrated in FIG. 1). An embodiment of the UE procedure 600 shown in FIG. 6 is for illustration only and does not limit the scope of this disclosure to any particular implementation.

As shown in FIG. 6, the UE procedure 600 begins at step 610, where the UE receives a configuration for N sets of cells for multi-cell scheduling. At step 620, the UE receives first DCI formats that schedule a single PDSCH on a single cell or trigger one bit of HARQ-ACK information. At step 630, the UE receives a first/second/ . . . /N-th group of DCI formats that schedule multiple PDSCHs on multiple cells in a first/second/ . . . /N-th set of cells, from the N sets of cells for multi-cell scheduling. At step 640, the UE determines a first counter/total DAI for the first DCI formats, and counter/total DAIs with indexes 2_j (with j∈{1, . . . , N}) for the first/second/ . . . /N-th group of DCI formats. At step 650, the UE generates a first Type-2 sub-codebook (sub-CB) for the first DCI formats, based on the first counter/total DAI, by including a number L₁ HARQ-ACK information bits for each DCI format, from the first DCI formats. At step 660, the UE generates Type-2 sub-CBs with indexes 2_j (j∈{1, . . . , N}) for the first/second/ . . . /N-th group of DCI formats, based on the counter/total DAIs with indexes 2_j, by including a number L_{max,j} HARQ-ACK information bits for each DCI format, from the j-th group of DCI format. At step 670, the UE generates a Type-2 CB by appending the Type-2 sub-CBs with indexes 2_j (j∈{1, . . . , N}) to the first Type-2 sub-CB.

In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and multiple second Type-2 sub-CBs for DCI formats that schedule more than one cell. The multiple second Type-2 sub-CBs can have a one-to-one or one-to-many association with the more than one sets of cells for multi-cell scheduling. The multiple second Type-2 sub-CBs include a number of HARQ-ACK information bits based on a number of TBs configured for the cell combinations that are configured for the associated sets of cells for multi-cell scheduling. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide first bits/value corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for all Type-2 sub-CBs or only for one or some Type-2 sub-CBs. When applicable, the UE can determine a last DCI format separately for each set of cells or for each Type-2 sub-CB, or jointly across a number/all sets of cells or Type-2 sub-CBs. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the multiple Type-2 sub-CBs in ascending order of the sets of cells.

Number, size, and ordering of Type-2 HARQ-ACK sub-CBs

When a UE is configured a number N≥1 sets of cells for multi-cell scheduling from same or different scheduling cells, in a first option, the UE generates a first Type-2 sub-CB and a number N second Type-2 sub-CBs (for example, referred to as sub-CB index {2_1, 2_2, . . . , to 2_N}). For example, the first Type-2 sub-CB corresponds to DCI formats that each schedule a single cell or trigger one HARQ-ACK information bit, such as one or more of the following:
a single-cell scheduling DCI format, such as DCI format 1_0, 1_1 or 1_2, that schedules a single cell; or
a multi-cell scheduling DCI format, such as DCI format 13, that schedules a single cell from any of N sets of cells for multi-cell scheduling; or
“special” DCI formats that are not used for scheduling PDSCH/data (e.g., used for control indication purposes) and trigger a single HARQ-ACK information bits, such as a DCI format for one or more of: SPS PDSCH release, CG PUSCH release, TCI state indication, SCell dormancy indication;
SPS PDSCH reception.

For example, each of the N second Type-2 sub-CBs correspond to a set of cells, from the N sets of cells for multi-cell scheduling. For example, the UE generates the Type-2 sub-CB index 2_1 for (all) DCI formats 1_3 that schedule PDSCHs on more than one cell from the first set of cells, and generates the Type-2 sub-CB index 2_2 for (all) DCI formats 1_3 that schedule PDSCHs on more than one cell from the second set of cells, and so on.

For example, an ordering of the N sets of cells for multi-cell scheduling (to determine, for example, the first/second/ . . . set of cells) can be based, for example, on one or more of the following:
in ascending (or descending) order of a smallest (or largest) cell index or CIF of cells within a set of cells. For example, a first set of cells comprising {cell 1, cell 4} has smaller set index than a second set of cells comprising {cell 2, cell 3}; or
in ascending (or descending) order of an (explicit) index for a set of cells provided as an information element (IE) for the set of cells by higher layer configuration, such as RRC. For example, a unique set index can be provided for each set of cells across different scheduling cells; or
first in ascending (or descending) order of a cell index or CIF for a scheduling cell corresponding to a set of cells, and next in ascending (or descending) order of:
   a smallest (or largest) cell index or CIF of cells within a set of cells, or
   an (explicit) index for a set of cells provided as an information element (IE) for the set of cells by higher layer configuration. For example, a unique set index can be provided for each set of cells corresponding to a same scheduling cell (while same set index values can be re-used across different scheduling cells).

For example, the UE generates one HARQ-ACK information bit for each DCI format corresponding to the first Type-2 sub-CB (at least) when the UE is configured a single TB for a PDSCH reception on any cell from any sets of cells or any cell in a corresponding PUCCH group or when the UE is configured spatial bundling for HARQ-ACK information on the cell group. For example, the UE generates two HARQ-ACK information bits for each DCI format corresponding to the first Type-2 sub-CB when the UE is configured two TBs for a PDSCH reception on at least one cell from a set of cells and the UE is not configured spatial bundling. In the latter example, for DCI formats that do not schedule two TBs, the UE can generate a predetermined value, such as (always) ACK or (always) NACK, for the second HARQ-ACK information bit corresponding to the DCI format.

For example, the UE generates L1 bits for each DCI format corresponding to a second Type-2 sub-CB with index 2_1 corresponding to a first set of cells for multi-cell scheduling, L_2 bits for a second Type-2 sub-CB with index 2_2 corresponding to a second set of cells for multi-cell scheduling, and so on. For example, L1, L2, and so on are:
a number of cells in the respective set of cells; or
a maximum number of cells across configured cell combinations for the set of cells; or
a maximum total number of configured TBs for cells across the configured cell combinations for the set of cells.

The UE determines a number of HARQ-ACK information bits in each of the multiple second Type-2 sub-CBs independently for each set of cells.

For example, when the UE is configured:
a set of cells consisting of cells {1, 2, 3, 4},
two TBs for cell #1, one TB for cell #2, one TB for cell #3, and two TBs for cell #4, and
cell combination #1=cells {1, 2}, cell combination #2=cells {3, 4}, cell combination #3=cells {1, 2, 3}, and cell combination #4=cells {1, 3, 4},
   then:
the set of cells has 4 cells,
the maximum number of cells across configured cell combinations for the set of cells is 3 cells, and
the cell combinations #1, #2, #3, and #4 are associated with 3, 3, 4, and 5 TBs, respectively, so a maximum total number of configured TBs for cells across the configured cell combinations is 5 TBs.

For example, based on the last method, the UE generates 5 bits of HARQ-ACK information for each DCI format corresponding to the set of cells.

In a second option, the UE generates a first Type-2 sub-CB as described in the first option, and a number M second Type-2 sub-CBs (for example, referred to as sub-CB index {2_1, 2_2, . . . , to 2_M}), where 1≤M≤N. For example, the UE generates a same second Type-2 CB for a first set of cells and a second set of cells when the first and the second sets of cells:
correspond to a same scheduling cell; or
include a same number of cells; or
correspond to a same maximum number of cells across cell combinations configured for the respective set of cells; or
correspond to a same maximum total number of configured TBs across cell combinations configured for the respective set of cells.

In a first example, the UE generates the Type-2 sub-CB index 2_1 for (all) DCI formats 1_3 that schedule PDSCHs on more than one cell from any set of cells corresponding to a first scheduling cell, and generates the Type-2 sub-CB index 2_2 for (all) DCI formats 1_3 that schedule PDSCHs on more than one cell from any set of cells corresponding to a second scheduling cell, and so on. For example, an ordering of the scheduling cells can be in ascending (or descending) order of a cell index for a scheduling cell.

For example, the UE generates L_1 bits for each DCI format corresponding to a second Type-2 sub-CB with index 2_1 that is associated with (all) sets of cells for a first scheduling, L_2 bits for a second Type-2 sub-CB with index 2_2 that is associated with a (all) sets of cells for a second scheduling cell, and so on. For example, L_1, L_2, . . . , and L_M are:
a maximum number of cells across sets of cells for a respective scheduling cell; or
a maximum number of cells across configured cell combinations for any set of cells for a respective scheduling cell; or
a maximum total number of configured TBs for cells across the configured cell combinations for any set of cells for a respective scheduling cell.

The UE determines a number of HARQ-ACK information bits in each of the multiple second Type-2 sub-CBs independently for each scheduling cell.

In a second example, the UE generates the Type-2 sub-CB index 2_1 for (all) DCI formats 1_3 that schedule PDSCHs on more than one cell from any set of cells that include a first number of cells (for example, all set of cells with 2 cells), and generates the Type-2 sub-CB index 2_2 for (all) DCI formats 1_3 that schedule PDSCHs on more than one cell from any set of cells that include a second number of cells (for example, all set of cells with 3 cells), and so on. For example, an ordering of the second Type-2 sub-CBs can be in ascending (or descending) order of a number of cells in a set of cells.

For example, the UE generates L_1 bits for each DCI format corresponding to a second Type-2 sub-CB with index 2_1 that is associated with (all) sets of cells that include a first number of cells (such as 2 cells), L_2 bits for a second Type-2 sub-CB with index 2_2 that is associated with (all) sets of cells that include a second number of cells (such as 3 cells), and so on. For example, L_1, L_2, . . . , and L_M are:
the first/second/ . . . number of cells (for example, 2 bits when 2 cell, 3 bits when 3 cells, and so on); or
a maximum number of cells across configured cell combinations for any set of cells that include a first/second/ . . . number of cells; or
a maximum total number of configured TBs for cells across the configured cell combinations for any set of cells that include a first/second/ . . . number of cells.

The UE determines a number of HARQ-ACK information bits in each of the multiple second Type-2 sub-CBs independently for each collections of sets of cells that include a same (first/second/ . . . ) number of cells.

In a third example, the UE determines, for each set of cells, a respective maximum number of cells among cell combinations configured for the set of cells. When first and second sets of cells have a same respective maximum number of cells among the corresponding cell combinations, the UE generates a same second Type-2 sub-CB for the first and second sets of cells.

For example, the UE generates:
the Type-2 sub-CB index 2_1 for (all) DCI formats 1_3 that schedule PDSCHs on more than one cell from any set of cells for which a maximum number of cells among the corresponding cell combinations equals a first value, that is, any set of cells with a size of a largest cell combination equal to the first value (for example, all set of cells with cell combinations having at most 2 cells), and
the Type-2 sub-CB index 2_2 for (all) DCI formats 1_3 that schedule PDSCHs on more than one cell from any set of cells for which a maximum number of cells among the corresponding cell combinations equals a second value, that is, any set of cells with a size of a largest cell combination equal to the second value (for example, all set of cells with cell combinations having at most 3 cells),
and so on.

For example, an ordering of the second Type-2 sub-CBs can be in ascending (or descending) order of a maximum number of cells in respective largest cell combinations.

For example, the UE generates L_1 bits for each DCI format corresponding to a second Type-2 sub-CB with index 2_1 that is associated with (all) sets of cells with a size of a largest cell combination equal to a first value (such as, all set of cells with cell combinations having at most 2 cells), L_2 bits for a second Type-2 sub-CB with index 2_2 that is associated with (all) sets of cells with a size of a largest cell combination equal to the second value (such as, all set of cells with cell combinations having at most 3 cells), and so on. For example, L_1, L_2, . . . , and L_M are:
a maximum number of cells across sets of cells with a respective size for a largest cell combination;
the first/second/ . . . values (for example, 2 bits when 2 cells, 3 bits when 3 cells, and so on); or
a maximum total number of configured TBs for cells across the configured cell combinations for any set of cells with a respective size for a largest cell combination.

The UE determines a number of HARQ-ACK information bits in each of the multiple second Type-2 sub-CBs independently for each collections of sets of cells with a same size for a largest cell combination.

In a fourth example, the UE determines, for each set of cells, a total number of TBs configured for cells among cell combinations configured for the set of cells, and accordingly determines a respective maximum total number of TBs configured for cells among the respective cell combinations. When first and second sets of cells have a same respective maximum total number of TBs configured for cells among the respective cell combinations, the UE generates a same second Type-2 sub-CB for the first and second sets of cells.

For example, the UE generates:
the Type-2 sub-CB index 2_1 for (all) DCI formats 1_3 that schedule PDSCHs on more than one cell from any set of cells for which a maximum total number of TBs configured for cells among the corresponding cell combinations is equal to a first value (for example, all set of cells with a maximum of 2 TBs for any cell combination), and
the Type-2 sub-CB index 2_2 for (all) DCI formats 1_3 that schedule PDSCHs on more than one cell from any set of cells for which a maximum number of cells among the corresponding cell combinations is equal to a second value (for example, all set of cells with a maximum of 3 TBs for any cell combination),
and so on.

For example, an ordering of the second Type-2 sub-CBs can be in ascending (or descending) order of a value of a maximum total number of TBs in respective cell combinations.

For example, the UE generates L_1 bits for each DCI format corresponding to a second Type-2 sub-CB with index 2_1 that is associated with (all) sets of cells with a maximum total number of TBs configured for cells among the corresponding cell combinations equal to a first value (for example, all set of cells with a maximum of 2 TBs for any cell combination), L2 bits for a second Type-2 sub-CB with index 2_2 that is associated with (all) sets of cells with a maximum total number of TBs configured for cells among the corresponding cell combinations equal to a second value (for example, all set of cells with a maximum of 3 TBs for any cell combination), and so on. For example, L_1, L_2, . . . , and L_M are:
a maximum number of cells across sets of cells with a respective value for a maximum number of TBs across cell combination;
a maximum number of cells across configured cell combinations for any set of cells with a respective value for a maximum number of TBs across cell combination;
the first/second/ . . . values (for example, 2 bits when 2 TBs, 3 bits when 3 TBs, and so on).

The UE determines a number of HARQ-ACK information bits in each of the multiple second Type-2 sub-CBs independently for each collections of sets of cells with a same value for a maximum number of TBs across cell combination.

When a UE receives a DCI format 1_3 that schedules:
multiple PDSCHs on multiple cells from a set of cells for multi-cell scheduling, and
to receive the multiple PDSCHs, except for one PDSCH on one cell from the multiple cells, on symbols that overlap with UL symbols as indicated by a respective common or dedicated TDD DL/UL configuration,
   the UE provides HARQ-ACK information bits corresponding to the DCI format 1_3 in a second Type-2 sub-CB, from the multiple second Type-2 sub-CBs, that is associated with the set of cells (using any of the above methods for association). The UE does not receive the multiple PDSCHs, except for the one PDSCH on the one cell. In one example, the UE generates ACK values for the PDSCHs that overlap with the UL symbols. In another example, the UE generates NACK values for the PDSCHs that overlap with the UL symbols.

For each DCI format in any of the multiple second Type-2 sub-CBs, a corresponding number of HARQ-ACK information bits for the respective co-scheduled PDSCHs by a DCI format 1_3 are ordered in ascending (or descending) order of serving cell indices, or cell-level CIF values, or a (new) index provided for cells in a respective set of cells, of the co-scheduled PDSCHs.

When a DCI format 1_3 corresponding to a second Type-2 sub-CB index 2_j schedules fewer cells than a maximum number of cells in any configured cell combination for an associated set of cells, the UE determines N HARQ-ACK feedback information bits corresponding to the actually scheduled cells, with N<N_{max,2_j} wherein N_{max,2_j} is a number of HARQ-ACK information bits that UE generates for each corresponding DCI format 1_3. In one example, HARQ-ACK information corresponding to the remaining (N_{max,2_j}−N) bits for the non-scheduled cells are NACKs. In another example, the HARQ-ACK information corresponding to the remaining (N_{max,2_j}−N) bits for the non-scheduled cells are ACKs.

The UE determines the ordering/placement of N HARQ-ACK feedback information bits corresponding to the scheduled cells within the N_{max,2_j} bits based on one of the following options:
Option 1: The N HARQ-ACK information bits corresponding to actually co-scheduled cells by the DCI format are placed first, where the N bits are placed in ascending (or descending) order of the cell index or CIF value of the cells or an ordering of cells within the set of cells, and the (N_{max,2_j}−N) NACKs are included at the end, or
Option 2: The HARQ-ACK information bits for both scheduled and non-scheduled cells are placed in order based on any of the ordering described in Option 1, such as in ascending order of cell indexes of the cells. For example, N HARQ-ACK information bits corresponding to actually co-scheduled cells by the DCI format 1_3 are placed in corresponding positions based on the ordering of cell, and for each cell from the set of cells that is not scheduled by the DCI format 13, NACK bits (or ACK bits) are inserted in the corresponding position based on the same ordering (potentially in between the Nbits).

In one example, when a cell is configured with up to 2 TBs for a PDSCH without spatial bundling, the HARQ-ACK information bits corresponding to the cell includes 2 consecutive bits regardless of whether a DCI format 1_3 schedules a PDSCH with one TB or 2 TBs on the cell. In another example, when a DCI format schedules a PDSCH with one TB, the UE can include the HARQ-ACK information for the non-scheduled TB along with HARQ-ACK information bits for any non-scheduled cells, so it is separate from HARQ-ACK information for the actually scheduled TB by the DCI format 1_3.

For the non-scheduled TB, in one alternative, the UE includes a NACK bit. In another alternative, the UE includes an ACK bit. In one example, a HARQ-ACK information for a non-scheduled TB is same as a HARQ-ACK information bit for a non-scheduled cell (both NACKs, or both ACKs).

The UE includes a corresponding number of HARQ-ACK information bits for each missed DCI format for each of the first or the multiple second Type-2 sub-CBs. The UE detects the existence and ordering of missed DCI formats based on values provided by a total DAI (tDAI) field/sub-field in DCI formats scheduling PDSCH receptions or by a corresponding DAI field/sub-field in DCI formats scheduling PUSCH transmissions (sometimes referred to as, UL DAI).

For example, the UE generates a number of bits, such as 1 or 2 bits, for each DCI format corresponding to the first Type-2 sub-CB, as previously described. For example, the UE determines a number of bits for the first Type-2 sub-CB regardless of a method for determining a number of the multiple second sub-CBs or respective sizes of the multiple second sub-CBs.

The UE concatenates the multiple second sub-CBs based on the ordering methods as previously described, and appends the concatenated second sub-CBs to the end of the first sub-CB to generate the Type-2 CB that the UE provides on the corresponding PUCCH or PUSCH transmission.

In one example, when the UE does not detect any DCI format corresponding to a set of cells with index j, with j∈{1, . . . N}, the UE does not generate a Type-2 sub-CB index 2_j or include in the concatenated Type-2 CB. Similar, when the UE does not detect any DCI format corresponding to any sets of cells associated with a Type-2 sub-CB with index 2_j, with j∈{1, . . . M}, the UE does not generate a Type-2 sub-CB index 2_j or include in the concatenated Type-2 CB.

### Impact on Counter DAI in Downlink DCI Formats

In one example, the UE operates with a first counter DAI in first DCI formats that are associated with the first Type-2 sub-CB, and multiple second counter DAIs in respective second DCI formats that are associated with the respective multiple second Type-2 sub-CBs (such as M or N second counter DAIs corresponding to the M or N second sub-CBs, respectively, as previously described). For example, the first DCI formats are the DCI formats associated with the first Type-2 sub-CB, as previously described.

For example, the UE operates with a second counter DAI index 2_1 for a second Type-2 sub-CB index 2_1, a second counter DAI index 2_2 for a second Type-2 sub-CB index 2_2, and so on.

For example, when:
a DCI format 1_3 schedules multiple PDSCHs on multiple cells from a set of cells for multi-cell scheduling, and
the set of cells is associated with a second Type-2 sub-CB with index 2_j (with j∈{1, . . . , M} or j∈{1, . . . , N}) from the multiple (M or N) second Type-2 sub-CBs (using any of the methods for association as previously described), a DAI field in the DCI format 1_3 provides a value for a counter DAI index 2_j.

In one example, the UE increments the counter DAI per DCI format, regardless of a number of PDSCHs that are scheduled by the DCI format. For example, if a DCI format 1_3 schedules 4 PDSCHs, the UE increments the counter DAI by (only) one. The UE increments the counter DAI index 2_j by one each time the UE receives a DCI format 1_3 corresponding to a set of cells for multi-cell scheduling that is associated with the second Type-2 HARQ-ACK sub-CB index 2j.

In one example, the value of the second counter DAI index 2_j field in the corresponding DCI format 1_3 denotes the accumulative number of {serving/reference cell, PDCCH monitoring occasion}-pairs in which PDSCH receptions, is present up to a reference serving cell and a current PDCCH monitoring occasion,
first, if the UE indicates by type2-HARQ-ACK-Codebook support for more than one PDSCH reception on a reference cell that are scheduled from a same PDCCH monitoring occasion, in increasing order of the PDSCH reception starting time for the same {reference cell, PDCCH monitoring occasion} pair,
second in ascending order of reference cell index, and
third in ascending order of PDCCH monitoring occasion index m, where 0≤m<M.

In one example, a UE does not expect to support a DCI format 1_3 that schedules more than one PDSCH receptions on a serving/reference cell in a same PDCCH monitoring occasion. Accordingly, the first bullet above may not apply for determination of the second counter DAIs.

In one example, a reference cell for counter DAI determination is a cell with smallest cells index, from the cells that are scheduled by the DCI format 1_3. For example, if a DCI format 1_3 schedules PDSCHs on cells with indexes {2, 3}, the reference cell for the counter DAI is cell 2. This holds even if cells {2, 3} are from a configured set of cells for multi-cell scheduling that includes cells with indexes {1, 2, 3, 4}.

In another example, a reference cell for counter DAI determination is a cell with smallest cells index, from the set of cells. In the above example, the reference cell for the counter DAI is cell 1, regardless of the cell combination scheduled by the DCI format 1_3, including whether or not the DCI format schedules a PDSCH on cell 1. For example, the reference cell is cell 1 (and not cell 2, as in the previous example).

For example, a size of a counter DAI can be 2 bits to provide a same reliability level for detection of missed DCIs and correct size of the HARQ-ACK sub-codebook as for single-cell scheduling DCI formats [TS 38.213, v17.4.0], which is 3 missed DCI formats. For example, a value of a counter DAI is provided by the 2 MSBs of a DAI field in the corresponding DCI format, such as DCI format 1_3.

For each Type-2 sub-CB, the UE orders the HARQ-ACK information bits among corresponding DCI formats 1_3 in ascending order of the counter DAI values provided in DCI formats 1_3. When a next value of respective counter DAI is not present in a next DCI format for a corresponding Type-2 sub-CB, the UE detects a missed DCI format and generates a corresponding number of NACK bits in the corresponding order/location. The UE also detects missed DCI formats based on total DAI or a DAI in an uplink DCI format, as subsequently described.

Impact on Total DAI (t-DAI) in Downlink DCI Formats

In one example, the UE operates with a first total DAI in first DCI formats that are associated with the first Type-2 sub-CB, and multiple second total DAIs in respective second DCI formats that are associated with the respective multiple second Type-2 sub-CBs (such as M or N second total DAIs corresponding to the M or N second sub-CBs, respectively, as previously described).

For example, the UE determines the first total DAI as for single-cell PDSCH scheduling, wherein the UE counts/accumulates a total number of first DCI formats across all serving cells up to a current PDCCH monitoring occasion. For example, the first DCI formats are the DCI formats associated with the first Type-2 sub-CB, as previously described.

For example, the UE operates with a total DAI index 2_1 for a Type-2 sub-CB index 2_1, a total DAI index 2_2 for a Type-2 sub-CB index 2_2, and so on.

For example, when:
a DCI format 1_3 schedules multiple PDSCHs on multiple cells from a set of cells for multi-cell scheduling, and
the set of cells is associated with a second Type-2 sub-CB with index 2_j (with j∈{1, . . . , M} or j∈{1, . . . , N}) from the multiple (M or N) second Type-2 sub-CBs (using any of the methods for association as previously described), a DAI field in the DCI format 1_3 provides a value for a total DAI index 2_j.

For example, the UE determines a total DAI index 2_j by counting/accumulating a total number of DCI formats 1_3 associated with the Type-2 sub-CB with index 2_j up to a current PDCCH monitoring occasion.

For example, a size of a total DAI can be 2 bits to provide a same reliability level for detection of missed DCIs and correct size of the HARQ-ACK sub-codebook as for single-cell scheduling DCI formats [TS 38.213, v17.4.0], which is 3 missed DCI formats. For example, a value of the total DAI is provided as 2 LSBs of the DAI field in the corresponding DCI format, such as DCI format 1_3.

It is noted that, each DCI format (for single-cell or multi-cell scheduling) includes a single value for total DAI value for the corresponding Type-2 sub-CB. For example, the DAI value in DCI format 1_3 corresponding to Type-2 sub-CB with index 2_j does not include a value for the first total DAI or for the second total DAI with index other than 2j.

In one example, when HARQ-ACK codebook generation depends on a value of a counter DAI or a total DAI or other properties associated with a last DCI format, and when the UE detects, in a (last) PDCCH monitoring occasion, more than one DCI format, such as a first DCI format 1_3 scheduling PDSCH on cells from a set of cell for multi-cell scheduling, and a second DCI format (such as a DCI format 1_0/1_1/1_2 or a second DCI format 1_3), the UE determines the last DCI format to be DCI format that is associated with the largest (or smallest) cell index. The first DCI format 1_3 (and the second DCI format 13) can be associated with more than one cell indexes, and a cell with smallest cell index is used as a reference cell for the first (or second) DCI format 1_3 when determining a last DCI format. For last DCI format determination, in one alternative, the UE determines the reference cell for the DCI format 1_3 to be a smallest cell index among the cells on which PDSCHs are scheduled by the DCI format 1_3. In another alternative, the UE determines the reference cell for the DCI format 1_3 to be a smallest cell index among the set of cells associated with the DCI format 1_3, regardless of whether or not the smallest cell index is scheduled by the DCI format 1_3.

In one example, a last DCI format is determined separately for each set of cells for multi-cell scheduling. In another example, a last DCI format is jointly determined among different sets of cells for multi-cell scheduling or among different Type-2 sub-CBs. In yet another alternative, a last DCI format is determined among a number of sets of cells for multi-cell scheduling or a number of Type-2 sub-CBs, that are determined as subsequently described for DAI value in UL DCI formats.

For example, a last DCI format can be, for example, a last DCI format in a last monitoring occasion among a number of PDCCH monitoring occasions corresponding to a HARQ-ACK transmission in a PUCCH/PUSCH.

### Impact on DAI in UL DCI Formats

When a UE generates a first Type-2 sub-CB for first DCI format, and multiple (such as M or N) second Type-2 sub-CBs for corresponding second DCI formats that are associated with the respective set of cells for multi-cell scheduling, an uplink DCI format that schedules a PUSCH transmission can include a DAI field with:
a first DAI value/sub-field, for the first Type-2 sub-CB, and
multiple (such as M or N) second DAI value/sub-field, each corresponding to one of the multiple second Type-2 sub-CBs, such as a value/sub-field for a DAI index 2_j associated with a Type-2 sub-CB with index 2_j.

In one example, the above applies when the UE determines separate counter/total DAI values for each Type-2 sub-CBs per corresponding DL DCI format.

For example, a size of each total DAI value/sub-field for each of the sub-CBs can be 2 bits to provide a same reliability level for detection of missed DCIs and correct size of the HARQ-ACK sub-codebook as for single-cell scheduling DCI formats [TS 38.213, v17.4.0], which is 3 missed DCI formats.

When multiplexing HARQ-ACK information on the PUSCH, the UE generates each of the Type-2 sub-CBs by determining parameter Vₜₑₘₚ₂ in a corresponding pseudo-code based on a value of a corresponding DAI sub-field in the UL DCI format, instead of a corresponding total DAI value provided in an associated DL DCI format.

The examples above can apply to any UL DCI format, such as a DCI format, such as an UL DCI format for single-cell scheduling, for example, DCI format 0_1/0_2, or a DCI format for multi-cell scheduling, for example, DCI format 0_3.

In one example, a DAI field in an UL DCI format includes only some of the above DAI values/sub-fields. For example, an UL DCI format for single-cell scheduling, such as DCI format 0_1/0_2, provides a DAI value only for the first Type-2 sub-CB, and does not provide a value/sub-field for any of the multiple second Type-2 sub-CBs.

For example, an UL DCI format for single-cell scheduling, such as DCI format 0_1/0_2, provides a first DAI value/sub-field for the first Type-2 sub-CB, and a second DAI value/sub-field for one second Type-2 sub-CB (for example with index 2_j), from the multiple second Type-2 sub-CBs. For example, the DAI field includes an index (for example, j) of the one second Type-2 sub-CB for which the DAI value/sub-field is provided.

For example, an UL DCI format for multi-cell scheduling, such as DCI format 0_3, provides multiple DAI values/sub-fields for the multiple second Type-2 sub-CB, and does not provide a value/sub-field for a first Type-2 sub-CB.

For example, an UL DCI format for multi-cell scheduling, such as a DCI format 0_3, that schedules only a single PUSCH on a single cell provides a DAI value only for the first Type-2 sub-CB, and does not provide a value for any of the second Type-2 sub-CB with index 2_j.

For example, an UL DCI format for multi-cell scheduling, such as DCI format 0_3, provides only one DAI value for one of the second Type-2 sub-CB (for example with index 2_j), from the multiple Type-2 sub-CBs, and does not provided a DAI value for the first Type-2 sub-CB or for any other second Type-2 sub-CBs (other than index 2_j), from the multiple second Type-2 sub-CBs. For example, the DAI field includes an index (for example, j) of the one second Type-2 sub-CB for which the DAI value is provided. In a variation, the one DAI value provided in DCI format 0_3 can be a DAI value corresponding to any of the Type-2 sub-CBs, including the first Type-2 sub-CB.

For example, an UL DCI format for multi-cell scheduling, such as DCI format 0_3, provides a number (one or more than one) of DAI values/subfield, wherein the number is provided by higher layers or predetermined in the specifications of system operation. For example, a DCI format 0_3 can include a number of indexes or a bitmap to indicate corresponding number of Type-2 sub-CBs.

In the above examples, when an UL DCI format does not provide a DAI value/sub-field for a Type-2 sub-CB, the UE generates the corresponding Type-2 sub-CB by determining parameter Vₜₑₘₚ₂ in a corresponding pseudo-code based on a value of a corresponding total DAI value provided in an associated DL DCI format.

In one example, a size of DAI field in UL DCI formats or DL DCI formats for multi-cell scheduling, such as DCI format 0_3 or 1_3, can be configurable by higher layers such as RRC.

Generation of multiple separate Type-2 sub-CB for DCI formats scheduling a single cell and multiple separate Type-2 sub-CBs for DCI formats scheduling multiple cells corresponding to more than one sets of cells for multi-cell scheduling: In one embodiment, for a UE configured with one or more than one sets of cells for multi-cell scheduling of PDSCHs, the UE can generate multiple first Type-2 sub-CBs for DCI formats scheduling a single cell or triggering a single bit for HARQ-ACK information per DCI format, and multiple second Type-2 sub-CBs for DCI formats that schedule more than one cell. The multiple first Type-2 sub-CBs can have a one-to-one mapping with a number of HARQ-ACK information bits (such as two first sub-CBs corresponding to one or two HARQ-ACK information bits) or can have a same association with the one or more than one sets of cells for multi-cell scheduling, as described in one or more embodiments herein, including any cells that do not belong to any set of cells for multi-cell scheduling. The UE generates the multiple second Type-2 sub-CBs as described in one or more embodiments herein. The counter/total DAI in downlink DCI formats as well as the DAI in uplink DCI formats increment based on a number of DCI formats (for example, rather than a number of PDSCHs or TBs that have triggered the HARQ-ACK information bits). Accordingly, the UE can operate with multiple first counter/total DAIs corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide multiple first bits/values corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for all Type-2 sub-CBs or only for one or some Type-2 sub-CBs. When applicable, the UE can determine a last DCI format separately for each set of cells or each Type-2 sub-CB, or jointly across a number/all sets of cells or Type-2 sub-CBs. The UE determines missed DCI formats based on values of the counter/total DAI fields provided in downlink DCI formats or based on bits/values provided in the DAI field in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the multiple first Type-2 sub-CBs in ascending order of the number of HARQ-ACK information bits or the order of the sets of cells and the multiple Type-2 sub-CBs in ascending order of the sets of cells.

In a first example, the UE generates two first Type-2 sub-CBs, such as a Type-2 sub-CB index 1_1 for DCI formats that trigger a single HARQ-ACK information bit, and a Type-2 sub-CB index 1_2 for DCI formats the schedule PDSCH on a single cell and trigger two HARQ-ACK information bits.

For example, the Type-2 sub-CB index 1_1 is associated with one or more of:
“special” DCI formats for control purpose that do not schedule a PDSCH and trigger a single HARQ-ACK information bit, such as a DCI format for one or more of: SPS PDSCH release or CG PUSCH release, or for SCell dormancy indication, or for TCI state indication, and
SPS PDSCH reception;
DCI formats for single-cell scheduling, such as DCI format 1_0/1_1/1_2, that schedules a PDSCH on a cell, wherein the cell is configured only one TB, or is configured two TBs with spatial bundling for HARQ-ACK reporting on PUSCH or PUCCH,
DCI formats for multi-cell scheduling, such as DCI format 1_3 that schedules a single PDSCH on a single cell, wherein the single cell is configured only one TB, or is configured two TBs with spatial bundling for HARQ-ACK reporting on PUSCH or PUCCH.

For example, the Type-2 sub-CB index 1_2 is associated with one or more of:
DCI formats for single-cell scheduling, such as DCI format 1_0/1_1/1_2, that schedules a PDSCH on a cell, wherein the cell is configured two TBs for PDSCH without spatial bundling for HARQ-ACK reporting on PUSCH or PUCCH,
DCI formats for multi-cell scheduling, such as DCI format 1_3, that schedules a single PDSCH on a single cell, wherein the single cell is configured two TBs without spatial bundling for HARQ-ACK reporting on PUSCH or PUCCH.

In a variation, when a cell is configured with two TBs for a PDSCH, and a DCI format for single-cell scheduling or for multi-cell scheduling schedules only one PDSCH with one TB on the cell, the DCI format corresponds to the Type-2 sub-CB index 1_1 (rather than 1_2, as described in the previous example).

The UE generates one HARQ-ACK information bits for sub-CB index 11, and two HARQ-ACK information bits for the sub-CB index 1_2.

In the above example, an ordering of the two first Type-2 sub-CBs is based on the number of HARQ-ACK information bits for each sub-CB, that is, the Type-2 sub-CB index 1_2 is appended to the end of the Type-2 sub-CB index 1_1.

In a second example, the UE generates (M+1) or (N+1) first Type-2 sub-CBs, with indexes 1_1, 1_2, . . . , 1_M, 1_(M+1), or with indexes 1_1, 1_2, . . . , 1_N, 1_(N+1), wherein generates M or N refer to a number of second Type-2 sub-CBs that the UE generates for multi-cell scheduling DCI formats associated with the more than one sets of cells for multi-cell scheduling.

For example, the first Type-2 sub-CB index 1 j (with j∈{1, . . . , M} or j∈{1, . . . , N}) is associated with DCI formats for single-cell scheduling or multi-cell scheduling that schedule a single PDSCH on a single cell, from a set of cells that is associated with the second Type-2 sub-CB index 2_j.

For example, the first Type-2 sub-CB index 1_(M+1) or 1_(N+1) is associated with
“special” DCI formats for control purpose that do not schedule a PDSCH and trigger a single HARQ-ACK information bit, such as a DCI format for one or more of: SPS PDSCH release or CG PUSCH release, or for SCell dormancy indication, or for TCI state indication, and
DCI formats for single-cell scheduling, such as DCI format 1_0/1_1/1_2, that schedules a PDSCH on a cell (if any) that is not included in any set of cells.

In the above example, an ordering of the multiple first Type-2 sub-CBs is based on the ordering of the sets of cells or ordering of the corresponding Type-2 sub-CBs, and the Type-2 sub-CB index 1_(M+1) or 1_(N+1) is appended to the end (or alternatively, included at the beginning) of the other first Type-2 sub-CBs.

The UE operates with multiple first counter/total DAI values corresponding to the multiple first Type-2 sub-CBs, and with multiple second counter/total DAI values corresponding to the multiple second Type-2 sub-CBs. The procedures are similar to those described in one or more embodiments herein.

A DAI field in an UL DCI format that schedules a PUSCH on a cell (or multiple PUSCHs on multiple cells) can provide multiple first DAI values/sub-fields corresponding to the multiple first Type-2 sub-CBs, and with multiple second DAI values/sub-fields corresponding to the multiple second Type-2 sub-CBs. This applies to any DCI format, including a DCI format for single-cell scheduling, such as DCI formats 0_1/0_2, or a DCI format 0_3 for multi-cell scheduling. In another example, a DAI field in an UL DCI format provides only one or a number of DAI values/sub-fields for one or a number of Type-2 sub-CBs (along with indexes of the sub-CBs). The procedures are similar to those described in one or more embodiments herein.

In one example, when the UE does not detect any DCI format associated with a Type-2 sub-CB with index 1_j, the UE does not generate a Type-2 sub-CB index 1_j or include in the concatenated Type-2 CB.

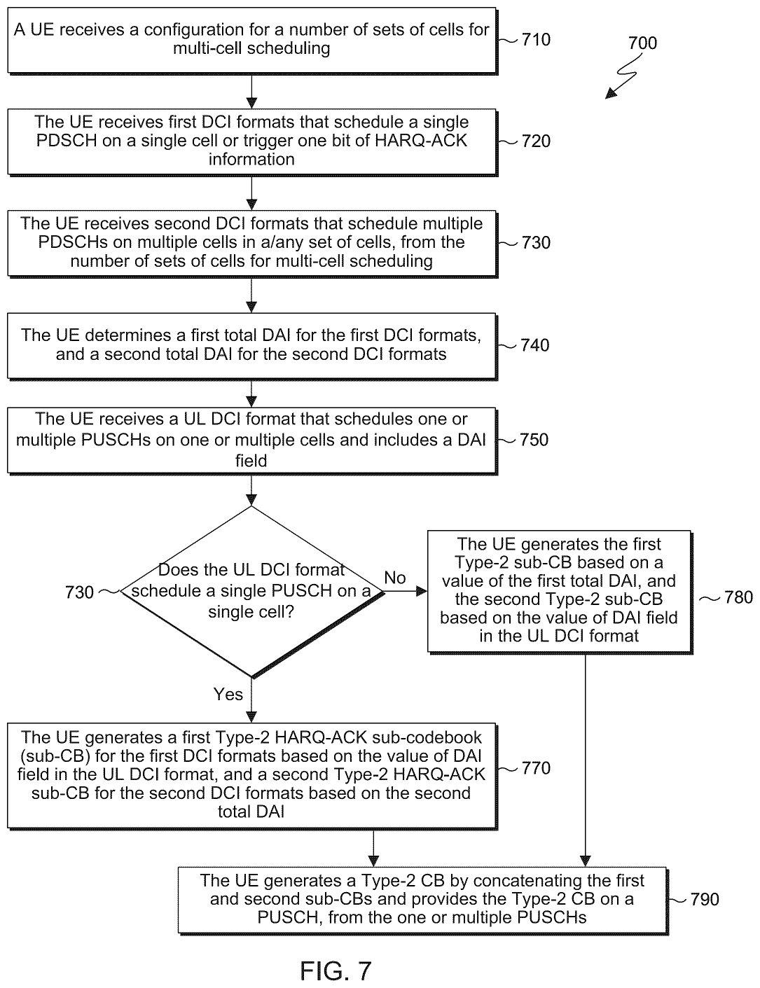

Generation of a separate Type-2 sub-CB for DCI formats scheduling a single cell and a single separate Type-2 sub-CB for DCI formats scheduling multiple cells across different sets of cells for multi-cell scheduling: FIG. 7 illustrates a flow chart of an example UE procedure 700 for generating separate Type-2 HARQ-ACK sub-CBs for single-cell scheduling and for multi-cell scheduling, based on a value of a DAI in an UL DCI format that is applicable to only one of the sub-CBs. The procedure 700 may be performed by a UE (e.g., any of the UEs 111-116 as illustrated in FIG. 1). An embodiment of the UE procedure 700 shown in FIG. 7 is for illustration only and does not limit the scope of this disclosure to any particular implementation.

As shown in FIG. 7, the UE procedure 700 begins at step 710, where a UE receives a configuration for a number of sets of cells for multi-cell scheduling. At step 720, the UE receives first DCI formats that schedule a single PDSCH on a single cell or trigger one bit of HARQ-ACK information. At step 730, the UE receives second DCI formats that schedule multiple PDSCHs on multiple cells in a/any set of cells, from the number of sets of cells for multi-cell scheduling. For example, HARQ-ACK information for the first DCI formats and the second DCI formats is to be provided by a same PUCCH. At step 740, the UE determines a first total DAI for the first DCI formats, and a second total DAI for the second DCI formats. At step 750, the UE receives a UL DCI format that schedules one or multiple PUSCHs on one or multiple cells and includes a DAI field. At step 760, the UE determines whether or not the UL DCI format schedules a single PUSCH on a single cell. At step 770, when the UE determines that the UL DCI format scheduled a single PUSCH on a single cell, the UE generates a first Type-2 HARQ-ACK sub-codebook (sub-CB) for the first DCI formats based on the value of DAI field in the UL DCI format, and a second Type-2 HARQ-ACK sub-CB for the second DCI formats based on the second total DAI. At step 780, when the UE determines that the UL DCI format scheduled a single PUSCH on a single cell, the UE generates the first Type-2 sub-CB based on a value of the first total DAI, and the second Type-2 sub-CB based on the value of DAI field in the UL DCI format. At step 790, the UE generates a Type-2 CB by concatenating the first and second sub-CBs and provides the Type-2 CB on a PUSCH, from the one or multiple PUSCHs. In another variation, the UL DCI format (regardless of single-cell scheduling or multi-cell UL scheduling) provides a first UL DAI for the first HARQ sub-CB, and a second UL DAI for the second HARQ sub-CB.

In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and a (single) second Type-2 sub-CB for DCI formats that schedule more than one cell. The second Type-2 sub-CB corresponds to (all) different sets of cells for multi-cell scheduling. The second Type-2 sub-CBs includes a number of HARQ-ACK information bits based on a number of TBs configured for the cell combinations that are configured across different sets of cells for multi-cell scheduling in a PUCCH group. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and a second counter/total DAI corresponding to multi-cell scheduling DCI formats, from the more than one sets of cells, that schedule more than one cell. Similar, the UE can operate with a DAI field in uplink DCI formats that provide a first value corresponding to DCI formats scheduling a single cell or triggering a single bit for HARQ-ACK information, and a second value corresponding to multi-cell scheduling DCI formats, from the more than one sets of cells, that schedule more than one cell. An UL DCI format can include DAI values for both Type-2 sub-CBs or only for one Type-2 sub-CB. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the second Type-2 sub-CB.

For example, the UE generates the first Type-2 sub-CB same as described in one or more embodiments herein. For example, the UE generates the Type-2 sub-CB by including HARQ-ACK information corresponding to DCI formats 1_3 that schedule PDSCHs on more than one cell from any set of cells.

For example, the UE generates one or two HARQ-ACK information bits for each DCI in the first Type-2 sub-CB.

For example, the UE generates a number of HARQ-ACK information bits for each DCI format corresponding to the second Type-2 sub-CB that is equal to:
a maximum number of cells in any set of cells, from the more than one sets of cells; or
a maximum number of cells across configured cell combinations for any set of cells, from the more than one sets of cells; or
a maximum total number of configured TBs for cells across the configured cell combinations for any set of cells, from the more than one sets of cells.

When a UE receives a DCI format 1_3 that schedules:
multiple PDSCHs on multiple cells from a set of cells for multi-cell scheduling, and
to receive the multiple PDSCHs, except for one PDSCH on one cell from the multiple cells, on symbols that overlap with UL symbols as indicated by a respective common or dedicated TDD DL/UL configuration,
   the UE provides HARQ-ACK information bits corresponding to the DCI format 1_3 in the second Type-2 sub-CB. The UE does not receive the multiple PDSCHs, except for the one PDSCH on the one cell. In one example, the UE generates ACK values for the PDSCHs that overlap with the UL symbols. In another example, the UE generates NACK values for the PDSCHs that overlap with the UL symbols.

For each DCI format 1_3 that schedules multiple PDSCHs on multiple cells from any set of cells, a corresponding number of HARQ-ACK information bits, in the second Type-2 sub-CB, for the respective co-scheduled PDSCHs by the DCI format 1_3 are ordered in ascending (or descending) order of serving cell indices, or cell-level CIF values, or a (new) index provided for cells in a respective set of cells, of the co-scheduled PDSCHs.

When a DCI format 1_3 corresponds to the second Type-2 sub-CB and schedules fewer cells than a maximum number of cells in any configured cell combination for an associated set of cells, the UE determines N HARQ-ACK feedback information bits corresponding to the actually scheduled cells, with N<Nₘₐₓ wherein Nₘₐₓ is a number of HARQ-ACK information bits that UE generates for each corresponding DCI format 1_3 (as previously described, for example, based in a maximum number of TBs for any cell combination in any set of cells). In one example, HARQ-ACK information corresponding to the remaining (Nₘₐₓ−N) bits for the non-scheduled cells are NACKs. In another example, the HARQ-ACK information corresponding to the remaining (Nₘₐₓ−N) bits for the non-scheduled cells are ACKs.

The UE determines the ordering/placement of N HARQ-ACK feedback information bits corresponding to the scheduled cells within the Nₘₐₓ bits based on one of the following options:
Option 1: The N HARQ-ACK information bits corresponding to actually co-scheduled cells by the DCI format are placed first, where the N bits are placed in ascending (or descending) order of the cell index or CIF value of the cells or an ordering of cells within the set of cells, and the (Nₘₐₓ−N) NACKs are included at the end, or
Option 2: The HARQ-ACK information bits for both scheduled and non-scheduled cells are placed in order based on any of the ordering described in Option 1, such as in ascending order of cell indexes of the cells. For example, N HARQ-ACK information bits corresponding to actually co-scheduled cells by the DCI format 1_3 are placed in corresponding positions based on the ordering of cells, and for each cell from the set of cells that is not scheduled by the DCI format 13, NACK bits (or ACK bits) are inserted in the corresponding position based on the same ordering (potentially in between the N bits).

The UE includes a corresponding number of HARQ-ACK information bits for each missed DCI format for each of the first or the multiple second Type-2 sub-CBs. The UE detects the existence and ordering of missed DCI formats based on values provided by a total DAI (tDAI) field/sub-field in DCI formats scheduling PDSCH receptions or by a corresponding DAI field/sub-field in DCI formats scheduling PUSCH transmissions (sometimes referred to as, UL DAI).

In one example, the UE operates with a first counter DAI in first DCI formats that are associated with the first Type-2 sub-CB, and a second counter DAI in second DCI formats that are associated with the second Type-2 sub-CB. For example, the first and second DCI formats are associated with the first and second Type-2 sub-CB, respectively, as previously described.

In one example, the UE increments the counter DAI per DCI format, regardless of a number of PDSCHs that are scheduled by the DCI format. For example, if a DCI format 1_3 schedules 4 PDSCHs, the UE increments the counter DAI by (only) one. The UE increments the counter DAI by one each time the UE receives a DCI format 1_3 that scheduled PDSCHs on more than one cell from any set of cells.

In one example, the value of the second counter DAI field in a corresponding DCI format 1_3 denotes the accumulative number of {serving/reference cell, PDCCH monitoring occasion}-pairs in which PDSCH receptions, is present up to a reference serving cell and a current PDCCH monitoring occasion,
first, if the UE indicates by type2-HARQ-ACK-Codebook support for more than one PDSCH reception, on a reference cell, that are scheduled from a same PDCCH monitoring occasion, in increasing order of the PDSCH reception starting time for the same {reference cell, PDCCH monitoring occasion} pair,
second in ascending order of reference cell index, and
third in ascending order of PDCCH monitoring occasion index m, where 0≤m<M.

In one example, a UE does not expect to support a DCI format 1_3 that schedules more than one PDSCH receptions on a serving/reference cell in a same PDCCH monitoring occasion. Accordingly, the first bullet may not apply for determination of the second counter DAI.

In one example, a reference cell for counter DAI determination is a cell with smallest cells index, from the cells that are scheduled by the DCI format 1_3. For example, if a DCI format 1_3 schedules PDSCHs on cells with indexes {2, 3}, the reference cell for the counter DAI is cell 2. This holds even if cells {2, 3} are from a configured set of cells for multi-cell scheduling that includes cells with indexes {1, 2, 3, 4}.

In another example, a reference cell for counter DAI determination is a cell with smallest cells index, from the set of cells. In the above example, the reference cell for the counter DAI is cell 1, regardless of the cell combination scheduled by the DCI format 1_3, including whether or not the DCI format schedules a PDSCH on cell 1. For example, the reference cell is cell 1 (and not cell 2, as in the previous example).

For example, a size of a counter DAI can be 2 bits to provide a same reliability level for detection of missed DCIs and correct size of the HARQ-ACK sub-codebook as for single-cell scheduling DCI formats [TS 38.213, v17.4.0], which is 3 missed DCI formats. For example, a value of a counter DAI is provided by the 2 MSBs of a DAI field in the corresponding DCI format, such as DCI format 1_3.

For the first/second Type-2 sub-CB, the UE orders the HARQ-ACK information bits among corresponding DCI formats in ascending order of the counter DAI values provided in the respective DCI formats. For example, for the second Type-2 sub-CB, the UE orders the HARQ-ACK information bits among corresponding DCI formats 1_3 in ascending order of the counter DAI values provided in DCI formats 1_3. When a next value of respective counter DAI is not present in a next DCI format for a corresponding Type-2 sub-CB, the UE detects a missed DCI format and generates a corresponding number of NACK bits in the corresponding order/location. The UE also detects missed DCI formats based on total DAI or a DAI in an uplink DCI format, as subsequently described.

In one example, the UE operates with a first total DAI in first DCI formats that are associated with the first Type-2 sub-CB, and a second total DAI in second DCI formats that are associated with the second Type-2 sub-CB.

For example, the UE determines the first total DAI as for single-cell PDSCH scheduling, wherein the UE counts/accumulates a total number of first DCI formats across all serving cells up to a current PDCCH monitoring occasion. For example, the first DCI formats are the DCI formats associated with the first Type-2 sub-CB, as previously described.

For example, the UE determines a second total DAI by counting/accumulating a total number of DCI formats 1_3 associated with the second Type-2 sub-CB up to a current PDCCH monitoring occasion.

For example, a size of a total DAI can be 2 bits to provide a same reliability level for detection of missed DCIs and correct size of the HARQ-ACK sub-codebook as for single-cell scheduling DCI formats [TS 38.213, v17.4.0], which is 3 missed DCI formats. For example, a value of the total DAI is provided as 2 LSBs of the DAI field in the corresponding DCI format, such as DCI format 1_3.

It is noted that, each DCI format (for single-cell or multi-cell scheduling) includes a single value for total DAI value for the corresponding Type-2 sub-CB. For example, the DAI value in DCI format 1_3 corresponding to second Type-2 sub-CB does not include a value for the first total DAI.

When a UE generates a first Type-2 sub-CB for first DCI format, and a second Type-2 sub-CBs for corresponding second DCI formats that are associated with the respective set of cells for multi-cell scheduling, an uplink DCI format that schedules a PUSCH transmission can include a DAI field with a first DAI value/sub-field, for the first Type-2 sub-CB, and a second DAI value/sub-field, for the second Type-2 sub-CB.

For example, a size of each total DAI value/sub-field for each of the sub-CBs can be 2 bits to provide a same reliability level for detection of missed DCIs and correct size of the HARQ-ACK sub-codebook as for single-cell scheduling DCI formats [TS 38.213, v17.4.0], which is 3 missed DCI formats.

When multiplexing HARQ-ACK information on the PUSCH, the UE generates each of the Type-2 sub-CBs by determining parameter Vₜₑₘₚ₂ in a corresponding pseudo-code based on a value of a corresponding DAI sub-field in the UL DCI format, instead of a corresponding total DAI value provided in an associated DL DCI format.

The examples above can apply to any UL DCI format, such as a DCI format, including an UL DCI format for single-cell scheduling, for example, DCI format 0_1/0_2, or a DCI format for multi-cell scheduling, for example, DCI format 0_3.

In one example, a DAI field in an UL DCI format includes only one of the two DAI values/sub-fields. For example, an UL DCI format for single-cell scheduling, such as DCI format 0_1/0_2, provides a DAI value only for the first Type-2 sub-CB, and does not provide a value/sub-field for the second Type-2 sub-CB.

For example, an UL DCI format for multi-cell scheduling, such as DCI format 0_3, provides a DAI value only for the second Type-2 sub-CB, and does not provide a value for the first Type-2 sub-CB.

For example, an UL DCI format for multi-cell scheduling, such as DCI format 0_3, that schedules only a single PUSCH on a single cell provides a DAI value only for the first Type-2 sub-CB, and does not provide a value for the second Type-2 sub-CB.

For example, an UL DCI format (for single-cell scheduling or multi-cell scheduling) provided a DAI value only for one of the two Type-2 sub-CBs, and includes a one-bit flag to indicate whether the provided DAI value is the first DAI value for the first Type-2 sub-CB or the second DAI value for the second Type-2 sub-CB.

In the above examples, when an UL DCI format does not provide a DAI value/sub-field for a Type-2 sub-CB, the UE generates the corresponding Type-2 sub-CB by determining parameter Vₜₑₘₚ₂ in a corresponding pseudo-code based on a value of a corresponding total DAI value provided in an associated DL DCI format.

In one example, a DCI format 0_3/1_3 can indicate a cell combination from a set of cells for multi-cell scheduling, wherein an FDRA field of DCI format 0_3/1_3 includes valid/non-reserved FDRA values for first cells from the indicated cell combination, and invalid/reserved FDRA values for second cells from the indicated cell combination. For example, the DCI format 0_3/1_3 schedules respective first PUSCHs/PDSCHs on the first cells, and does not schedule second PUSCHs/PDSCHs on the second cells. For example, the UE can be configured a set of cells using RRC parameter MC-DCI-SetofCells from a list of sets of cells MC-DCI-SetofCellsToAddModList, and the cell combination can be indicated using the ‘scheduled cells indicator’ field of DCI 0_3/1_3 from a list of cell combinations provided by RRC parameter ScheduledCellCombo-ListDCI-0-3/ScheduledCellCombo-ListDCI-1-3. For example, the set of cells can include third cells that are not included in the indicated cell combination by the DCI format 0_3/1_3. For example, the third cells can include zero, one, or more than one cells.

For example, such invalid/reserved values for FDRA can be used to validate that first DCI fields, from the DCI format 0_3/1_3, corresponding to the second cells provide an (implicit) indication of a UE procedure other than PUSCH/PDSCH scheduling, such as for one or more of: SCell dormancy indication, (enhanced) Type-3 HARQ-ACK codebook (CB) trigger, HARQ-ACK CB retransmission, Type-2 SPS PDSCH activation/deactivation, Type-2 configured grant (CG) PUSCH activation/deactivation, TCI state indication, and so on. For example, the first DCI fields can include one or more of MCS, new data indicator (NDI), redundancy version (RV), HARQ process number (HPN), antenna port (AP), DMRS sequence initialization field, and so on. For example, values of the first DCI fields are interpreted as values for parameter associated with the (implicitly) indicated UE procedure. For example, values of the first DCI fields are repurposed to provide bits or bitmaps associated with the (implicitly) indicated UE procedure. For example, second cells for which the first DCI fields are repurposed can include one cell or more than one cell.

In another example, a DCI format 0_3/1_3 may not include a ‘scheduled cells indicator’ field to indicate a cell combination from a corresponding/indicated set of cells. For example, the UE may not be provided a list of cell combinations provided by RRC parameter ScheduledCellCombo-ListDCI-0-3 or ScheduledCellCombo-ListDCI-1-3. For example, the DCI format 0_3/1_3 can include a valid/non-reserved FDRA value for a cell to schedule PUSCH transmission or PDSCH reception on the cell or can include an invalid/reserved FDRA value for a cell to indicate that the cell is not scheduled. For example, the first cells include cells for which valid/non-reserved FDRA values are indicated by the DCI format 0_3/1_3. For example, the second cells include cells, from the set of cells, with invalid/reserved FDRA values and with the first fields (such as one or more of MCS, NDI, RV, HPN, AP, and so on) repurposed for indicating a UE procedure as previously mentioned. For example, second cells include a cell with smallest cell index among the cells with invalid/reserved FDRA values. For example, second cells can include a cell with smallest cell index among the cells with invalid/reserved FDRA values that provides a largest number of bits for the first DCI field to be repurposed for (implicitly) indicating a UE procedure as previously mentioned. For example, second cells for which the first DCI fields are repurposed can include one cell or more than one cell. For example, the DCI format 0_3/1_3 can invalid/reserved FDRA values for third cells for which the first DCI fields are not repurposed for indicating a UE procedure as previously mentioned. For example, the third cells can include zero, one, or more than one cells.

Various examples in the following refer to cell combinations including the first cells and the second cells as previously described.

Various examples in the following can, alternatively or additionally, apply to cell combinations including the first cells, the second cells, and the third cells as previously described.

Various examples in the following can, alternatively or additionally, apply with “second cells” replaced with “second cells or third cells” or replaced with “second cells and third cells”.

For example, an invalid FDRA value can include:
all ‘0’ bits for resource allocation Type 0, or
all ‘1’ bits for resource allocation Type 1, or
all ‘0’ or all ‘1’ bits for dynamic switch resource allocation type.

For example, an invalid FDRA value can include:
all ‘1’ bits for resource allocation Type 0, or
all ‘0’ bits for resource allocation Type 1, or
all ‘1’ or all ‘0’ bits for dynamic switch resource allocation type.

For example, other reserved FDRA values can be additionally or alternatively considered as invalid values, such as:
a starting ‘0’ bit followed by remaining ‘1’ bits (or a starting ‘1’ bit followed by remaining ‘0’ bits) for resource allocation Type 0, or
a starting ‘1’ bit followed by remaining ‘0’ bits (or a starting ‘0’ bit followed by remaining ‘1’ bits) for resource allocation Type 1, or
all ‘0’ bits for resource allocation Type 2 with numerology index=1, or
all ‘1’ bits for resource allocation Type 2 with numerology index=0, or
all ‘1’ bits for resource allocation Type 0 or for resource allocation Type 2 with numerology index=1, or
all ‘0’ bits for resource allocation Type 1 or for resource allocation Type 2 with numerology index=0, or
all ‘1’ or all ‘0’ bits for dynamic switch resource allocation type, or
a starting ‘0’ bit followed by remaining ‘1’ bits or a starting ‘1’ bit followed by remaining ‘0’ bits for dynamic switch resource allocation type.

There are several approaches for determining HARQ-ACK information values, and placements thereof, corresponding to a DCI format 1_3 that includes invalid/reserved FDRA values for at least one cell from a cell combination indicated by the DCI format 1_3.

In one example, the UE includes only one predetermined HARQ-ACK information bit for all the second cells, regardless of whether the second cells include one cell or multiple cells. For example, the only one predetermined HARQ-ACK information bit is an ACK. For example, the only one predetermined HARQ-ACK information bit corresponds to a cell with smallest cell index among the second cells. Such UE behavior can be to acknowledge the corresponding indication (such as SCell dormancy indication, HARQ-ACK CB retransmission indication, and so on, as previously mentioned). For example, the UE includes NACKs for other cells from the second cells, if any. For example, such NACKs can be appended to NACKs corresponding to the third cells.

In one example, the UE treats both the second cells and the third cells same as non-scheduled cells, and includes NACKs for both the second cells and the third cells, that are appended after HARQ-ACK information bits corresponding to the first cells.

In one example, the UE includes, in a corresponding HARQ-ACK codebook such as Type-1 CB or an (enhanced) Type-2 CB or an (enhanced) Type-3 CB, a predetermined value of HARQ-ACK information bit for each cell form such second cells with such invalid/reserved FDRA values. For example, the predetermined value of HARQ-ACK information bit can be an ACK. For example, the predetermined value of HARQ-ACK information bit can be a NACK.

In one example, the UE includes two predetermined values of HARQ-ACK information bits (such as two ACKs or two NACKs) for a cell from the second cells when the UE is configured two-TB PDSCH reception for the cell (for example, if maxNrofCodeWordsScheduledByDCI is 2 for the serving cell) and the UE is not configured with harq-ACK-SpatialBundlingPUCCH. In one example, the UE includes only one predetermined value of HARQ-ACK information bit (such as one ACK or one NACK) for a/each cell from the second cells regardless of whether the cell is configured one-TB or two-TB PDSCH reception (for example, even if maxNrofCodeWordsScheduledByDCI is 2 for the serving cell and the UE is not configured with harq-ACK-SpatialBundlingPUCCH).

In one example, the UE includes such predetermined values of HARQ-ACK information bits corresponding to the second cells in corresponding order of cell index within the set of cells or within the indicated cell combination. For example, a Type-2 HARQ-ACK CB can include HARQ-ACK information bits for the co-scheduled cells indicated by the DCI format 1_3, including the first cells and the second cells, in ascending order of cell index, followed by a number of NACKs for third cells from the set of cells that are not included in the cell combination indicated by the DCI format 1_3.

In another example, the UE appends such predetermined values of HARQ-ACK information bits corresponding to the second cells and NACKs corresponding to the third cells to HARQ-ACK information bits corresponding to the first cells. For example, such behavior applies at least when the predetermined values of HARQ-ACK information bits corresponding to the second cells are NACKs.

In yet another example, the UE first includes HARQ-ACK information bits corresponding to the first cells, then the predetermined HARQ-ACK information bits corresponding to the second cells, and then NACKs corresponding to the third cells. For example, such behavior applies at least when the predetermined values of HARQ-ACK information bits corresponding to the second cells are ACKs.

There are several approaches for determining a HARQ-ACK sub-codebook (sub-CB), among a first HARQ-ACK sub-CB (corresponding to DCI formats scheduling no cells while triggering HARQ-ACK information or scheduling a single cell) and a second HARQ-ACK sub-CB (corresponding to DCI formats scheduling more than one cells), for including HARQ-ACK information bits corresponding to a DCI format 1_3 that includes invalid/reserved FDRA values for at least one cell from an indicated cell combination by the DCI format 1_3.

In one example, the UE includes HARQ-ACK information corresponding to a DCI format 1_3 in a second sub-CB (corresponding to DCI formats scheduling multiple cells) of a Type-2 HARQ-ACK CB when the DCI format 1_3 indicates:
a cell combination that includes more than one cell; or
valid/non-reserved FDRA values for a first number of cells and invalid/reserved FDRA values for a second number of cells, wherein a summation of the first number and the second number exceeds one (regardless of the actual value of the first number and the second number); or
valid/non-reserved FDRA values for scheduling more than one cell or invalid/reserved FDRA value for more than one (other) cell from the set of cells; or
valid/non-reserved FDRA values for scheduling more than one cell and invalid/reserved FDRA value for zero, one, or more than one other cell from the set of cells; or
valid/non-reserved FDRA values for scheduling at least one cell and invalid/reserved FDRA value for at least one other cell from the set of cells; or
valid/non-reserved FDRA values for no cell from a set of cells and invalid/reserved FDRA values for more than one cell from the set of cells.

For example, the UE includes HARQ-ACK information corresponding to a DCI format 1_3 in the second sub-CB when the DCI format 1_3 schedules PDSCH (with valid/non-reserved FDRA value) on (at least) one cell from a corresponding set of cells. For example, the DCI format can include invalid/reserved FDRA values for one or more cells, such as for repurposing first DCI fields to indicate a certain UE procedure as previously described. Such UE behavior applies at least when the UE uses predetermined ACK(s) corresponding to the one or more cells with invalid/reserved FDRA values when used for implicit indication of certain UE procedures.

For example, a counter/total DAI field in such a DCI format 1_3 is incremented according to a second counter/total DAI value corresponding to second DCI formats that are associated with the second Type-2 HARQ-ACK sub-CB.

In one example, the UE includes HARQ-ACK information corresponding to a DCI format 1_3 in a first sub-CB (corresponding to DCI formats scheduling no cells while triggering HARQ-ACK information or scheduling a single cell) of a Type-2 HARQ-ACK CB when the DCI format 1_3 indicates:
a cell combination that includes (zero or) one cell; or
valid/non-reserved FDRA values for scheduling one cell from a set of cells and invalid/reserved FDRA value for no cell from the set of cells; or
valid/non-reserved FDRA values for scheduling one cell from a set of cells and invalid/reserved FDRA value for one (or more than one) other cell from the set of cells; or
valid/non-reserved FDRA values for no cell from a set of cells and invalid/reserved FDRA values for one cell (or more than one cells) from the set of cells.

For example, the UE includes HARQ-ACK information corresponding to a DCI format 1_3 in the first sub-CB when the DCI format 1_3 schedules PDSCH (with valid/non-reserved FDRA value) on (zero or) one cell from a corresponding set of cells. For example, the DCI format can include invalid/reserved FDRA values for one or more cells, such as for repurposing first DCI fields to indicate a certain UE procedure as previously described. Such UE behavior applies at least when the UE determines predetermined NACK(s) corresponding to the one or more cells with invalid/reserved FDRA values (at least when used for implicit indication of certain UE procedures). In another example, such UE behavior applies even when the UE determines predetermined ACK(s) corresponding to such one or more cells with invalid/reserved FDRA.

For example, a counter/total DAI field in such a DCI format 1_3 is incremented according to a first counter/total DAI value corresponding to first DCI formats that are associated with the first Type-2 HARQ-ACK sub-CB.

For example, when the UE includes HARQ-ACK information corresponding to such DCI format 1_3 in the first sub-CB, the UE does not include any HARQ-ACK information bits, such as predetermined NACK(s) (or predetermined ACK(s)) corresponding to the one or more cells with invalid/reserved FDRA values.

For example, the UE includes HARQ-ACK information bits corresponding to a DCI format 1_3 in a first Type-2 HARQ-ACK sub-CB (corresponding to DCI formats scheduling no cell while triggering HARQ-ACK information, or scheduling one cell) when the DCI format 1_3 includes valid/non-reserved FDRA value for (only) one cell.

For example, the UE includes the predetermined NACK (or ACK) in a second Type-2 HARQ-ACK sub-CB (corresponding to DCI formats scheduling multiple PDSCHs on multiple cells) when a number of cells in a cell combination indicated by a DCI format 1_3 (or a number of cells with valid/non-reserved FDRA value in a DCI format 1_3) is larger than one.

Various methods and examples as previously described are also applicable when a DCI format 0_3/1_3 indicates a cell combination that includes cells that are deactivated or have an active DL/UL BWP that is a dormant BWP, referred to as deactivated/dormant cell, for brevity. For example, the DCI format 0_3/1_3 includes invalid/reserved FDRA values for a deactivated/dormant cell. For example, various UE procedures apply to a deactivated/dormant cell regardless of whether the DCI format 0_3/1_3 includes invalid/reserved FDRA values or valid/non-reserved FDRA values for a deactivated/dormant cell. In another example, fields of a DCI format 0_3/1_3 corresponding to a deactivated/dormant cell are reserved.

For example, the UE generates a predetermined HARQ-ACK information bit such as a NACK (or an ACK) for a PDSCH reception on a deactivated/dormant cell. For example, the UE includes the predetermined NACK (or ACK) in ascending order of cell indexes among the cell combination, or includes the predetermined NACK (or ACK) after HARQ-ACK information bits for co-scheduled cells that are active/activated and have an active DL BWP that is not a dormant BWP (before or along with non-scheduled/non-indicated cells, as previously described).

For example, the UE includes HARQ-ACK information bits corresponding to a DCI format 1_3 in a second sub-CB when the DCI format 1_3 includes valid/non-reserved FDRA values for more than one (activated/non-dormant) cell.

For example, when determining to include HARQ-ACK information bits corresponding to a DCI format 1_3 in a first sub-CB or in a second sub-CB, the UE can count deactivated/dormant cell(s), if any applicable, towards a number of cells in an indicated cell combination (or a number of cells with valid FDRA values). In another example, the UE does not count deactivated/dormant cell(s), if any applicable, towards the number of cells.

For example, the UE includes HARQ-ACK information bits corresponding to a DCI format 1_3 in a second sub-CB when a number of cells with non-predetermined HARQ-ACK information bits is larger than one cell. For example, a predetermined HARQ-ACK information bit includes HARQ-ACK information corresponding to a PDSCH reception on a cell for one or more of the following:
when the PDSCH is on a deactivated/dormant cell, or
when the DCI format 1_3 includes invalid/reserved FDRA values for the cell.

For example, the UE includes HARQ-ACK information bits corresponding to a DCI format 1_3 in the first sub-CB when a number of cells with non-predetermined HARQ-ACK information bits is (only) one cell.

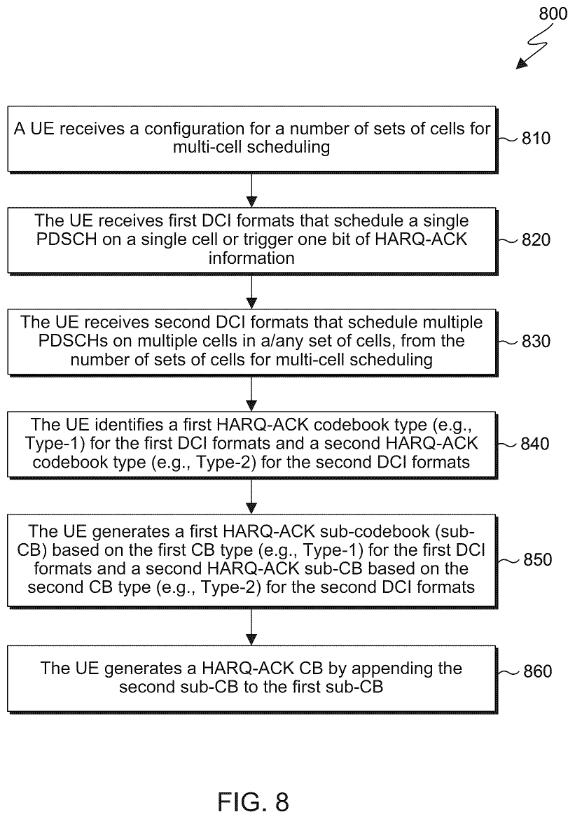

Separate HARQ-ACK codebook types for single-cell scheduling and multi-cell scheduling DCI formats: FIG. 8 illustrates a flow chart of an example UE procedure 800 for generating separate Type-2 HARQ-ACK sub-CBs for single-cell scheduling and for multi-cell scheduling, with different HARQ-ACK codebook types, such as Type-1 for single-cell scheduling and Type-2 for multi-cell scheduling. The procedure 800 may be performed by a UE (e.g., any of the UEs 111-116 as illustrated in FIG. 1). An embodiment of the UE procedure 800 shown in FIG. 8 is for illustration only and does not limit the scope of this disclosure to any particular implementation.

As shown in FIG. 8, the UE procedure 800 begins at step 810, where a UE receives a configuration for a number of sets of cells for multi-cell scheduling. At step 820, the UE receives first DCI formats that schedule a single PDSCH on a single cell or trigger one bit of HARQ-ACK information. At step 830, the UE receives second DCI formats that schedule multiple PDSCHs on multiple cells in a/any set of cells, from the number of sets of cells for multi-cell scheduling. At step 840, the UE identifies a first HARQ-ACK codebook type (e.g., Type-1) for the first DCI formats and a second HARQ-ACK codebook type (e.g., Type-2) for the second DCI formats. At step 850, the UE generates a first HARQ-ACK sub-codebook (sub-CB) based on the first CB type (e.g., Type-1) for the first DCI formats and a second HARQ-ACK sub-CB based on the second CB type (e.g., Type-2) for the second DCI formats. At step 860, the UE generates a HARQ-ACK CB by appending the second sub-CB to the first sub-CB.

In one embodiment, a UE can be configured a first HARQ-ACK codebook type for first DCI formats, such as for a Type-1 codebook for single-cell scheduling DCI formats, and a second HARQ-ACK codebook type for second DCI formats, such as a Type-2 codebook for multi-cell scheduling DCI formats. The UE can transmit a PUCCH or PUSCH that includes only one HARQ-ACK codebook with one HARQ-ACK codebook type, or the UE can concatenate the two HARQ-ACK codebooks that are of different HARQ-ACK codebook and transmit the two codebooks in a same PUSCH or PUCCH.

In one example, the UE can be configured multiple HARQ-ACK codebook types in a PUCCH group, wherein the UE is configured to generate a first HARQ-ACK codebook/sub-codebook according to a first HARQ-ACK codebook type, and a second HARQ-ACK codebook/sub-codebook according to a second HARQ-ACK codebook type. For example, the UE generates a Type-1 HARQ-ACK CB/sub-CB for DCI formats for single-cell scheduling, such as DCI format 1_0/1_1/1_2 (including for self-scheduling), and a Type-2 HARQ-ACK CB/sub-CB for DCI formats for multi-cell scheduling, such as DCI formats 1_3. Such design can be beneficial, for example, since multi-cell scheduling operates based on fast signaling exchange or coordination among, including for DAI values, among different cells, so an operation of Type-2 CB becomes more feasible.

For example, DCI formats that do not schedule a PDSCH (and are used for control purpose) and trigger HARQ-ACK information, such as DCI formats for SPS PDSCH release or CG PUSCH release or SCell dormancy indication, or TCI state indication are predetermined or configured to be included among the first DCI formats, for example, associated with a Type-1 CB/sub-CB (alternatively, Type-2 CB/sub-CB).

For example, DCI formats for multi-cell scheduling such as DCI format 1_3 that schedule only a single PDSCH on a single cell can be predetermined or configured to be included among the first DCI formats, for example, associated with a Type-1 CB/sub-CB (alternatively, Type-2 CB/sub-CB).

In one example, the UE generates a HARQ-ACK codebook by concentering the first HARQ-ACK sub-CB with the first HARQ-ACK codebook type and the second HARQ-ACK sub-CB with the second HARQ-ACK codebook type. Accordingly, the UE provides the HARQ-ACK codebook in a PUCCH or a PUSCH transmission.

In another example, the UE provides only one of the first or the second HARQ-ACK codebook in a PUCCH or PUSCH transmission. For example, the UE is configured by higher layers whether a PUCCH resource is associated with the first HARQ-ACK codebook type or the second HARQ-ACK codebook type. For example, the UE is provided a pattern or mapping among PUCCH resources and the HARQ-ACK codebook types. For example, the UE provides a first HARQ-ACK codebook type in first PUCCH resources and a second HARQ-ACK codebook type in second PUCCH resources. For example, a DL DCI that triggers a PUCCH transmission includes a field (such as a one-bit flag) to indicate whether to provide a first or a second HARQ-ACK codebook type on the PUCCH. For example, an UL DCI that schedules a PUSCH transmission includes a field (such as a one-bit flag) to indicate whether to provide a first or a second HARQ-ACK codebook type on the PUSCH.

Separate spatial bundling type for single-cell scheduling and multi-cell scheduling DCI formats: In one embodiment, a UE can be configured a first information element (IE) providing a first type of spatial bundling of HARQ-ACK information in PUSCH/PUCCH for first DCI formats and a second IE providing a second type of spatial bundling of HARQ-ACK information in PUSCH/PUCCH for second DCI formats. For example, the UE can be configured to provide HARQ-ACK information without spatial bundling for the two TBs of a PDSCH that is scheduled by a single-cell scheduling DCI format, and to provide HARQ-ACK information with spatial bundling for the two TBs of a PDSCH that is scheduled by a multi-cell scheduling DCI format. Such design can be beneficial, for example, to reduce a size of the HARQ-ACK CB.

Number of HARQ-ACK bits for PUCCH power control: In one embodiment, when a UE transmits a PUCCH with a UCI that is no larger than 11 bits, the UE determines a number of HARQ-ACK information bits as n_{HARQ-ACK}=n_{HARQ-ACK,TB}+n_{HARQ-ACK,Multi-Cell}, wherein n_{HARQ-ACK,TB} is based on a number of HARQ-ACK information bits in a first sub-codebook, such as for single-cell scheduling DCI formats, and n_{HARQ-ACK,Multi-Cell} is based on a number of HARQ-ACK information bits in a second sub-codebook, such as for multi-cell scheduling. For example, the UE generates a single Type-2 sub-CB across different sets of cells for multi-cell scheduling, as considered in one or more embodiments herein.

For example, let O_{ACK} denote a number of HARQ-ACK information bits, O_{SR} denote a number of scheduling request (SR) bits, and let O_{CSI} denote a number of CSI report bits. For example, the formula n_{HARQ-ACK}=n_{HARQ-ACK,TB}+n_{HARQ-ACK,Multi-Cell} applies when O_{ACK}+O_{SR}+O_{CSI}≤11.

For example, the following holds for the first Type-2 sub-CB:

$${n}_{HARQ - ACK , TB} = ( ( {V}_{DAI , {m}_{last}}^{DL} - {\sum }_{c = 0}^{{N}_{cells}^{DL} - 1} {U}_{DAI , c} ) mod ( {T}_{D} ) ) {N}_{TB , max}^{DL} + {\sum }_{c = 0}^{{N}_{cells}^{DL} - 1} ( {\sum }_{m = 0}^{M - 1} {N}_{m , c}^{received} + {N}_{SPS , c} ) + {\sum }_{g = 0}^{G - 1} ( ( ( {v}_{DAI , {m}_{last} , g}^{DL} - {\sum }_{c = 0}^{{N}_{cells , g}^{DL} - 1} {U}_{DAI , c , g} ) mod ( {T}_{D , g} ) ) {N}_{TB , max , g}^{DL} + {\sum }_{c = 0}^{{N}_{cells , g}^{DL} - 1} ( {\sum }_{m = 0}^{{M}_{g} - 1} {N}_{m , c , g}^{received} + {N}_{SPS , c , g} ) ) .$$

When multi-cast broadcast service (MBS) is not applicable, the corresponding terms do not contribute to the summation above, so the formula simplifies as follows:

$${n}_{HARQ - ACK , TB} = ( ( {V}_{DAI , {m}_{last}}^{DL} - {\sum }_{c = 0}^{{N}_{cells}^{DL} - 1} {U}_{DAI , c} ) mod ( {T}_{D} ) ) {N}_{TB , max}^{DL} + {\sum }_{c = 0}^{{N}_{cells}^{DL} - 1} ( {\sum }_{m = 0}^{M - 1} {N}_{m , c}^{received} + {N}_{SPS , c} ) ,$$

wherein all terms are defined in [TS 38.213, v17.4.0]. For example, N_{cells}^{DL} is a number of serving cells where the UE is configured to receive unicast PDSCHs (that are scheduled by single-cell or multi-cell scheduling DCI format).

For example, a contribution of the second sub-CB is based on the following:

$${n}_{HARQ - ACK , Multi - Cell} = ( ( {V}_{DAI , {m}_{last}}^{DL} - {\sum }_{s = 0}^{{N}_{sets}^{DL , Multi - Cell} - 1} {U}_{DAI , s}^{Multi - Cell} ) mod ( {T}_{D} ) ) {N}_{HARQ - ACK , max}^{Multi - Cell , max} + {\sum }_{s = 0}^{{N}_{sets}^{DL , Multi - Cell} - 1} {\sum }_{m = 0}^{M - 1} {N}_{m , s}^{received , Multi - Cell} .$$

For example,
If N_{cells}^{DL}=1, V_{DAI,m}_{ₗₐₛₜ}^{DL} is the value of the counter DAI in the last multi-cell scheduling DCI format (such as DCI format 1_3) scheduling more than one PDSCH receptions on more than one cell, from any sets of cells for multi-cell scheduling, that the UE detects within the M PDCCH monitoring occasions; In one example, a configuration of a DCI 1_3 for a set of cells can imply that the UE operates with at leas two cells (for example, N_{cells}^{DL}>1), so the condition N_{cells}^{DL}=1 may not apply.
if N_{cells}^{DL}>1, V_{DAI,m}_{ₗₐₛₜ}^{DL} is the value of the total DAI in the last multi-cell scheduling DCI format (such as DCI format 1_3) scheduling more than one PDSCH receptions on more than one cell, from any sets of cells for multi-cell scheduling, that the UE detects within the M PDCCH monitoring occasions;
V_{DAI,m}_{ₗₐₛₜ}^{DL}=0, if the UE does not detect any multi-cell scheduling DCI format (such as DCI format 1_3) scheduling more than one PDSCH receptions on more than one cell, from any sets of cells for multi-cell scheduling, in any of the M PDCCH monitoring occasions
U_{DAI,s}^{Multi-cell} is the total number of multi-cell scheduling DCI formats (such as DCI format 1_3) scheduling more than one PDSCH receptions on more than one cell in a set s of cells for multi-cell scheduling, from the Nₛₑₜₛ^{DL,Multi-Cell} sets of cells, that the UE detects within the M PDCCH monitoring occasions for the set of cells s. U_{DAI,s}^{Multi-Cell}=0 if the UE does not detect any multi-cell scheduling DCI formats (such as DCI format 1_3) scheduling more than one PDSCH receptions on more than one cell, from a set s of cells for multi-cell scheduling, in any of the M PDCCH monitoring occasions;
   Alternatively, U_{DAI,s}^{Multi-Cell} can be replaced with U_{DAI,c}^{Multi-Cell} that is the total number of multi-cell scheduling DCI formats (such as DCI format 1_3) scheduling more than one PDSCH receptions on respective more than one cells in a set of cells for multi-cell scheduling that has serving cell c as the reference cell, from the N_{Ref-Cells}^{DL,Multi-Cell} reference cells for sets of cells for multi-cell scheduling or from N_{Cells}^{DL} serving across Nₛₑₜₛ^{DL} sets of serving cells in the PUCCH group, that the UE detects within the M PDCCH monitoring occasions for the set of cells with reference cell as cell c. U_{DAI,c}^{Multi-Cell}=0 if the UE does not detect any multi-cell scheduling DCI formats (such as DCI format 1_3) scheduling more than one PDSCH receptions on respective more than one cells, that has serving cell c as the reference cell, in any of the M PDCCH monitoring occasions;
   For example, a reference cell for the more than one cells scheduled/indicated by a DCI 1_3 is a cell with smallest cell index among the more than one cells;
   For example, a reference cell for a set of cells is a corresponding scheduling cell if the scheduling cell is included in the set of cell and the scheduling cell is the only cell in the set of cells with a search space for monitoring multi-cell scheduling DCI format, such as DCI format 0_3/1_3, with unique search space set ID (that is, without a linked search space set having a same search space set ID);
   For example, a reference cell for a set of cells is a cell from the set of cells that is provided a (linked) search space set for monitoring multi-cell scheduling DCI format, such as DCI format 0_3/1_3, and has a same search space set ID as an (original) search space set for monitoring the multi-cell scheduling DCI format on the scheduling cell;
T_{D}=2^{N}^{_{C-DAI}}^{^{DL}} where N_{C-DAI}^{DL} the number of bits for the counter DAI field in unicast DCI formats for multi-cell scheduling (such as DCI format 1_3);
N_{HARQ-ACK,max}^{Multi-Cell,max} is a number of HARQ-ACK information bits that the UE generates in response to detecting a multi-cell scheduling DCI format (such as DCI format 1_3) scheduling more than one PDSCH receptions on more than one cell, from any sets of cells for multi-cell scheduling. For example, N_{HARQ-ACK,max}^{Multi-Cell,max} is a maximum number of TBs across configured cell combinations for any set of cells, from the Nₛₑₜₛ^{DL,Multi-Cell} sets of cells for multi-cell scheduling, such as when spatial bundling of HARQ-ACK information in PUCCH is not enabled; For example, N_{HARQ-ACK,max}^{Multi-Cell,max} is a maximum number of configured cells in any set of cells, from the Nₛₑₜₛ^{DL,Multi-Cell} sets of cells for multi-cell scheduling, such as when spatial bundling of HARQ-ACK information in PUCCH is enabled;
m is an index for a monitoring occasion within the M PDCCH monitoring occasions;
N_{m,s}^{received,Multi-Cell} is a number of transport blocks in PDSCHs that the UE receives in the more than one cells in a set s of cells for multi-cell scheduling, from the Nₛₑₜₛ^{DL,Multi-Cell} sets of cells for multi-cell scheduling, associated with a DCI 1_3 detected in PDCCH monitoring occasion m and the UE reports corresponding HARQ-ACK information in the PUCCH.
   When spatial bundling of HARQ-ACK information in PUCCH is enabled, N_{m,s}^{received,Multi-Cell} refers to “a number of PDSCHs that . . . ” rather than “a number of transport blocks in PDSCHs that . . . ”;
   N_{m,s}^{received, Multi-Cell} can be replaced by N_{m,c}^{received,Multi-Cell} wherein c is an index of a reference cell for the corresponding set of cells or for the corresponding more than one scheduled/indicated cells by a DCI 1_3;

HARQ-ACK generation based on advanced UE capability for multiple MC-DCIs per cell or per set of cells per MO: In one embodiment, when a UE indicates a capability for HARQ-ACK generation based on processing more than one unicast DL MC-DCI 1_3 per cell or per set of cells configured for multi-cell scheduling in a same PDCCH monitoring occasion (MO) or in a same slot of the scheduling cell, the UE counts the cell or the set of serving cells a number N_{MC-DCI}^{MO} times in each PDCCH MO index ‘m’ in a pseudo-code for Type-2 HARQ-ACK codebook generation, wherein N_{MC-DCI}^{MO} is the number of unicast DL MC-DCI 1_3 that the UE can process in a same MO or slot. Accordingly, the cell or the set of serving cells can be checked in the pseudo-code a corresponding number of times for MC-DCIs that can schedule the cell or the set of serving cells in a corresponding PDCCH MO index ‘m’, and the UE can generate a corresponding number of sets of HARQ-ACK information bits if the UE has processed multiple MC-DCIs for the same cell or the same set of cells in the corresponding MO. In an alternative method, the UE counts, in a pseudo-code for Type-2 HARQ-ACK codebook generation, a serving cell c or a set of serving cells s a number N_{MC-DCI,c}^{m} or N_{MC-DCI,s}^{m} times in a given PDCCH MO index ‘m’, wherein N_{MC-DCI,c}^{m} or N_{MC-DCI,s}^{m} is the number of unicast DL MC-DCI formats 1_3 that the UE (actually) receives in the same MO index ‘m’ that each schedule a PDSCH on the serving cell c or each schedule more than one PDSCH receptions on respective more than one serving cells from the set of serving cells s. Accordingly, the corresponding HARQ-ACK bits are ordered first in increasing order of the PDSCH reception starting time for the same {serving cell with smallest index from the respective more than one serving cells, PDCCH monitoring occasion} pair, and second in ascending order of the smallest serving cell index from the respective more than one serving cells.

For example, the UE can indicate, by a new UE capability, such as type2-HARQ-ACK-Codebook-MC-DCI, a support for Type-2 HARQ-ACK codebook generation based on processing more than one unicast DL MC-DCI 1_3 (per cell or) per set of cells configured for multi-cell scheduling in a same PDCCH monitoring occasion (MO) or in a same slot of the scheduling cell. For example, such UE capability type2-HARQ-ACK-Codebook-MC-DCI can be reported per band combination (BC) or per UE. For example, such UE capability type2-HARQ-ACK-Codebook-MC-DCI can have as prerequisite a UE capability for DL multi-cell scheduling (such as FG 49-1) or a UE capability for DL multi-cell scheduling with different/mixed numerology (such as FG 49-1b) or a UE capability for processing more than one unicast MC-DCI (per cell or) per set of cells in a same slot or in N consecutive slots of the scheduling cell (as described further below, herein referred to as Advanced-MC-DCI-processing-r18). For example, the UE can report a support for such UE capability type2-HARQ-ACK-Codebook-MC-DCI separately from a UE capability type2-HARQ-ACK-Codebook (FG 18-9) for Type-2 HARQ-ACK codebook generation based on processing more than one unicast DL SC-DCI 1_0/1_1/1_2 per cell in a same PDCCH MO or in a same slot of the scheduling cell. In another example, the existing UE capability type2-HARQ-ACK-Codebook (FG 18-9) for Type-2 HARQ-ACK codebook generation based on processing more than one unicast DL SC-DCI 1_0/1_1/1_2 per cell in a same PDCCH MO can be re-used to also indicate a UE support for Type-2 HARQ-ACK codebook generation based on processing more than one unicast DL MC-DCI 1_3 per set of cells configured for multi-cell scheduling in a same MO. Various examples methods that are subsequently described may apply when the UE indicated either of the UE capabilities described herein, such as type2-HARQ-ACK-Codebook-MC-DCI or the legacy type2-HARQ-ACK-Codebook.

For example, when the UE indicates a UE capability Advanced-MC-DCI-processing-r18, and does not indicate a UE capability type2-HARQ-ACK-Codebook-MC-DCI or type2-HARQ-ACK-Codebook, the UE expects that the X>1 DCI formats 1_3 in the same MO correspond to different subsets or combinations of cells from a set of cells, or correspond to subset of combinations of cells that have different reference cells (with smallest cell index, such as first DCI 1_3 for cells {1,2} and a second DCI 1_3 for cells {2,3} from a set of cells {1,2,3}). In another example, the UE may still receive multiple DCI formats 1_3 that schedule a same reference cell multiple times, and the UE behavior may not be defined.

In one example, when the UE indicates a UE capability type2-HARQ-ACK-Codebook-MC-DCI, the UE counts a set of serving cells N_{MC-DCI}^{MO} times in each MO. For example, the UE counts a set of serving cells ‘s’ in each MO a number N_{MC-DCI}^{MO} times when the UE indicates the UE capability type2-HARQ-ACK-Codebook-MC-DCI or the UE capability Advanced-MC-DCI-processing-r18 for a band or BC that includes (the cell or) the set of serving cells. For example, when the UE indicates the UE capability type2-HARQ-ACK-Codebook-MC-DCI or the UE capability Advanced-MC-DCI-processing-r18 in a per-UE setting, the UE counts any/all sets of serving cells in each MO a number N_{MC-DCI}^{MO} times.

In another example, when the UE indicates type2-HARQ-ACK-Codebook-MC-DCI, and receives a number N_{MC-DCI,s}^{m}>1 of DCI formats 1_3 in PDCCH receptions at a same PDCCH monitoring occasion m that each schedule more than one PDSCH receptions on respective more than one serving cells from a same set of serving cells MC-DCI-SetofCells (indexed with set index s), the set of serving cells s is counted N_{MC-DCI,s}^{m} times for the PDCCH monitoring occasion m:
first in increasing order of the PDSCH reception starting time for the same {serving cell with smallest index from the respective more than one serving cells, PDCCH monitoring occasion} pair, and
second in ascending order of the smallest serving cell index from the respective more than one serving cells.

In another example, when the UE indicates type2-HARQ-ACK-Codebook-MC-DCI and receives a number N_{PDSCH,c}^{m}>1 of PDSCHs on a serving cell c that are scheduled by DCI formats 1_3 in PDCCH receptions at a same PDCCH monitoring occasion m, wherein each of the DCI formats 1_3 schedule more than one PDSCH receptions on respective more than one serving cells, and c is the smallest cell index among the more than one serving cells, the serving cell c is counted N_{PDSCH,c}^{m} times for PDCCH monitoring occasion m in increasing order of the PDSCH reception starting time among the N_{PDSCH,c}^{m} PDSCHs.

The corresponding HARQ-ACK information bits are placed according to the above ordering in the Type-2 HARQ-ACK codebook or corresponding sub-codebook.

For example, among MC-DCIs in received the MO index m that schedule respective cell combinations with same cell having smallest cell index among the respective cell combination:
first HARQ-ACK bits corresponding to a first MC-DCI with earlier starting time for PDSCH reception on the cell with the smallest cell index are placed before;
second HARQ-ACK bits corresponding to a second MC-DCI with a later/next earlier starting time for PDSCH reception on the cell with the smallest cell index.

For example, among MC-DCIs in received the MO index m:
first HARQ-ACK bits corresponding to first MC-DCI(s) that schedule first more than one PDSCH receptions on respective first more than one cells having a first cell as smallest cell index among the respective first more than one cells are placed before
second HARQ-ACK bits corresponding to second MC-DCI(s) that schedule second more than one PDSCH receptions on respective second more than one cells having a second cell as smallest cell index among the respective first more than one cells, when the first cell has a smaller cell index than the second cell.

An example specification text to capture such UE behavior can be as follows:

```
Set N_{cells,set}^{DL,max} to the maximum number of serving cells in ScheduledCell-ListDCI-1-3 of a set of
      serving cells provided by MC-DCI-SetofCells, across the number of sets of serving cells,
      that can be scheduled PDSCH receptions by DCI format 1_3
Set Nₛₑₜₛ^{TB,max} to the maximum total number of TBs in PDSCH receptions that can be scheduled
      by a DCI format 1_3 over more than one serving cells in a set of serving cells across the
      number of sets of serving cells
Set Nₛₑₜₛ^{DL} to the number of sets of serving cells MC-DCI-SetofCells in a PUCCH group
Set N_{cells}^{DL} to the number of serving cells, across Nₛₑₜₛ^{DL} sets of serving cells in the PUCCH group
Set c to the index of serving cells, c = 0, ... , N_{cells}^{DL} − 1, a lower index corresponds to a lower
    RRC index of a corresponding serving cell
  - [Alt-1] if the UE indicates type2-HARQ-ACK-Codebook-MC-DCI, a set of serving cells
        MC-DCI-SetofCells is counted N_{MC-DCI}^{MO} times where N_{MC-DCI}^{MO} is the number of DCI
        formats 1_3 in PDCCH receptions at a same PDCCH monitoring occasion (corresponding
        to the set of serving cells) based on the reported value of Advacned-PDCCH-MC-DCI-
        processing-r18
  - [Alt-2] if the UE indicates type2-HARQ-ACK-Codebook-MC-DCI, and receives a number
        N_{MC-DCI,s}^{m} > 1 of DCI formats 1_3 in PDCCH receptions at a same PDCCH monitoring
        occasion m that each schedule more than one PDSCH receptions on respective more than
        one serving cells from a same set of serving cells MC-DCI-SetofCells (indexed with set
        index s), the set of serving cells s is counted N_{MC-DCI,s}^{m} times for the PDCCH monitoring
        occasion m first in increasing order of the PDSCH reception starting time for the same
        {serving cell with smallest index from the respective more than one serving cells, PDCCH
        monitoring occasion} pair, and second in in ascending order of the smallest serving cell
        index from the respective more than one serving cells
    - [Alt-3] if the UE indicates type2-HARQ-ACK-Codebook-MC-DCI, and receives a
          number N_{PDSCH,c}^{m} > 1 of PDSCHs on a serving cell c that are scheduled by DCI formats
          1_3 in PDCCH receptions at a same PDCCH monitoring occasion m, wherein each of
          the DCI formats 1_3 schedule more than one PDSCH receptions on respective more than
          one serving cells, and c is the smallest cell index among the more than one serving cells,
          the serving cell c is counted N_{PDSCH,c}^{m} times for PDCCH monitoring occasion m in
          increasing order of the PDSCH reception starting time among the N_{PDSCH,c}^{m} PDSCHs
Set mc to the index of a serving cell, in a set of indexes of serving cells arranged in ascending
      order, from the set of N_{cells,set}^{DL,max} serving cells, mc = 0, ... , N_{cells,set}^{DL,max} − 1
Set m = 0 − PDCCH monitoring occasion index for detection of a DCI format 1_3 scheduling
      PDSCH receptions on serving cells from a set of serving cells: lower index corresponds to
      earlier PDCCH monitoring occasion
  Set j = 0
  Set Vₜₑₘₚ = 0
  Set Vₜₑₘₚ₂ = 0
  Set Vₛ = Ø
  Set M to the number of PDCCH monitoring occasions
  while m < M
      c = 0
      if harq-ACK-SpatialBundlingPUCCH is not provided,
            while c < N_{cells}^{DL}
```

*** < Unchanged parts are omitted > ***

In one example, the sentence “if the UE indicates type2-HARQ-ACK-Codebook-MC-DCI . . . , a set of serving cells MC-DCI-SetofCells is counted . . . ” can be replaced by “if the UE indicates type2-HARQ-ACK-Codebook-MC-DCI for a set of serving cells MC-DCI-SetofCells . . . , the set of serving cells MC-DCI-SetofCells is counted . . . ”, for example, when the UE reports the UE capability per band or per BC, so that the UE behavior applies only to bands or BCs where the UE has indicated the support for the corresponding UE capability.

In one example, the UE capability type2-HARQ-ACK-Codebook-MC-DCI or counting of a set of serving cells in each MO a number N_{MC-DCI}^{MO} or N_{MC-DCI,s}^{m} times can be based on a (maximum) number of PDSCH receptions that can be scheduled on at least one cell from the set of cells or on all cells in the set of serving cells using (more than one) MC-DCI formats 1_3 in (more than one) PDCCHs in a corresponding same PDCCH MO. For example, the parameter N_{MC_DCI}^{MO} can be referred to as/replaced by parameter N_{PDSCH}^{MO}.

In one example, above methods and examples apply to a second Type-2 HARQ-ACK sub-codebook (sub-CB) that the UE determines in association with MC-DCI formats 1_3 that schedule more than one PDSCHs on respective more than one serving cells from a set of cells configured for multi-cell scheduling.

In another example, similar methods and examples above can apply to a first Type-2 HARQ-ACK sub-codebook (sub-CB) that the UE determines in association with unicast SPS PDSCH receptions or with any unicast DCI format scheduling PDSCH reception on a single serving cell, or having associated HARQ-ACK information without scheduling a PDSCH reception. For example, when the UE indicates a UE capability type2-HARQ-ACK-Codebook-MC-DCI, the UE counts a serving cell ‘c’ in each MO a number N_{MC-DCI}^{MO} times. For example, the MC-DCI format 1_3 can schedule a single serving cell up to N_{MC-DCI}^{MO} times in a same MO. In another example, a (legacy) UE capability type2-HARQ-ACK-Codebook-r16 can be modified so that it includes MC-DCI format 1_3 as well.

In one example, for a UE that is capable of multi-cell scheduling, the UE can report a capability for a number of unicast DCI formats that the UE can process per slot or per a number of consecutive slots. A unicast DCI format can be a single-cell scheduling DCI (SC-DCI) format such as DCI format 0_0/1_0/0_1/1_1/0_2/1_2 or a multi-cell scheduling DCI (MC-DCI) format 0_3/1_3. There can be various options in terms of processing only one of MC-DCI or SC-DCI or both of them, and also in terms of counting the processed unicast DCI formats per scheduled cell or per set of cells for multi-cell scheduling.

In one option, the UE capability can be to process 1 (or 2) unicast DCI formats (SC-DCI or MC-DCI) per set of cells for multi-cell scheduling (for example, 1 unicast DCI scheduling DL, or 1 unicast DCI scheduling UL for FDD scheduling cell, or 2 unicast DCIs scheduling UL for TDD scheduling cell).

In another option, the UE capability can be to process either 1 (or 2) unicast MC-DCI formats per set of cells, or 1 (or 2) unicast SC-DCI formats per scheduled cell (in the set of cells). For example, when the UE detects a DL MC-DCI format 1_3 in a slot for a set of cells, the UE does not need to detect any DL SC-DCI for any cell in the set of cells in that slot (when scheduling cell has an SCS that is smaller than or equal to an SCS of the set of cells). For example, when the UE does not detect a DL MC-DCI format 1_3 in a slot for a set of cells, the UE capability can be to process 1 DL SC-DCI for each cell in the set of cells in that slot. For example, the UE capability can be processing either 1 UL MC-DCI for a set of cells for multi-cell scheduling in a slot, otherwise 1 UL SC-DCI for each cell from the set of cells in the slot, for FDD scheduling cell. For example, the UE capability can be processing either 2 UL MC-DCI for a set of cells for multi-cell scheduling in a slot, otherwise 2 UL SC-DCIs for each cell from the set of cells in the slot, for TDD scheduling cell.

In another option, the UE capability can be to process 1 (or 2) unicast DCI formats (SC-DCI or MC-DCI) for a reference cell of a set of cells for multi-cell scheduling, and also process 1 (or 2) unicast SC-DCI formats for each non-reference cell from the set of cells.

In yet another option, the UE capability can be to process 1 (or 2) unicast MC-DCI formats per set of cells and also processes 1 (or 2) unicast SC-DCI formats per scheduled cell (in the set of cells).

In various options, the number of unicast MC-DCI/SC-DCI are per slot of scheduling cell when the scheduling cell has an SCS configuration that is smaller than or equal to an SCS configuration of the set of cells, or are per N consecutive slots of the scheduling cell when the scheduling cell has an SCS configuration that is N times larger than (e.g., N=2, 4, 8, . . . ) an SCS configuration of the set of cells.

In yet another option, the UE capability can be to process 1 (or 2) unicast DCI (MC-DCI or SC-DCI) per set of cells when the UE is configured to monitor a PDCCH for MC-DCI in the 1 slot or N consecutive slots of the scheduling cell, and UE can process 1 (or 2) unicast SC-DCI per scheduled cell (in the set of cells) when the UE is not configured to monitor a PDCCH for MC-DCI in the 1 slot or N consecutive slots of the scheduling cell.

In a further option, the UE capability can be to process 1 (or 2) unicast MC-DCI per set of cells per 1 slot or per N consecutive slots of the scheduling cell, and to process 1 (or 2) unicast SC-DCI for each cell from the set of cells that is not scheduled by the MC-DCI in the 1 or N slots.

In one example, the above options for processing MC-DCI and SC-DCI can be conditioned on the UE supporting both a first UE capability for MC-DCI processing and also a second UE capability for SC-DCI processing. For example, for a UE that reports a first UE capability only for MC-DCI processing and does not report a second UE capability for SC-DCI processing, the first UE capability can be to process 1 (or 2) unicast MC-DCIs per set of cells per 1 slot or per N consecutive slots of the scheduling cell and no processing of any SC-DCI for any cell from the set of cells. In another example, the UE capability can be to process 1 (or 2) unicast MC-DCIs per set of cells per 1 slot or per N consecutive slots of the scheduling cell and no processing of any SC-DCI for any cell from the set of cells (regardless of support or no support for a second UE capability for SC-DCI processing).

In one example, a UE capability for processing both MC-DCI and SC-DCI can be restricted to certain cells, and no SC-DCI processing may be supported for other cells in the set of cells. For example, the UE capability can be to process one or both of 1 (or 2) MC-DCI per set of cells and/or 1 (or 2)SC-DCI for one or more of a primary cell (PCell) or a PSCell or an sPCell or a PUCCH-SCell or a secondary PUCCH-SCell or a scheduling cell of the set of cells, or a reference cell of the set of cells (as described earlier) per 1 slot or per N consecutive slots of the scheduling cell, while for other cells in the set of cells, the UE is not expected to process any SC-DCI in the 1 or N slots. For example, the UE does not process SC-DCI for such other cells regardless of whether or not the MC-DCI schedules a PDSCH/PUSCH on any cell from such other cells. For example, the UE processes 1 (or) unicast SC-DCI for each cell from the one or more of a primary cell (PCell) or a PSCell or an sPCell or a PUCCH-SCell or a secondary PUCCH-SCell or a scheduling cell of the set of cells, or a reference cell of the set of cells when the cell is not scheduled by the MC-DCI in the 1 or N slots.

In one example, the UE capability for processing SC-DCI in addition to/in parallel with MC-DCI can be restricted to certain DCI formats or certain RNTI. For example, a unicast SC-DCI in above options and examples can refer (only) to DCI format 0_0/1_0, or (only) to DCI format 0_1/1_1, or (only) for SC-DCI formats with CRC scrambled by one or more of: SI-RNTI, RA-RNTI, P-RNTI, CS-RNTI, TC-RNTI, MsgB-RNTI, SP-CSI-RNTI, and so on.

In various options, the number “1 (or 2)” unicast SC-DCI/MC-DCI refers, for example, to 1 DCI scheduling DL, or 1 DCI scheduling UL from an FDD scheduling cell, or 2 DCIs scheduling UL from a TDD scheduling cell. In various options, separate (advanced) UE capabilities can be defined by replacing the number “1 (or 2)” with a number X, where X can have a value set such as {2} or {2, 4} or {2, 4, 6} or {2, 4, 8}, or {2, 4, 6, 8}, or {1, 2}, {1, 2, 4} or {1, 2, 4, 8}, {1, 2, 4, 6} or {1, 2, 4, 6, 8}. For example, parameter X for the advanced UE capabilities can be defined in terms of a parameter N that is the SCS ratio between the SCS of the scheduling cell and the SCS of the set of co-scheduled cells. For example, parameter X can take value from a value set {1, 2¹, 2², . . . , N} where N=2^{μ}^{₁}^{-μ}^{₂} with μ₁ and μ₂ corresponding to SCS configurations of the (active BWPs) of the set of co-scheduled cells and the scheduling cell, respectively (or vice versa). For example, the advanced UE capability can be applicable (only) for the low-to-high SCS scenario, wherein the SCS configuration of the scheduling cell is smaller than or equal to an SCS configuration for the set of cells for multi-cell scheduling. For example, parameter X for the advanced UE capabilities can be defined in terms of a (maximum) number of cells in the set of cells. For example, parameter X can take value from a value set {1, 2, 3, 4} or a value set {1, 2, . . . , M} where M is a maximum number of cells in a set of cells that is supported by the UE or a maximum number of co-scheduled cells by an MC-DCI format 0_3/1_3 that is supported by the UE (for a corresponding band or band combination). In one example, a value set of X can be based on both the SCS ratio and the number of co-scheduled cells, so that parameter X can take value from a value set {1, 2¹, 2², . . . , N}×{1, 2, 3, 4} or {1, 2¹, 2², . . . , N}×{1, 2, . . . , M}, where M is as defined earlier, and operation ‘x’ refers to cartesian product of two sets of cells. In one example, value 1 can be excluded from the above value sets, and only values>1 can be reported.

In one example, the advanced UE capabilities can be defined with certain restrictions. For example, the value X only refers to a number of unicast MC-DCI per set of cells per 1 or N consecutive slots, and does not apply to a number of unicast SC-DCIs in the 1 or N slots that the UE can process. For example, the UE does not processes any unicast SC-DCI for any cell from the set of cells in the 1 or N slots, or the UE can process only 1 (or 2) unicast SC-DCI in the 1 or N slots for each cell from the set of cells or for each cell from the set of cells that is not scheduled by any of the X unicast MC-DCIs, or for each cell from the one or more of a primary cell (PCell) or a PSCell or an sPCell or a PUCCH-SCell or a secondary PUCCH-SCell or a scheduling cell of the set of cells, or a reference cell of the set of cells, and so on. For example, the UE can process more than 1 (or 2) unicast SC-DCIs in the 1 or N slots for a cell (as described above) when the UE separately report an Advanced capability for processing multiple SC-DCIs in 1 or N slots.

In one example, the X unicast MC-DCIs in 1 or N slots can be for separate cell combinations/subsets from the set of cells, while in another example, the X unicast MC-DCIs in 1 or N slots can be for overlapping or identical cell combinations/subsets from the set of cells.

In one example, the Advanced UE capability for MC-DCI can be based on a maximum number of PDSCHs/PUSCHs that can be scheduled on a same cell per 1 slot or N consecutive slots using one or more MC-DCIs. For example, the UE capability can be to process Y unicast MC-DCI formats per 1 slot or N slots wherein the Y MC-DCI formats can be such that any cell from the set of cells can be scheduled up to X PDSCHs/PUSCHs per 1 slot or N consecutive slots. For example, Y≥X. For example, the value Y may not be reported by the UE and can be up to gNB scheduling or configuration implementation. For example, when the set of cells includes cells {1, 2, 3, 4} and UE reports X=2, the UE can process all of the following MC-DCI formats: a first MC-DCI format scheduling cells {1, 2, 3}, a second MC-DCI scheduling cells {1, 2, 4}, and a third MC-DCI format scheduling cells {3, 4}, so that Y=3; alternatively, the UE can process all of the following MC-DCI formats: a first MC-DCI scheduling cells {1, 2}, a second MC-DCI scheduling cells {2, 3}, a third MC-DCI scheduling cells {3, 4}, and a fourth MC-DCI scheduling cells {1, 4}, so that Y=4.

For example, a UE feature group (FG) 49-1 can refer to a UE capability for DL multi-cell scheduling via DCI format 1_3 when the scheduling cell has same SCS configuration as the set of cells for multi-cell scheduling. For example, FG 49-1b can refer to a UE capability for DL multi-cell scheduling via DCI format 1_3 when the scheduling cell has different SCS configuration than the set of cells for multi-cell scheduling. For example, FG 49-2 can refer to a UE capability for UL multi-cell scheduling via DCI format 0_3 when the scheduling cell has same SCS configuration as the set of cells for multi-cell scheduling. For example, FG 49-2b can refer to a UE capability for UL multi-cell scheduling via DCI format 0_3 when the scheduling cell has different SCS configuration than the set of cells for multi-cell scheduling.

For example, a component in FG 49-1 can be for a number of unicast DCI formats that the UE can process:
One unicast DCI (SC-DCI or MC-DCI) for scheduling DL per slot per reference cell of a set of cells configured for multi-cell scheduling & one unicast SC-DCI for scheduling DL per slot per non-reference cell of the set of cells, for FDD/TDD scheduling cell;

For example, a component in FG 49-2 can be for a number of unicast DCI formats that the UE can process:
One unicast DCI (SC-DCI or MC-DCI) for scheduling UL per slot per reference cell of a set of cells configured for multi-cell scheduling & one unicast SC-DCI for scheduling UL per slot per non-reference cell of the set of cells, for FDD scheduling cell;
Two unicast DCIs (SC-DCI or MC-DCI) for scheduling UL per slot per reference cell of a set of cells configured for multi-cell scheduling & two unicast SC-DCIs for scheduling UL per slot per non-reference cell of the set of cells, for TDD scheduling cell;

For example, a component in FG 49-1b can be for a number of unicast DCI formats that the UE can process:
For low-to-high SCS:
   One unicast DCI (SC-DCI or MC-DCI) for scheduling DL per slot of scheduling cell per reference cell of a set of cells configured for multi-cell scheduling & one unicast SC-DCI for scheduling DL per slot of scheduling cell per non-reference cell of the set of cells, for FDD/TDD scheduling cell;
For high-to-low SCS:
   One unicast DCI (SC-DCI or MC-DCI) for scheduling DL per N consecutive slots of scheduling cell per reference cell of a set of cells configured for multi-cell scheduling & one unicast SC-DCI for scheduling DL per N consecutive slots of scheduling cell per non-reference cell of the set of cells, for FDD/TDD scheduling cell;
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, a component in FG 49-2b can be for a number of unicast DCI formats that the UE can process:
For low-to-high SCS:
   One unicast DCI (SC-DCI or MC-DCI) for scheduling UL per slot of scheduling cell per reference cell of a set of cells configured for multi-cell scheduling & one unicast SC-DCI for scheduling UL per slot of scheduling cell per non-reference cell of the set of cells, for FDD scheduling cell;
   Two unicast DCIs (SC-DCI or MC-DCI) for scheduling UL per slot of scheduling cell per reference cell of a set of cells configured for multi-cell scheduling & two unicast SC-DCIs for scheduling UL per slot of scheduling cell per non-reference cell of the set of cells, for TDD scheduling cell;
For high-to-low SCS:
   One unicast DCI (SC-DCI or MC-DCI) for scheduling UL per N consecutive slots of scheduling cell per reference cell of a set of cells configured for multi-cell scheduling & one unicast SC-DCI for scheduling UL per N consecutive slots of scheduling cell per non-reference cell of the set of cells, for FDD scheduling cell;
   Two unicast DCIs (SC-DCI or MC-DCI) for scheduling UL per N consecutive slots of scheduling cell per reference cell of a set of cells configured for multi-cell scheduling & two unicast SC-DCIs for scheduling UL per N consecutive slots of scheduling cell per non-reference cell of the set of cells, for TDD scheduling cell;
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, a component in FG 49-1 (same SCS) for a baseline UE capability for a number of unicast DL DCI formats that the UE can process can be as follows:
The number of unicast DL DCI to process for each cell in a set of cells configured for multi-cell PDSCH scheduling by a DCI format 1_3
   One unicast DCI per slot of scheduling cell for each cell in the set of cells for FDD/TDD scheduling cell
The unicast DCI can be either a legacy DCI format or a DCI format 1_3
A DCI format 1_3 can schedule more than one cell from the set of cells

For example, a component in FG 49-2 (same SCS) for a baseline UE capability for a number of unicast UL DCI formats that the UE can process can be as follows:
The number of unicast UL DCI to process for each cell in a set of cells configured for multi-cell PUSCH scheduling by a DCI format 0_3
   One unicast DCI per slot of scheduling cell for each cell in the set of cells for FDD scheduling cell
   Two unicast DCI per slot of scheduling cell for each cell in the set of cells for TDD scheduling cell
unicast DCI can be either a legacy DCI format or a DCI format 0_3
A DCI format 0_3 can schedule more than one cell from the set of cells

For example, a component in FG 49-1b (different SCS) for a baseline UE capability for a number of unicast DL DCI formats that the UE can process can be as follows:
For low-to-high SCS:
   One unicast DCI per slot of scheduling cell for each cell in the set of cells for FDD/TDD scheduling cell
For high-to-low SCS:
   One unicast DCI per N consecutive slots of scheduling cell for each cell in the set of cell for FDD/TDD scheduling cell
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).
unicast DCI can be either a legacy DCI format or a DCI format 1_3
A same DCI format 1_3 can schedule more than one cell from the set of cells

For example, a component in FG 49-2b (different SCS) for a baseline UE capability for a number of unicast UL DCI formats that the UE can process can be as follows:
For low-to-high SCS:
   The number of unicast UL DCI to process for each cell in a set of cells configured for multi-cell PUSCH scheduling by a DCI format 0_3
      One unicast DCI per slot of scheduling cell for each cell in the set of cells for FDD scheduling cell
      Two unicast DCI per slot of scheduling cell for each cell in the set of cells for TDD scheduling cell
For high-to-low SCS:
   The number of unicast UL DCI to process for each cell in a set of cells configured for multi-cell PUSCH scheduling by a DCI format 0_3
      One unicast DCI per N consecutive slots of scheduling cell for each cell in the set of cells for FDD scheduling cell
      Two unicast DCI per N consecutive slots of scheduling cell for each cell in the set of cells for TDD scheduling cell
      N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).
   The unicast DCI can be either a legacy DCI format or a DCI format 0_3
   A same DCI format 0_3 can schedule more than one cell from the set of cells

HARQ-ACK skipping in case of BWP change: In one embodiment, when a UE is provided an MC-DCI format 1_3 in a PDCCH, and the MC-DCI format 1_3 schedules first PDSCHs on first cells from a set of cells, and the UE receives the PDCCH in a monitoring occasion (MO)/slot that is before a BWP change event, the UE can skip the HARQ-ACK information corresponding to one or more or all PDSCHs from the first PDSCHs. Herein, the BWP change event can include change for one or more of: an active DL BWP of a cell from the first cells, an active DL BWP of a cell from the set of cells, active DL BWPs of all cells from the first cells, active DL BWPs of all cells from the set of cells, active UL BWP of PCell or PSCell or PUCCH-SCell or secondary PUCCH-SCell (sPUCCH-SCell). For example, the UE can skip the HARQ-ACK information corresponding to the cell with a change of the active DL BWP. For example, the UE can skip the HARQ-ACK information for all cells from the first (co-scheduled) cells when there is a change of active DL BWP for each cell from the first cells or when there is a change of active DL BWP for at least one cell from the first cells. When the UE skips the HARQ-ACK information associated with such MC-DCI for the entire set of cells is skipped, in one example, the UE generates a corresponding number of NACKs that are appended at the end of the second HARQ-ACK sub-codebook, as for missed MC-DCI formats. In another example, the UE does not generate any HARQ-ACK information for such MC-DCI.

In one example, HARQ-ACK information associated with such MC-DCI for the entire set of cells is skipped in case of (i) active DL BWP change for at least one cell from the set of cells for multi-cell scheduling; or (ii) active UL BWP change for the PCell/PUCCH-SCell. This example can be implemented in the specifications using a text such as that provided in TP #1 below.

In another example, HARQ-ACK information for the entire set of cells is skipped in case of (i) active DL BWP change for at least one cell from the co-scheduled cells by the MC-DCI format 1_3 that is provided in the PDCCH MO of interest; or (ii) active UL BWP change for the PCell/PUCCH-SCell. This example can be implemented in the specifications using a text such as that provided in TP #2 below.

In another example, HARQ-ACK information associated with such MC-DCI for the entire set of cells is skipped in case of (i) active DL BWP change for all cells from the set of cells for multi-cell scheduling; or (ii) active UL BWP change for the PCell/PUCCH-SCell.

In another example, HARQ-ACK information associated with such MC-DCI for the entire set of cells is skipped in case of (i) active DL BWP change for all cells from the co-scheduled cells by the MC-DCI format 1_3 that is provided in the PDCCH MO of interest; or (ii) active UL BWP change for the PCell/PUCCH-SCell.

In yet another example, HARQ-ACK information associated with such MC-DCI for the entire set of cells is skipped only in case of active UL BWP change for the PCell/PUCCH-SCell. For example, in case of active DL BWP change for one or more cells from the set of cells or from the co-scheduled cells, only HARQ-ACK information for the corresponding one or more cell is skipped (e.g., a NACK value is provided). For example, such NACK values are included as padding bits at the end of the same block of HARQ-ACK information corresponding to the same MC-DCI, as for other cells from the corresponding set of cells that are not scheduled by that MC-DCI. For example, the HARQ-ACK information associated with such MC-DCI are provided in the second HARQ-ACK sub-codebook in bit locations associated with the counter DAI in the MC-DCI. For example, such HARQ-ACK information is not relegated to the end of the second HARQ-ACK sub-codebook, as for missed MC-DCI formats. This example can be implemented in the specifications using a text such as that provided in TP #3 below.

A different example specification text is provided in TP #3A below, where elements from (a variation of) TP #2 is combined with TP #3. For example, HARQ-ACK information for the entire set of cells is skipped (that is, NACKs appended at the end of the codebook or fully dropped) in case of (i) active DL BWP change for all of the co-scheduled cells by the MC-DCI format 1_3 that is provided in the PDCCH MO of interest; or (ii) active UL BWP change for the PCell/PUCCH-SCell. According to TP #3A, in case of active DL BWP change for only one or some (but not all) of the co-scheduled cells by that DCI format 13, only the corresponding HARQ-ACK information bits are skipped (that is, NACKs appended at the end of the HARQ-ACK information block corresponding to that DCI format 13, as for non-scheduled cells).

In a further example, HARQ-ACK skipping due to BWP change is not on the level of a set of serving cells, rather applies to serving cells individually. For example, an active UL BWP change for the PCell/PUCCH-SCell is also considered as part of event for HARQ-ACK skipping for a serving cell along with a change of active DL BWP on the serving cell. This example can be implemented in the specifications using a text such as that provided in TP #4 below.

In various examples, such as examples above, HARQ-ACK skipping for all cells or for one/some cells due to an active DL BWP change for the all cells or one/some cells, applies when the corresponding PDSCH receptions are after the same active DL BWP change. For example, when both PDCCH and the corresponding PDSCH are before the active DL BWP for a cell, the UE does not skip the corresponding HARQ-ACK information.

Several example specifications texts are as follows with respect to [TS 38.213 v.17.6.0] or with respect to draft [TS 38.213, v18.0.0].

A first example text (labeled as TP #1) is as follows:

```
Set Nₛₑₜₛ^{TB,max} to the maximum total number of TBs in PDSCH receptions that can be
  scheduled by a DCI format 1_3 over more than one serving cells in a set of serving cells
  across the number of sets of serving cells
Set Nₛₑₜₛ^{DL} to the number of sets of serving cells MC-DCI-SetofCells in a PUCCH group
Set N_{cells}^{DL} to the number of serving cells, across Nₛₑₜₛ^{DL} sets of serving cells in the
  PUCCH group
Set c to the index of serving cells, c = 0, ... , N_{cells}^{DL} − 1, a lower index corresponds to a
  lower RRC index of a corresponding serving cell
Set mc to the index of a serving cell, in a set of indexes of serving cells arranged in
ascending order, from the set of N_{cells,set}^{DL,max} serving cells, mc = 0, ... , N_{cells,set}^{DL,max} − 1
Set m = 0 − PDCCH monitoring occasion index for detection of a DCI format 1_3
  scheduling PDSCH receptions on serving cells from a set of serving cells: lower index
  corresponds to earlier PDCCH monitoring occasion
Set j = 0
Set Vₜₑₘₚ = 0
Set Vₜₑₘₚ₂ = 0
Set Vₛ = Ø
Set M to the number of PDCCH monitoring occasions
while m < M
  c = 0
  if harq-ACK-SpatialBundlingPUCCH is not provided,
    while c < N_{cells}^{DL}
      if PDCCH monitoring occasion m is before an active DL BWP change on any / at
      least one serving cell from a set of serving cells that includes serving cell c or an
      active UL BWP change on the serving cell of PUCCH transmission if the UE is
      provided pucch-sSCellDyn or pucch-sSCellDynDCI-1-2, or an active UL BWP
      change on the PCell if the UE is not provided pucch-sSCellDyn and pucch-
      sSCellDynDCI-1-2, and an active DL BWP change is not triggered in PDCCH
      monitoring occasion m
        c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells where the DCI format is associated with a PDCCH
        reception in PDCCH monitoring occasion m and c is the smallest serving cell
        index among the more than one serving cells
          if V_{C-DAI,c,m}^{DL} ≤ Vₜₑₘₚ
            j = j + 1;
*** <Unchanged parts are omitted> ***
        end if
        s = s + 1;
      end if
    end while
  else
    while c < N_{cells}^{DL}
      if PDCCH monitoring occasion m is before an active DL BWP change on any / at
      least one serving cell from a set of serving cells that includes serving cell c or an
      active UL BWP change on the serving cell of PUCCH transmission if the UE is
      provided pucch-sSCellDyn or pucch-sSCellDynDCI-1-2, or an active UL BWP
      change on the PCell if the UE is not provided pucch-sSCellDyn and pucch-
      sSCellDynDCI-1-2, and an active DL BWP change is not triggered in PDCCH
      monitoring occasion m
        c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells , where the DCI format is associated with a PDCCH
        reception in PDCCH monitoring occasion m and c is the smallest serving cell
        index among the more than one serving cells
          if V_{C-DAI,c,m}^{DL} ≤ Vₜₑₘₚ
            j = j + 1;
                *** <Unchanged parts are omitted> ***
        end if
        c = c + 1;
      end if
    end while
    end if
    m = m + 1;
  end while
  ${V}_{temp} = ( j mod ( \frac{4}{{T}_{D}} ) ) \times ( \frac{4}{{T}_{D}} ) + {V}_{temp} ;$
  if UE does not set Vₜₑₘₚ₂ = V_{T-DAI}^{UL,s} and T_{D} = 2
    Vₜₑₘₚ₂ = Vₜₑₘₚ;
  end if
  $j = ⌊ \frac{j \times {T}_{D}}{4} ⌋ ;$
  if Vₜₑₘₚ₂ < Vₜₑₘₚ
    j = j + 1;
  end if
  if harq-ACK-SpatialBundlingPUCCH is not provided,
    O^{ACK} = Nₛₑₜₛ^{TB,max} · (4 · j + Vₜₑₘₚ₂)
  else
    O^{ACK} = N_{cells,set}^{DL,max} · (4 · j + Vₜₑₘₚ₂)
  end if
õᵢ^{ACK} = NACK for any i ∈ {0,1, ... , O^{ACK} − 1}\Vₛ .
```

Another example specifications text (labeled as TP #2) can be as follows (with more repeated text omitted herein):

*** <Unchanged parts are omitted> ***

```
Set M to the number of PDCCH monitoring occasions
while m < M
  c = 0
  if harq-ACK-SpatialBundlingPUCCH is not provided,
    while c < N_{cells}^{DL}
      if PDCCH monitoring occasion m is before an active DL BWP change on any / at
      least one serving cell from more than one serving cells, from a set of serving cells
      that includes serving cell c, on which respective more than one PDSCHs are
      scheduled by a DCI format 1_3 that is provided in a PDCCH in the PDCCH
      monitoring occasion m or an active UL BWP change on the serving cell of
      PUCCH transmission if the UE is provided pucch-sSCellDyn or pucch-
      sSCellDynDCI-1-2, or an active UL BWP change on the PCell if the UE is not
      provided pucch-sSCellDyn and pucch-sSCellDynDCI-1-2, and an active DL BWP
      change is not triggered in PDCCH monitoring occasion m
        c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells where the DCI format is associated with a PDCCH
        reception in PDCCH monitoring occasion m and c is the smallest serving cell
        index among the more than one serving cells
          if V_{c-DAI,c,m}^{DL} ≤ Vₜₑₘₚ
            j = j + 1;
```

*** <Unchanged parts are omitted> ***

```
        end if
        s = s + 1;
      end if
    end while
  else
    while c < N_{cells}^{DL}
      if PDCCH monitoring occasion m is before an active DL BWP change on any / at
      least one serving cell from more than one serving cells, from a set of serving cells
      that includes serving cell c, on which respective more than one PDSCHs are
      scheduled by a DCI format 1_3 that is provided in a PDCCH in the PDCCH
      monitoring occasion m or an active UL BWP change on the serving cell of
      PUCCH transmission if the UE is provided pucch-sSCellDyn or pucch-
      sSCellDynDCI-1-2, or an active UL BWP change on the PCell if the UE is not
      provided pucch-sSCellDyn and pucch-sSCellDynDCI-1-2, and an active DL BWP
      change is not triggered in PDCCH monitoring occasion m
          c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells, where the DCI format is associated with a PDCCH
        reception in PDCCH monitoring occasion m and c is the smallest serving cell
        index among the more than one serving cells
          if V_{c-DAI,c,m}^{DL} ≤ Vₜₑₘₚ
            j = j + 1;
```

*** <Unchanged parts are omitted> ***

```
        end if
        c = c + 1;
      end if
  end while
  end if
  m = m + 1;
end while
```

*** <Unchanged parts are omitted> ***

A further example specifications text (labeled as TP #3) can be as follows:

```
***<Unchanged parts are omitted>***
Set M to the number of PDCCH monitoring occasions
while m < M
  c = 0
  if harq-ACK-SpatialBundlingPUCCH is not provided,
    while c < N_{cells}^{DL}
      if PDCCH monitoring occasion m is before an active UL BWP change on the
      serving cell of PUCCH transmission if the UE is provided pucch-sSCellDyn or
      pucch-sSCellDynDCI-1-2, or an active UL BWP change on the PCell if the UE is
      not provided pucch-sSCellDyn and pucch-sSCellDynDCI-1-2, ([note: the following
      may or may not be present] and an active DL BWP change is not triggered in
      PDCCH monitoring occasion m)
        c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells where the DCI format is associated with a PDCCH
        reception in PDCCH monitoring occasion m and c is the smallest serving cell
        index among the more than one serving cells
          if V_{C-DAI,c,m}^{DL} ≤ Vₜₑₘₚ
            j = j + 1;
          end if
          Vₜₑₘₚ = V_{C-DAI,c,m}^{DL};
          if V_{T-DAI,m}^{DL} = ∅
            V_{temp,2} = V_{C-DAI, c,m}^{DL};
          else
            V_{temp,2} = V_{T-DAI,m,}^{DL};
          end if
          cnt = 0;
          mc = 0;
          while mc < N_{cells,set}^{DL,max}
            if PDCCH monitoring occasion m is before an active DL BWP change on
            serving cell mc and an active DL BWP change is not triggered in PDCCH
            monitoring occasion m
              mc = mc + 1;
            else
              if the UE is scheduled PDSCH reception on serving cell mc, if any,
                from the more than one serving cells
                if maxNrofCodeWordsScheduledByDCI is 2 for serving cell mc, if
              any,
                  ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK information$
                  bit corresponding to the first transport block of this cell
                  ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + 1 + cnt}^{ACK} = HARQ - ACK$
                  information bit corresponding to the second transport block of
                  this cell
                  cnt = cnt + 2;
              else
                  ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK information$
                  bit corresponding to the transport block of this cell
              cnt = cnt + 1;
              end if
            end if
            mc = mc + 1;
          end if
        end while
        while cnt < Nₛₑₜₛ^{TB,max}
          ${\tilde{o}}_{{N}_{sets}^{TB , max} \cdot {T}_{D} \cdot j + {N}_{sets}^{TB , max} \cdot {V}_{C - DAI , c , m}^{DL} - 1 + cnt}^{ACK} = NACK ;$
          cnt = cnt + 1;
        end while
        Vₛ = Vₛ ∪ {Nₛₑₜₛ^{TB, max} · T_{D} · j + Nₛₑₜₛ^{TB,max} · (V_{C-DAI,c,m}^{DL} − 1), ... , Nₛₑₜₛ^{TB,max} ·
          T_{D} · j + Nₛₑₜₛ^{TB,max} · (V_{C-DAI,c,m}^{DL} − 1) + Nₛₑₜₛ^{TB,max} − 1};
      end if
      c = c + 1;
    end if
    end while
  else
    while c < N_{cells}^{DL}
      if PDCCH monitoring occasion m is before an active UL BWP change on the
      serving cell of PUCCH transmission if the UE is provided pucch-sSCellDyn or
      pucch-sSCellDynDCI-1-2, or an active UL BWP change on the PCell if the UE is
      not provided pucch-sSCellDyn and pucch-sSCellDynDCI-1-2, ([note: the following
      may or may not be present] and an active DL BWP change is not triggered in
      PDCCH monitoring occasion m)
        c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells, where the DCI format is associated with a PDCCH
        reception in PDCCH monitoring occasion m and c is the smallest serving cell
        index among the more than one serving cells
          if V_{C-DAI,c,m}^{DL} ≤ Vₜₑₘₚ
            j = j + 1;
          end if
          Vₜₑₘₚ = V_{C-DAI,c,m}^{DL};
          if V_{T-DAI,m}^{DL} = ∅
            V_{temp,2} = V_{C-DAI,c,m}^{DL};
          else
            V_{temp,2} = V_{T-DAI,m}^{DL};
          end if
          cnt = 0;
          mc = 0;
          while mc < N_{cells,set}^{DL,max}
            if PDCCH monitoring occasion m is before an active DL BWP change on
            serving cell mc and an active DL BWP change is not triggered in
            PDCCH monitoring occasion m
              mc = mc + 1;
            else
                if the UE is scheduled PDSCH reception for transport blocks with
                  enabled HARQ-ACK information on serving cell mc, if any,
                  from the more than one serving cells
                  if maxNrofCodeWordsScheduledByDCI is 2 for serving cell mc
                    if the PDSCH reception provides two transport blocks
                      ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = binary AND$
                        operation of the HARQ-ACK information bits
                        corresponding to the first and second transport blocks of
                        this cell
                          else
                        ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = HARQ - ACK$
                        information bit corresponding to the first transport block
                        of this cell
                          end if
                          else
                            ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = HARQ - ACK$
                            information bit of this cell
                          end if
                          cnt = cnt + 1;
                        end if
                        mc = mc + 1;
                    end while
                    while cnt < N_{cells,set}^{DL,max}
                      ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = NACK ;$
                      cnt = cnt + 1;
                    end while
                    Vₛ = Vₛ ∪ {N_{cells,set}^{DL,max} · T_{D} · j + N_{cells,set}^{DL,max} · (V_{C-DAI,c,m}^{DL} − 1),
                      N_{cells,set}^{DL, max} _{cells,set}^{DL,max} · (V_{C-DAI,c,m}^{DL} − 1) +
                      1 ... , N_{cells,set}^{DL, max} · T_{D} · j + N_{cells,set}^{DL,max} · (V_{C-DAI,c,m}^{DL} − 1) +
                      N_{cells,set}^{DL, max} − 1};
          end if
          c = c + 1;
        end if
      end while
    end if
    m = m + 1;
  end while
*** <Unchanged parts are omitted> ***
```

Another variation of an specifications text (labeled as TP #3A) can be as follows that combined elements from TP #2 and elements from TP #3:

```
*** <Unchanged parts are omitted> ***
Set M to the number of PDCCH monitoring occasions
while m < M
  c = 0
  if harq-ACK-SpatialBundlingPUCCH is not provided,
    while c < N_{cells}^{DL}
      if PDCCH monitoring occasion m is before an active DL BWP change on all of
      the more than one serving cells, from a set of serving cells that includes serving
      cell c, on which respective more than one PDSCHs are scheduled by a DCI format
      1_3 that is provided in a PDCCH in the PDCCH monitoring occasion m or an
      active UL BWP change on the serving cell of PUCCH transmission if the UE is
      provided pucch-sSCellDyn or pucch-sSCellDynDCI-1-2, or an active UL BWP
      change on the PCell if the UE is not provided pucch-sSCellDyn and pucch-
      sSCellDynDCI-1-2, and an active DL BWP change is not triggered in PDCCH
      monitoring occasion m
        c = c + 1;
      else
        if there is a PDSCH reception on serving cell c that is scheduled by a DCI
        format scheduling more than one PDSCHs that provide respective more than
        one transport blocks with enabled HARQ-ACK information on respective more
        than one serving cells where the DCI format is associated with a PDCCH
        reception in PDCCH monitoring occasion m and c is the smallest serving cell
        index among the more than one serving cells
          if V_{C-DAI,c,m}^{DL} ≤ Vₜₑₘₚ
            j = j + 1;
          end if
          Vₜₑₘₚ = V_{C-DAI,c,m}^{DL};
          if V_{T-DAI,m}^{DL} = ∅
            V_{temp,2} = V_{C-DAI,c,m}^{DL};
          else
            V_{temp,2} = V_{T-DAI,m}^{DL};
          end if
          cnt = 0;
          mc = 0;
          while mc < N_{cells,set}^{DL,max}
            if PDCCH monitoring occasion m is before an active DL BWP change on
            serving cell mc and an active DL BWP change is not triggered in PDCCH
            monitoring occasion m
              mc = mc + 1;
            else
              if the UE is scheduled PDSCH reception on serving cell mc, if any,
                from the more than one serving cells
                if maxNrofCodeWordsScheduledByDCI is 2 for serving cell mc, if
              any,
                ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK information$
                bit corresponding to the first transport block of this cell
                ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + 1 + cnt}^{ACK} = HARQ - ACK$
                information bit corresponding to the second transport block of
                this cell
                cnt = cnt + 2;
              else
                ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK information$
                bit corresponding to the transport block of this cell
              cnt = cnt + 1;
              end if
            end if
            mc = mc + 1;
          end if
        end while
        while cnt < Nₛₑₜₛ^{TB,max}
          ${\tilde{o}}_{{N}_{sets}^{TB , max} \cdot {T}_{D} \cdot j + {N}_{sets}^{TB , max} \cdot {V}_{C - DAI , c , m}^{DL} - 1 + cnt}^{ACK} = NACK ;$
          cnt = cnt + 1;
        end while
        Vₛ = Vₛ ∪ {Nₛₑₜₛ^{TB,max} · T_{D} · j + Nₛₑₜₛ^{TB,max} · (V_{C-DAI,c,m}^{DL} − 1), ... , Nₛₑₜₛ^{TB,max} · T_{D} ·
          j + Nₛₑₜₛ^{TB,max} · (V_{C-DAI,c,m}^{DL} − 1) + Nₛₑₜₛ^{TB,max} − 1};
      end if
      c = c + 1;
    end if
  end while
else
  while c < N_{cells}^{DL}
    if PDCCH monitoring occasion m is before an active DL BWP change on all of
    the more than one serving cells, from a set of serving cells that includes serving
    cell c, on which respective more than one PDSCHs are scheduled by a DCI format
    1_3 that is provided in a PDCCH in the PDCCH monitoring occasion m or an
    active UL BWP change on the serving cell of PUCCH transmission if the UE is
    provided pucch-sSCellDyn or pucch-sSCellDynDCI-1-2, or an active UL BWP
    change on the PCell if the UE is not provided pucch-sSCellDyn and pucch-
    sSCellDynDCI-1-2, and an active DL BWP change is not triggered in PDCCH
    monitoring occasion m
      c = c + 1;
    else
      if there is a PDSCH reception on serving cell c that is scheduled by a DCI
      format scheduling more than one PDSCHs that provide respective more than
      one transport blocks with enabled HARQ-ACK information on respective more
      than one serving cells, where the DCI format is associated with a PDCCH
      reception in PDCCH monitoring occasion m and c is the smallest serving cell
      index among the more than one serving cells
        if V_{C-DAI,c,m}^{DL} ≤ Vₜₑₘₚ
          j = j+ 1;
        end if
        Vₜₑₘₚ = V_{C-DAI,c,m}^{DL};
        if V_{T-DAI,m}^{DL} = ∅
          V_{temp,2} = V_{C-DAI,c,m}^{DL};
        else
          V_{temp,2} = V_{T-DAI,m}^{DL};
        end if
        cnt = 0;
        mc = 0;
        while mc < N_{cells,set}^{DL,max}
          if PDCCH monitoring occasion m is before an active DL BWP change on
          serving cell mc and an active DL BWP change is not triggered in
          PDCCH monitoring occasion m
            mc = mc + 1;
          else
            if the UE is scheduled PDSCH reception for transport blocks with
              enabled HARQ-ACK information on serving cell mc, if any,
              from the more than one serving cells
              if maxNrofCode WordsScheduledByDCI is 2 for serving cell mc
                if the PDSCH reception provides two transport blocks
                  ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = binary AND$
                    operation of the HARQ-ACK information bits
                    corresponding to the first and second transport blocks of
                    this cell
                      else
                  ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = HARQ - ACK$
                  information bit corresponding to the first transport block
                  of this cell
                      end if
              else
                ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = HARQ - ACK$
                information bit of this cell
              end if
              cnt = cnt + 1;
            end if
            mc = mc + 1;
          end while
          while cnt < N_{cells,set}^{DL,max}
            ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = NACK ;$
            cnt = cnt + 1;
          end while
          Vₛ = Vₛ ∪ {N_{cells,set}^{DL,max} · T_{D} · j + N_{cells,set}^{DL,max} · (V_{C-DAI,c,m}^{DL} − 1), N_{cells,set}^{DL,max} ·
            T_{D} · j + N_{cells,set}^{DL,max} · (V_{C-DAI,c,m}^{DL} − 1) + 1 ... , N_{cells,set}^{DL,max} · T_{D} · j +
            N_{cells,set}^{DL,max} · (V_{C-DAI,c,m}^{DL} − 1) + N_{cells,set}^{DL,max} − 1};
      end if
      c = c + 1;
      end if
    end while
  end if
  m = m+ 1;
end while
*** <Unchanged parts are omitted> ***
```

Yet another example specifications text (labeled as TP #4) can be as follows:

```
*** <Unchanged parts are omitted> ***
Set M to the number of PDCCH monitoring occasions
while m < M
  c = 0
  if harq-ACK-SpatialBundlingPUCCH is not provided,
    while c < N_{cells}^{DL}
      if there is a PDSCH reception on serving cell c that is scheduled by a DCI
      format scheduling more than one PDSCHs that provide respective more than
      one transport blocks with enabled HARQ-ACK information on respective more
      than one serving cells where the DCI format is associated with a PDCCH
      reception in PDCCH monitoring occasion m and c is the smallest serving cell
      index among the more than one serving cells
        if V_{C-DAI,c,m}^{DL} ≤ Vₜₑₘₚ
          j = j + 1;
        end if
        Vₜₑₘₚ = V_{C-DAI,c,m}^{DL};
        if V_{T-DAI,m}^{DL} = ∅
          V_{temp,2} = V_{C-DAI,c,m}^{DL};
        else
          V_{temp,2} = V_{T-DAI,m}^{DL};
        end if
        cnt = 0;
        mc = 0;
        while mc < N_{cells,set}^{DL,max}
          if PDCCH monitoring occasion m is before an active DL BWP change on
          serving cell mc or before an active UL BWP change on the serving cell of
          PUCCH transmission if the UE is provided pucch-sSCellDyn or pucch-
          sSCellDynDCI-1-2, or an active UL BWP change on the PCell if the UE
          is not provided pucch-sSCellDyn and pucch-sSCellDynDCI-1-2, and an
          active DL BWP change is not triggered in PDCCH monitoring occasion
          m
            mc = mc + 1;
          else
            if the UE is scheduled PDSCH reception on serving cell mc, if any,
              from the more than one serving cells
              if maxNrofCodeWordsScheduledByDCI is 2 for serving cell mc, if
            any,
              ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK information$
              bit corresponding to the first transport block of this cell
              ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + 1 + cnt}^{ACK} = HARQ - ACK$
              information bit corresponding to the second transport block of
              this cell
              cnt = cnt + 2;
            else
              ${\tilde{o}}_{{N}_{sets}^{TB , max} \cdot {T}_{D} \cdot j + {N}_{sets}^{TB , max} \cdot ( {V}_{C - DAI , c , m}^{DL} - 1 ) + cnt}^{ACK} = HARQ - ACK information$
              bit corresponding to the transport block of this cell
            cnt = cnt + 1;
            end if
          end if
          mc = mc + 1;
        end if
      end while
      while cnt < Nₛₑₜₛ^{TB,max}
        ${\tilde{o}}_{{N}_{sets}^{TB , max} \cdot {T}_{D} + {N}_{sets}^{TB , max} \cdot {V}_{C - DAI , c , m}^{DL} - 1 + cnt}^{ACK} = NACK ;$
        cnt = cnt + 1;
      end while
      Vₛ = Vₛ ∪ {Nₛₑₜₛ^{TB,max} · T_{D} · j + Nₛₑₜₛ^{TB,max} · (V_{C-DAI,c,m}^{DL} − 1), ... , Nₛₑₜₛ^{TB,max} · T_{D} ·
        j + Nₛₑₜₛ^{TB,max} · (V_{C-DAI,c,m}^{DL} − 1) + Nₛₑₜₛ^{TB,max} − 1};
      end if
      c = c + 1;
    end while
  else
    while c < N_{cells}^{DL}
      if there is a PDSCH reception on serving cell c that is scheduled by a DCI format
      scheduling more than one PDSCHs that provide respective more than one transport
      blocks with enabled HARQ-ACK information on respective more than one serving
      cells , where the DCI format is associated with a PDCCH reception in PDCCH
      monitoring occasion m and c is the smallest serving cell index among the more
      than one serving cells
        if V_{C-DAI,c,m}^{DL} ≤ Vₜₑₘₚ
          j = j + 1;
        end if
        Vₜₑₘₚ = V_{C-DAI,c,m}^{DL};
        if V_{T-DAI,m}^{DL} = ∅
          V_{temp,2} = V_{C-DAI,c,m}^{DL};
        else
          V_{temp,2} = V_{T-DAI,m}^{DL};
        end if
        cnt = 0;
        mc = 0;
        while mc < N_{cells,set}^{DL,max}
          if PDCCH monitoring occasion m is before an active DL BWP change on
          serving cell mc, or before an active UL BWP change on the serving cell of
          PUCCH transmission if the UE is provided pucch-sSCellDyn or pucch-
          sSCellDynDCI-1-2, or an active UL BWP change on the PCell if the UE is
          not provided pucch-sSCellDyn and pucch-sSCellDynDCI-1-2, and an active
          DL BWP change is not triggered in PDCCH monitoring occasion m
            mc = mc + 1;
          else
            if the UE is scheduled PDSCH reception for transport blocks with enabled
              HARQ-ACK information on serving cell mc, if any, from the more
              than one serving cells
              if maxNrofCodeWordsScheduledByDCI is 2 for serving cell mc
                if the PDSCH reception provides two transport blocks
                  ${\tilde{o}}_{{N}_{cells , set}^{DL , max} \cdot {T}_{D} \cdot j + {N}_{cells , set}^{DL , max} \cdot {V}_{C - DAI , c , , m}^{DL} - 1 + cnt}^{ACK} = binary AND operation of$
                    the HARQ-ACK information bits corresponding to the first
                    and second transport blocks of this cell
                      else
                    ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = HARQ - ACK$
                    information bit corresponding to the first transport block of
                    this cell
                      end if
              else
                ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = HARQ - ACK information bit$
                of this cell
              end if
              cnt = cnt + 1;
            end if
            mc = mc + 1;
          end if
        end while
      while cnt < N_{cells,set}^{DL, max}
        ${\tilde{o}}_{{N}_{cells , set}^{DL , max} \cdot {T}_{D} \cdot j + {N}_{cells , set}^{DL , max} \cdot {V}_{C - DAI , c , m}^{DL} - 1 + cnt}^{ACK} = NACK ;$
        cnt = cnt + 1;
      end while
      Vₛ = Vₛ ∪ {N_{cells,set}^{DL, max} · T_{D} · j + N_{cells,set}^{DL,max} · (V_{C-DAI,c,m}^{DL} − 1), N_{cells,set}^{DL,max} ·
        T_{D} · j + N_{cells,set}^{DL, max} · (V_{C-DAI,c,m}^{DL} − 1) + 1 ... , N_{cells,set}^{DL,max} · T_{D} · j +
        N_{cells,set}^{DL,max} · (V_{C-DAI,c,m}^{DL} − 1) + N_{cells,set}^{DL, max} − 1};
      end if
      c = c + 1;
    end while
  end if
  m = m+ 1;
end while
*** <Unchanged parts are omitted> ***
```

In above example texts such as TP #1, #2, #3, and #4, the sentence “and an active DL BWP change is not triggered in PDCCH monitoring occasion in” can be replaced by:
“and an active DL BWP change on any serving cell from a/the set of serving cells that include serving cell c is not triggered in PDCCH monitoring occasion m”, or
“and an active DL BWP change on all serving cells from a the set of serving cells that includes serving cell c is not triggered in PDCCH monitoring occasion m”, or
“and an active DL BWP change on at least one serving cell from a the set of serving cells that includes serving cell c is not triggered in PDCCH monitoring occasion m”, or
“and an active DL BWP change on any all at least one serving cells from the more than one serving cells (including serving cell c) that are scheduled by the corresponding DCI format is not triggered in PDCCH monitoring occasion m”, or
“and an active DL BWP change on serving cell mc is not triggered in PDCCH monitoring occasion m”, or
“and an active DL BWP change on the PCell or the serving cell of PUCCH transmission is not triggered in PDCCH monitoring occasion m”.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for providing hybrid automatic repeat request acknowledgment (HARQ-ACK) information, the method comprising:
receiving:
first information for a first set of serving cells including multiple serving cells,
first downlink control information (DCI) formats, wherein each DCI format from the first DCI formats schedules physical downlink shared channel (PDSCH) receptions on respective serving cells from the first set of serving cells, and
first PDSCHs on respective first serving cells, from the first set of serving cells, that are scheduled by a first DCI format from the first DCI formats, wherein:
the first DCI format is provided by a first physical downlink control channel (PDCCH) reception in a first PDCCH monitoring occasion (MO),
the first PDCCH MO is before a first active downlink (DL) bandwidth part (BWP) change on a first serving cell from the first serving cells, and
a second active DL BWP change on the first serving cell is not triggered in the first PDCCH MO;
determining:
first HARQ-ACK information corresponding to the first PDSCHs, wherein:
the first HARQ-ACK information includes a negative acknowledgment (NACK) for the first PDSCH, and
the NACK is appended to HARQ-ACK information corresponding to the first PDSCHs except for the first PDSCH, and
a first HARQ-ACK codebook associated with the first DCI formats that includes the first HARQ-ACK information; and
transmitting a physical uplink control channel (PUCCH) or a physical uplink shared channel (PUSCH) that provides HARQ-ACK codebooks including the first HARQ-ACK codebook.

2. The method of claim 1, further comprising:
receiving second PDSCHs on respective second serving cells, from the first set of serving cells, that are scheduled by a second DCI format from the first DCI formats, wherein:
the second DCI format is provided by a second PDCCH that is received in a second PDCCH MO,
the second PDCCH MO is before an active UL BWP change on a serving cell of the PUCCH transmission, and
second NACKs corresponding to the second PDSCHs are appended to the first HARQ-ACK codebook.

3. The method of claim 1, further comprising:
indicating a capability for processing multiple DCI formats, from the first DCI formats, provided in respective PDCCHs in a same PDCCH MO, for the first set of serving cells;
receiving second PDSCHs on respective second serving cells, from the first set of serving cells, that are scheduled by a second DCI format from the first DCI formats, wherein:
the second DCI format is provided by a second PDCCH reception in the first PDCCH MO, and
a smallest cell index among the first serving cells is smaller than a smallest cell index among the second serving cells; and
determining second HARQ-ACK information corresponding to the second PDSCHs, wherein the second HARQ-ACK information is included in the first HARQ-ACK codebook after the first HARQ-ACK information.

4. The method of claim 3, further comprising:
determining:
a first counter downlink assignment index (c-DAI) associated with the first DCI format, and
a second c-DAI associated with the second DCI format, wherein the second c-DAI is larger than the first c-DAI.

5. The method of claim 1, further comprising:
indicating a capability to provide HARQ-ACK information for PDSCH receptions scheduled by multiple DCI formats, from the first DCI formats, provided in respective PDCCHs in a same PDCCH MO, for the first set of serving cells;
receiving second PDSCHs on respective second serving cells, from the set of serving cells, that are scheduled by a second DCI format from the first DCI formats, wherein:
the second DCI format is provided by a second PDCCH that is received in the first PDCCH MO,
a smallest serving cell index among the first serving cells is same as a smallest serving cell index among the second serving cells, and
a starting time for a reception of a second PDSCH, from the first PDSCHs, corresponding to a serving cell with the smallest serving cell index is earlier than a starting time for a reception of a third PDSCH, from the second PDSCHs, corresponding to the serving cell with the smallest serving cell index; and
determining:
a first counter downlink assignment index (c-DAI) associated with the first DCI format,
a second c-DAI associated with the second DCI format, wherein the second c-DAI is larger than the first c-DAI, and
second HARQ-ACK information corresponding to the second PDSCHs, wherein the second HARQ-ACK information is included in the first HARQ-ACK codebook after the first HARQ-ACK information.

6. The method of claim 1, further comprising:
receiving:
second information for a second set of serving cells,
second DCI formats, wherein each DCI format from the second DCI formats:
schedules only one PDSCH reception on only one serving cell from the second set of serving cells, or
does not schedule a PDSCH reception and is associated with HARQ-ACK information; and
determining a second HARQ-ACK codebook associated with the second DCI formats, wherein:
the first HARQ-ACK codebook is of a first type,
the second HARQ-ACK codebook is of a second type, and
the HARQ-ACK codebooks includes the second HARQ-ACK codebook prepended to the first HARQ-ACK codebook.

7. The method of claim 1, wherein:
any DCI format, from the first DCI formats, provides a value for a block of frequency domain resource allocation (FDRA) field associated with a serving cell from the first set of serving cells, and
the value comprises of bits that are:
all equal to 0 for an FDRA type 0,
all equal to 1 for an FDRA type 1, or
all equal to either 0 or 1 for a dynamic switching FDRA type,
when the serving cell is a deactivated serving cell or has an active DL BWP that is a dormant DL BWP.

8. A user equipment (UE) comprising:
a transceiver configured to receive:
first information for a first set of serving cells including multiple serving cells,
first downlink control information (DCI) formats, wherein each DCI format from the first DCI formats schedules physical downlink shared channel (PDSCH) receptions on respective serving cells from the first set of serving cells, and
first PDSCHs on respective first serving cells, from the first set of serving cells, that are scheduled by a first DCI format from the first DCI formats, wherein:
the first DCI format is provided by a first physical downlink control channel (PDCCH) reception in a first PDCCH monitoring occasion (MO),
the first PDCCH MO is before a first active downlink (DL) bandwidth part (BWP) change on a first serving cell from the first serving cells, and
a second active DL BWP change on the first serving cell is not triggered in the first PDCCH MO; and
a processor operably coupled with the transceiver, the processor configured to determine:
first HARQ-ACK information corresponding to the first PDSCHs, wherein:
the first HARQ-ACK information includes a negative acknowledgment (NACK) for the first PDSCH, and
the NACK is appended to HARQ-ACK information corresponding to the first PDSCHs except for the first PDSCH, and
a first HARQ-ACK codebook associated with the first DCI formats that includes the first HARQ-ACK information;
wherein the transceiver is further configured to transmit a physical uplink control channel (PUCCH) or a physical uplink shared channel (PUSCH) that provides HARQ-ACK codebooks including the first HARQ-ACK codebook.

9. The UE of claim 8, wherein:
the transceiver is further configured to receive second PDSCHs on respective second serving cells, from the first set of serving cells, that are scheduled by a second DCI format from the first DCI formats,
the second DCI format is provided by a second PDCCH that is received in a second PDCCH MO,
the second PDCCH MO is before an active UL BWP change on a serving cell of the PUCCH transmission, and
second NACKs corresponding to the second PDSCHs are appended to the first HARQ-ACK codebook.

10. The UE of claim 8, wherein:
the transceiver is further configured to:
transmit an indication a capability for processing multiple DCI formats, from the first DCI formats, provided in respective PDCCHs in a same PDCCH MO, for the first set of serving cells, and
receive second PDSCHs on respective second serving cells, from the first set of serving cells, that are scheduled by a second DCI format from the first DCI formats,
the second DCI format is provided by a second PDCCH reception in the first PDCCH MO,
a smallest cell index among the first serving cells is smaller than a smallest cell index among the second serving cells, and
the processor is further configured to determine second HARQ-ACK information corresponding to the second PDSCHs, wherein the second HARQ-ACK information is included in the first HARQ-ACK codebook after the first HARQ-ACK information.

11. The UE of claim 10, wherein:
the processor is further configured to determine:
a first counter downlink assignment index (c-DAI) associated with the first DCI format, and
a second c-DAI associated with the second DCI format, wherein the second c-DAI is larger than the first c-DAI.

12. The UE of claim 8, wherein:
the transceiver is configured to:
transmit an indication of a capability to provide HARQ-ACK information for PDSCH receptions scheduled by multiple DCI formats, from the first DCI formats, provided in respective PDCCHs in a same PDCCH MO, for the first set of serving cells, and
receive second PDSCHs on respective second serving cells, from the set of serving cells, that are scheduled by a second DCI format from the first DCI formats, wherein:
the second DCI format is provided by a second PDCCH that is received in the first PDCCH MO, and
a smallest serving cell index among the first serving cells is same as a smallest serving cell index among the second serving cells,
a starting time for a reception of a second PDSCH, from the first PDSCHs, corresponding to a serving cell with the smallest serving cell index is earlier than a starting time for a reception of a third PDSCH, from the second PDSCHs, corresponding to the serving cell with the smallest serving cell index; and
the processor is further configured to determine:
a first counter downlink assignment index (c-DAI) associated with the first DCI format,
a second c-DAI associated with the second DCI format, wherein the second c-DAI is larger than the first c-DAI, and
second HARQ-ACK information corresponding to the second PDSCHs, wherein the second HARQ-ACK information is included in the first HARQ-ACK codebook after the first HARQ-ACK information.

13. The UE of claim 8, wherein:
the transceiver is further configured to receive:
second information for a second set of serving cells,
second DCI formats, wherein each DCI format from the second DCI formats:
schedules only one PDSCH reception on only one serving cell from the second set of serving cells, or
does not schedule a PDSCH reception and is associated with HARQ-ACK information, and
the processor is further configured to determine a second HARQ-ACK codebook associated with the second DCI formats, wherein:
the first HARQ-ACK codebook is of a first type,
the second HARQ-ACK codebook is of a second type, and
the HARQ-ACK codebooks includes the second HARQ-ACK codebook prepended to the first HARQ-ACK codebook.

14. The UE of claim 8, wherein:
any DCI format, from the first DCI formats, provides a value for a block of frequency domain resource allocation (FDRA) field associated with a serving cell from the first set of serving cells, and
the value comprises of bits that are:
all equal to 0 for an FDRA type 0,
all equal to 1 for an FDRA type 1, or
all equal to either 0 or 1 for a dynamic switching FDRA type,
when the serving cell is a deactivated serving cell or has an active DL BWP that is a dormant DL BWP.

15. A base station comprising:
a transceiver configured to transmit:
first information for a first set of serving cells including multiple serving cells,
first downlink control information (DCI) formats, wherein each DCI format from the first DCI formats schedules physical downlink shared channel (PDSCH) transmissions on respective serving cells from the first set of serving cells, and
first PDSCHs on respective first serving cells, from the first set of serving cells, that are scheduled by a first DCI format from the first DCI formats, wherein:
the first DCI format is provided by a first physical downlink control channel (PDCCH) transmission in a first PDCCH monitoring occasion (MO),
the first PDCCH MO is before a first active downlink (DL) bandwidth part (BWP) change on a first serving cell from the first serving cells, and
a second active DL BWP change on the first serving cell is not triggered in the first PDCCH MO; and
a processor operably coupled with the transceiver, the processor configured to determine:
first HARQ-ACK information corresponding to the first PDSCHs, wherein:
the first HARQ-ACK information includes a negative acknowledgment (NACK) for the first PDSCH, and
the NACK is appended to HARQ-ACK information corresponding to the first PDSCHs except for the first PDSCH, and
a first HARQ-ACK codebook associated with the first DCI formats that includes the first HARQ-ACK information;
wherein the transceiver is further configured to receive a physical uplink control channel (PUCCH) or a physical uplink shared channel (PUSCH) that provides HARQ-ACK codebooks including the first HARQ-ACK codebook.

16. The base station of claim 15, wherein:
the transceiver is further configured to transmit second PDSCHs on respective second serving cells, from the first set of serving cells, that are scheduled by a second DCI format from the first DCI formats,
the second DCI format is provided by a second PDCCH that is transmitted in a second PDCCH MO,
the second PDCCH MO is before an active UL BWP change on a serving cell of the PUCCH reception, and
second NACKs corresponding to the second PDSCHs are appended to the first HARQ-ACK codebook.

17. The base station of claim 15, wherein:
the transceiver is further configured to:
receive an indication of a capability for processing multiple DCI formats, from the first DCI formats, provided in respective PDCCHs in a same PDCCH MO, for the first set of serving cells, and
transmit second PDSCHs on respective second serving cells, from the first set of serving cells, that are scheduled by a second DCI format from the first DCI formats, the second DCI format is provided by a second PDCCH transmission in the first PDCCH MO;
a smallest cell index among the first serving cells is smaller than a smallest cell index among the second serving cells; and
the processor is further configured to determine:
a first counter downlink assignment index (c-DAI) associated with the first DCI format, and
a second c-DAI associated with the second DCI format, wherein the second c-DAI is larger than the first c-DAI, and
second HARQ-ACK information corresponding to the second PDSCHs, wherein the second HARQ-ACK information is included in the first HARQ-ACK codebook after the first HARQ-ACK information.

18. The base station of claim 15, wherein:
the transceiver is configured to:
receive an indication of a capability to provide HARQ-ACK information for PDSCH transmissions scheduled by multiple DCI formats, from the first DCI formats, provided in respective PDCCHs in a same PDCCH MO, for the first set of serving cells, and
transmit second PDSCHs on respective second serving cells, from the set of serving cells, that are scheduled by a second DCI format from the first DCI formats, wherein:
the second DCI format is provided by a second PDCCH that is transmitted in the first PDCCH MO, and
a smallest serving cell index among the first serving cells is same as a smallest serving cell index among the second serving cells,
a starting time for a transmission of a second PDSCH, from the first PDSCHs, corresponding to a serving cell with the smallest serving cell index is earlier than a starting time for a transmission of a third PDSCH, from the second PDSCHs, corresponding to the serving cell with the smallest serving cell index; and
the processor is further configured to determine:
a first counter downlink assignment index (c-DAI) associated with the first DCI format,
a second c-DAI associated with the second DCI format, wherein the second c-DAI is larger than the first c-DAI, and
second HARQ-ACK information corresponding to the second PDSCHs, wherein the second HARQ-ACK information is included in the first HARQ-ACK codebook after the first HARQ-ACK information.

19. The base station of claim 15, wherein:
the transceiver is further configured to transmit:
second information for a second set of serving cells,
second DCI formats, wherein each DCI format from the second DCI formats:
schedules only one PDSCH transmission on only one serving cell from the second set of serving cells, or
does not schedule a PDSCH transmission and is associated with HARQ-ACK information, and
the processor is further configured to determine a second HARQ-ACK codebook associated with the second DCI formats, wherein:
the first HARQ-ACK codebook is of a first type,
the second HARQ-ACK codebook is of a second type, and
the HARQ-ACK codebooks includes the second HARQ-ACK codebook prepended to the first HARQ-ACK codebook.

20. The base station of claim 15, wherein:
any DCI format, from the first DCI formats, provides a value for a block of frequency domain resource allocation (FDRA) field associated with a serving cell from the first set of serving cells, and
the value comprises of bits that are:
all equal to 0 for an FDRA type 0,
all equal to 1 for an FDRA type 1, or
all equal to either 0 or 1 for a dynamic switching FDRA type,
when the serving cell is a deactivated serving cell or has an active DL BWP that is a dormant DL BWP.
